(19) United States
(12) Patent Application Publication
(10) Pub. No.: US 2019/0080286 A1
(43) Pub. Date: Mar. 14, 2019

(54) Computer-Implemented Marketplace Platform Facilitating Connection of Consumer Vehicle Drivers with Consumer Shippers

(71) Applicant: Kaargo, Inc., New York, NY (US)

(72) Inventor: Sarayu Srinivasan, New York, NY (US)

(21) Appl. No.: 15/407,593

(22) Filed: Jan. 17, 2017

Related U.S. Application Data
(60) Provisional application No. 62/295,781, filed on Feb. 16, 2016.

(51) Int. Cl. G06Q 10/08; G06Q 30/00

(52) U.S. Cl. CPC G06Q 10/0834; H04L 67/42; G06Q 30/018

(57) ABSTRACT

A computer-implemented method of providing a marketplace platform enables one of a first set of first consumers to connect and interact with one of a second set of second consumers, In this embodiment, each first consumer is planning a trip in a motor vehicle driven by such first consumer, the trip having an origin and a destination over a specific time period, and willing to carry a set of items from a pickup location near the origin to a delivery location near the destination. Each second consumer desires to ship a shipment from a starting location to an end location over a specific time interval. In this embodiment, furthermore, the one of the first consumers and the one of the second consumers may choose to connect with each other on the basis of perceived matches (i) between the origin and the starting location, (ii) between the destination and the ending location, and (iii) between the specific time period and the specific time interval.

### RELATED APPLICATION

This application claims the benefit of U.S. provisional application Ser. No. 62/295,781, filed Feb. 16, 2016, having the same title and inventor as the present application. This related application is hereby incorporated herein by reference in its entirety.

### TECHNICAL FIELD

The present invention relates to marketplace platforms, and more particularly to a consumer-to-consumer marketplace platform facilitating the connection of consumer vehicle drivers with consumer shippers.

### BACKGROUND ART

It is known in the prior art to provide marketplace platforms. Examples of such platforms include craigslist, www.craigslist.org, eBay, www.ebay.com, and airbnb, www.airbnb.com.

### SUMMARY OF THE EMBODIMENTS

In a first embodiment of the invention there is provided a computer-implemented method of providing a marketplace platform that enables one of a first set of first consumers to connect and interact with one of a second set of second consumers. In this embodiment, each first consumer is planning a trip in a motor vehicle driven by such first consumer, the trip having an origin and a destination over a specific time period, and willing to carry a set of items from a pickup location within a first specified distance of the origin to a delivery location within a second specified distance of the destination. Each second consumer desires to ship a shipment from a starting location to an end location over a specific time interval. In this embodiment, furthermore, the one of the first consumers and the one of the second consumers may choose to connect with each other on the basis of perceived matches (i) between the origin and the starting location, (ii) between the destination and the ending location, and (iii) between the specific time period and the specific time interval. The method of this embodiment includes:
receiving at a server system, over a wide area network, from a computer client of each of the first and second consumers, data by which each such consumer is registered, such data including contact information and a credit facility identifier;
also receiving at the server system, over the wide area network, from a computer client of each consumer desiring to be a first consumer, driver's license identification data;
receiving at the server system, over the wide area network, from a computer client of each first consumer desiring to post a trip, trip data characterizing the trip to be posted, such data including for such trip: the origin, the destination, and the specific time interval;
storing by the server system the received trip data in a database;
receiving at the server system, over the wide area network, from a computer client of each second consumer desiring to post a shipment, shipment data characterizing the shipment to be posted, such data including for such shipment: the starting location, the end location, the specific time period, and an uploaded photograph of such shipment, and wherein provision of such shipment data from such second consumer is a condition to use of the platform by such second consumer;
storing by the server system the received shipment data in the database;
causing at least some of the stored trip data and at least some of the stored shipment data to be searchable over the wide area network via a client computer of any of the consumers;
responsive to a purchase-a-trip message from a client computer of a purchasing one of the second consumers, receiving at the server system, over the wide area network from a client computer of the purchasing one of the second consumers, purchase data characterizing a trip purchase, such data identifying a corresponding posted trip;
updating by the server system the database to reflect the trip purchase;
transmitting, by the server system, purchase completion messages, to the client computer of the purchasing one of the second consumers, such second consumer hereinafter called “the shipper” and to the client computer of the corresponding one of the first consumers whose trip was purchased, such first consumer hereinafter called “the driver”, confirming the trip purchase for a corresponding shipment; and
serving by the server system to the computer client of the driver a copy of the uploaded photograph of the shipper's shipment and also an instruction to the driver to refuse to carry any item tendered to the driver by the shipper if the item does not match an item in the uploaded photograph of the shipper's shipment;
with respect to a purchased trip that has been commenced:
receiving at the server system, contemporaneous geolocation data from a mobile computer, of the driver, that is in communication with the server and running an application causing such data to be transmitted to the server; and
transmitting, by the server system, to the computer client of the shipper, location data showing the contemporaneous location of the driver and the corresponding shipment and the corresponding shipment, such location data including a map that shows the current location of the corresponding shipment highlighted and a tracking history for such purchased trip that has been commenced.

In another and similar embodiment, there there is provided a computer-implemented method of providing a marketplace platform that enables one of a first set of first consumers to connect and interact with one of a second set of second consumers. In this embodiment, each first consumer is planning a trip in a motor vehicle driven by such first consumer, the trip having an origin and a destination over a specific time period, and willing to carry a set of items from a pickup location within a first specified distance of the origin to a delivery location within a second specified distance of the destination. Each second consumer desires to ship a shipment from a starting location to an end location over a specific time interval. In this embodiment, furthermore, the one of the first consumers and the one of the second consumers may choose to connect with each other on the basis of perceived matches (i) between the origin and the starting location, (ii) between the destination and the ending location, and (iii) between the specific time period and the specific time interval. The method of this embodiment includes:
receiving at a server system, over a wide area network, from a computer client of each of the first and second consumers, data by which each such consumer is registered, such data including contact information and a credit facility identifier;
also receiving at the server system, over the wide area network, from a computer client of each consumer desiring to be a first consumer, driver's license identification data;
receiving at the server system, over the wide area network, from a computer client of each first consumer desiring to post a trip, trip data characterizing the trip to be posted, such data including for such trip: the origin, the destination, and the specific time interval;
storing by the server system the received trip data in a database;
receiving at the server system, over the wide area network, from a computer client of each second consumer desiring to post a shipment, shipment data characterizing the shipment to be posted, such data including for such shipment: the starting location, the end location, and the specific time period;
storing by the server system the received shipment data in the database;
causing at least some of the stored trip data and at least some of the stored shipment data to be searchable over the wide area network via a client computer of any of the consumers;
responsive to a purchase-a-trip message from a client computer of a purchasing one of the second consumers, receiving at the server system, over the wide area network from a client computer of the purchasing one of the second consumers, purchase data characterizing a trip purchase, such data identifying a corresponding posted trip;
updating by the server system the database to reflect the trip purchase; and
transmitting, by the server system, purchase completion messages, to the client computer of the purchasing one of the second consumers, such second consumer hereinafter called “the shipper” and to the client computer of the corresponding one of the first consumers whose trip was purchased, such first consumer hereinafter called “the driver”, confirming the trip purchase for a corresponding shipment.

In a further related embodiment, the method further includes, with respect to a purchased trip that has been commenced, receiving at the server system, contemporaneous geolocation data from a mobile computer, of the driver, that is in communication with the server and running an application causing such data to be transmitted to the server and transmitting, to the computer client of the shipper, location data showing the contemporaneous location of the driver and the corresponding shipment. Optionally, transmitting, to the computer client of the shipper, location data showing the contemporaneous location of the driver and the corresponding shipment, includes transmitting a map that shows the current location of the corresponding shipment highlighted and a tracking history for such purchased trip that has been commenced.

In a further related embodiment, receiving at the server system the shipment data includes receiving an uploaded photograph of such shipment, and wherein provision of such shipment data from such second consumer is a condition to use of the platform by such second consumer and the method further includes serving by the server system to the computer client of the driver a copy of the uploaded photograph of the shipper's shipment and also an instruction to the driver to refuse to carry any item tendered to the driver by the shipper if the item does not match an item in the uploaded photograph of the shipper's shipment. In another further related embodiment, receiving at the server system the trip data includes receiving an uploaded photograph of the vehicle and causing at least some of the stored trip dat to be searchable over the wide area network extends to the uploaded photographs of the vehicles, so that each shipper can assess suitability, of the space and dimensions, of a vehicle of a potential driver, for transporting the shipper's shipment.

### BRIEF DESCRIPTION OF THE DRAWINGS

The foregoing features of embodiments will be more readily understood by reference to the following detailed description, taken with reference to the accompanying drawings, in which:

FIG. 1A is a block diagram of system architecture for logical processes used in an embodiment of the present invention;

FIG. 1B is a block diagram of system architecture showing the storage modules used in connection with the embodiment of FIG. 1A;

FIGS. 2-6 relate to logical flow for the Post a Trip module 111 of FIG. 1A;

FIG. 2 is a block diagram of the load details validation process for the Post a Trip module 111 of FIG. 1A;

FIG. 3 is a block diagram of the unload details validation process for the Post a Trip module 111 of FIG. 1A;

FIG. 4 is a block diagram of the vehicle details validation process for the Post a Trip module 111 of FIG. 1A;

FIG. 5 is a block diagram of the price details validation process for the Post a Trip module 111 of FIG. 1A;

FIG. 6 is a block diagram of the driver declaration verification process and for the Post a Trip module 111 of FIG. 1A;

FIGS. 7-10 relate to logical flow for the Post a Shipment module 110 of FIG. 1A;

FIG. 7 is a block diagram of the load details validation process for the Post a Shipment module 110 of FIG. 1A;

FIG. 8 is a block diagram of the unload details validation process for the Post a Shipment module 110 of FIG. 1A;

FIG. 9 is a block diagram of the item details validation process for the Post a Shipment module 110 of FIG. 1A;

FIG. 10 is a block diagram of the shipper declaration verification process for the Post a Shipment module 110 of FIG. 1A;

FIGS. 11-16 relate to logical flow for the Purchase a Trip module 116 of FIG. 1A;

FIG. 11 is a block diagram of the origin city and destination city details validation process for the Purchase a Trip module 116 of FIG. 1A;

FIG. 12 is a block diagram of the trip availability validation process for the Purchase a Trip module 116 of FIG. 1A;

FIG. 13 is a block diagram of the shipment details validation process for the Purchase a Trip module 116 of FIG. 1A;

FIG. 14 is a block diagram of the payment and shipper declaration process for the Purchase a Trip module 116 of FIG. 1A;

FIG. 15 is a block diagram of the payment method addition process for the Purchase a Trip module 116 of FIG. 1A;

FIG. 16 is a block diagram of the trip purchase completion messaging process for the Purchase a Trip module 116 of FIG. 1A;

FIGS. 17-19 relate to logical flow for the Driver Proposal module 117 of FIG. 1A;

FIG. 17 is a block diagram of the driver trip proposal submission process for the Driver Proposal Submission module 117 of FIG. 1A;

FIG. 18 is a block diagram of the purchase proposed trip process for the Driver Proposal Submission 117 of FIG. 1A;

FIG. 19 is a block diagram of the driver trip proposal submission process for the Driver Proposal Submission 117 of FIG. 1A;

FIGS. 20-23 relate to logical flow for the driver proposal module 117 of FIG. 1A;

FIG. 20 is a block diagram of the driver proposal acceptance by shipper process for the Driver Proposal module 117 of FIG. 1A;

FIG. 21 is a block diagram of the payment details process for the Driver Proposal module 117 of FIG. 1A;

FIG. 22 is a block diagram of the payment method addition process for the Driver Proposal module 117 of FIG. 1A;

FIG. 23 is a block diagram of the purchase a trip completion and messaging process for the Driver Proposal module 117 of FIG. 1A;

FIGS. 24-25 relate to logical flow for the member personal profiles module 114 of FIG. 1A;

FIGS. 24A-24C are block diagrams of the member introduction and vehicle status change processes for the Member Personal Profile module 114 of FIG. 1A;

FIG. 25 is a block diagram of the member reviews and ratings process for the Member Personal Profile module 114 of FIG. 1A;

FIGS. 26A-26B are block diagrams of the member reviews and ratings process for the Member Public Profile module 115 of FIG. 1A;

FIG. 27 is a block diagram of the member verification process for the DMV/MVR Checks module 104 and Criminal/Driver Checks module 106 of FIG. 1A;

FIGS. 28-36 relate to logical flow for the Member Dashboard module 120 of FIG. 1A;

FIG. 28 is a block diagram of logical flow for the various sub-modules of the Member Dashboard module 120 of FIG. 1A;

FIG. 29 (comprised of FIG. 29A and FIG. 29B) is a block diagram of logical flow for the posted trips and posted shipments sub-modules of the Member Dashboard module 120 of FIG. 1A;

FIG. 30 (comprised of FIG. 30A and FIG. 30B) is a block diagram of logical flow for the trip cancel and trip edit sub-modules of the Upcoming trips section in the Member Dashboard module 120 of FIG. 1A;

FIG. 31 (comprised of FIG. 31A and FIG. 31B) is a block diagram of logical flow for the trip complete and pay driver sub-modules of the Upcoming trips section in the Member Dashboard module 120 of FIG. 1A;

FIG. 32 (comprised of FIG. 32A through FIG. 32D) is a block diagram of logical flow for various functions within the Transaction Grid and Reviews and Ratings sub-modules of the Member Dashboard module 120 of FIG. 1A;

FIG. 33 (comprised of FIG. 33A and FIG. 33B) is a block diagram of logical flow for the Account edit and Payment edit sub-modules of the Member Dashboard module 120 of FIG. 1A;

FIG. 34 (comprised of FIG. 34A and FIG. 34B) is a block diagram of logical flow for the Add payment and Delete payment sub-modules of the Member Dashboard module 120 of FIG. 1A;

FIG. 35 (comprised of FIG. 35A and FIG. 35B) is a block diagram of logical flow for the vehicle add and vehicle edit sub-modules of the Member Dashboard module 120 of FIG. 1A;

FIG. 36 is a block diagram of logical flow for the Vehicle delete sub-module of the Member Dashboard module 120 of FIG. 1A;

FIGS. 37-45 relate to logical flow of the various edits sub-modules of the dashboard module 120 of FIG. 1A;

FIGS. 37A-37B are block diagrams of logical flow for the edit vehicle details process of the Member Dashboard module 120 of FIG. 1A;

FIG. 38 is a block diagram of logical flow for the edit load/unload details process of the Member Dashboard module 120 of FIG. 1A;

FIGS. 39A-39B are block diagrams of logical flow for the edit a shipment sub-module of the Member Dashboard module 120 of FIG. 1A;

FIG. 40 is a block diagram of logical flow for the edit shipment's load/unload details process sub-module of the Member Dashboard module 120 of FIG. 1A;

FIGS. 41A-41B are block diagrams of logical flow for the edit upcoming trip as a shipper sub-module of the Member Dashboard module 120 of FIG. 1A;

FIGS. 42A-42B are block diagrams of logical flow for the edit upcoming trip as a driver sub-module of the Member Dashboard module 120 of FIG. 1A;

FIG. 43 is a block diagram of logical flow for the edit trip load details sub-module of the Member Dashboard module 120 of FIG. 1A;

FIG. 44 is a block diagram of logical flow for the edit trip unload details sub-module of the Member Dashboard module 120 of FIG. 1A;

FIGS. 45A-45C are block diagrams of logical flow for the complete, canceled and expired trip sub-modules of the Member Dashboard module 120 of FIG. 1A;

FIGS. 46-51 relate to logical flow for the various sub-modules of the Message Center 113 of FIG. 1A;

FIG. 46 is a block diagram of logical flow for the various message center views of the Message Center module 113 of FIG. 1A;

FIG. 47 is a block diagram of logical flow for the various message center actions of the Message Center module 113 of FIG. 1A;

FIG. 48 is a block diagram of logical flow for the individual pages of the Message Center module 113 of FIG. 1A;

FIG. 49 is a block diagram of logical flow for the compose new message page of the Message Center module 113 of FIG. 1A;

FIG. 50 is a block diagram of logical flow for the contact driver/shipper sub-module of the Message Center module 113 of FIG. 1A;

FIG. 51 is a block diagram of logical flow for the contact Kaargo member sub-module of the Message Center module 113 of FIG. 1A;

FIG. 52 (comprised of FIG. 52A and FIG. 52B) is a block diagram of logical processes in the find trips within certain distance and find shipments posted en route for an existing trip sub-modules in the Geo-location based search for trips and shipments module 118 of FIG. 1A;

FIG. 53 is a block diagram of logical processes in the Insurance sub-module of the Insurance module 107 of FIG. 1A;

FIG. 54 is a block diagram of logical processes in the vehicle and trip regulatory compliance sub-module of the Regulatory Compliance module 105 of FIG. 1A;

FIG. 55 is a block diagram of logical processes in the track my shipment sub-module of the Dashboard Compliance module 120 of FIG. 1A;

FIG. 56 is a block diagram of logical processes in the ticker sub-module of the search for trips and shipments module 118 of FIG. 1A;

FIG. 57A and FIG. 57B are block diagrams of logical processes in the My Favorite routes sub-modules of the Profile module 114 of FIG. 1A;

FIG. 58A and FIG. 58B are block diagrams of logical processes in the repeat trip and return trip sub-modules of the Dashboard module 120 of FIG. 1A;

FIG. 59 is a block diagram of logical processes in the shipments from multiple shippers in a trip module of the Purchase a Trip module 116 of FIG. 1A;

FIG. 60 is a block diagram of logical processes in the community affiliations module of the Public Profile module 115 of FIG. 1A;

FIG. 61 through FIG. 78 are representations of web pages, displayed on a client computer of a user, providing features and functionalities of a user interface in an embodiment suitable for use in connection with the embodiment of FIG. 1A;

FIG. 61 is a representation of a web page display of a post a trip sub-module which illustrates how vehicles types, vehicle images, make, model and year are captured in the user interface;

FIG. 62 is a representation of a web page display of a post a trip sub-module, which illustrates how all the trip details are previewed before being posted in the user interface;

FIG. 63 is a representation of a web page display of a post a shipment sub-module, which illustrates how multiple items, item images, quantity, dimension etc. are captured in the user interface;

FIG. 64 is a representation of a web page display of a post a shipment sub-module, which illustrates how all the shipment details are previewed before being posted in the user interface;

FIG. 65 is a representation of a web page display wherein a shipper can search for available trips based on an origin and a destination city;

FIG. 66 is a representation of a web page display of all available trips in the system for a given origin and a destination city route, and also includes refinement of the search criteria;

FIG. 67 is a representation of a web page display which may be invoked as part of purchase a trip process that shows a trip's load/unload details, vehicle used for the trip, driver details, ratings and reviews for the driver;

FIG. 68 is a representation of a web page display of a purchase a trip process, showing the items entered for that trip;

FIG. 69 is a representation of a web page display of the Purchase a Trip process, showing payment methods and the total amount to be paid for that trip.

FIG. 70 is a representation of a web page display of a purchase a trip process, showing successful completion of purchasing a trip, along with trip-related details;

FIG. 71 is a representation of a web page display wherein a driver can search for available shipments based on an origin and a destination city;

FIG. 72 is a representation of a web page display, in the purchase a trip flow, showing offers by drivers to make a trip for a shipment posted by a shipper for a given origin and a destination city route;

FIG. 73 is a representation of a web page display, in the driver proposal module flow, wherein a shipper is purchasing a trip based on a proposal received from a driver offering to undertake the trip;

FIG. 74 is a representation of a web page display, associated with a member personal profile;

FIG. 75 is a representation of a web page display of the dashboard;

FIG. 76 is a representation of a web page display of the edit trip details from the dashboard;

FIG. 77 is a representation of a web page display on a client computer of a driver, providing rating and review for the shipper from the dashboard; and

FIG. 78 is a representation of a web page display on a client computer of a shipper, providing a map with shipment tracking data in the form of contemporaneous geolocations that shows the current location of the shipment highlighted and a tracking history for that trip.

### DETAILED DESCRIPTION OF SPECIFIC EMBODIMENTS

Definitions. As used in this description and the accompanying claims, the following terms shall have the meanings indicated, unless the context otherwise requires:
A “set” includes at least one member.
A “server system” is an arrangement of a set of servers, coupled to a wide area network for communication with computer clients, for implementing a marketplace platform facilitating connection of consumer vehicle drivers with consumer shippers in accordance with embodiments of the present invention.
A “computer client” is a computer system, operated by a consumer shipper or a consumer vehicle driver, which may be implemented by a personal computer, a smartphone, a tablet computing device, or other portable or non-portable computing device running an application, such as a browser, that enables the computer system to be in communication with a server system over a wide area network, wherein the server system has the effect of controlling some processes running on the computer client. Optionally, the application is a dedicated application, and optionally the dedicated application is configured to execute on a smartphone.
A “credit facility” means a credit card or bank account or other credit arrangement; and a credit facility identifier means credit card data or bank account identification data.
The “origin” and “destination” of a “trip” by a first consumer in a motor vehicle are positions along a journey in the motor vehicle, wherein the journey includes the trip, but may also include travel in addition to the trip. For example, a first consumer driver may be planning to travel, for example, to an IKEA or Costco store, and the second consumer shipper may arrange to purchase a trip that has its origin at the IKEA or Costco store and its destination at the home of the consumer shipper, even though the journey taken by the first consumer driver includes travel, to the IKEA or Costco store, that is in addition to the trip.
“Causing stored trip data and stored shipment data to be searchable over the wide area network via a client computer” means providing a search engine, accessible to the client computer over the wide area network, configured to query the stored trip data and the stored shipment data and to transmit query results over the wide area network to the client computer.
A “computer process” is the performance of a described function in a computer using computer hardware (such as a processor, field-programmable gate array or other electronic combinatorial logic, or similar device), which may be operating under control of software or firmware or a combination of any of these or operating outside control of any of the foregoing. All or part of the described function may be performed by active or passive electronic components, such as transistors or resistors. In using the term “computer process” we do not necessarily require a schedulable entity, or operation of a computer program or a part thereof, although, in some embodiments, a computer process may be implemented by such a schedulable entity, or operation of a computer program or a part thereof. Furthermore, unless the context otherwise requires, a “process” may be implemented using more than one processor or more than one (single- or multi-processor) computer.

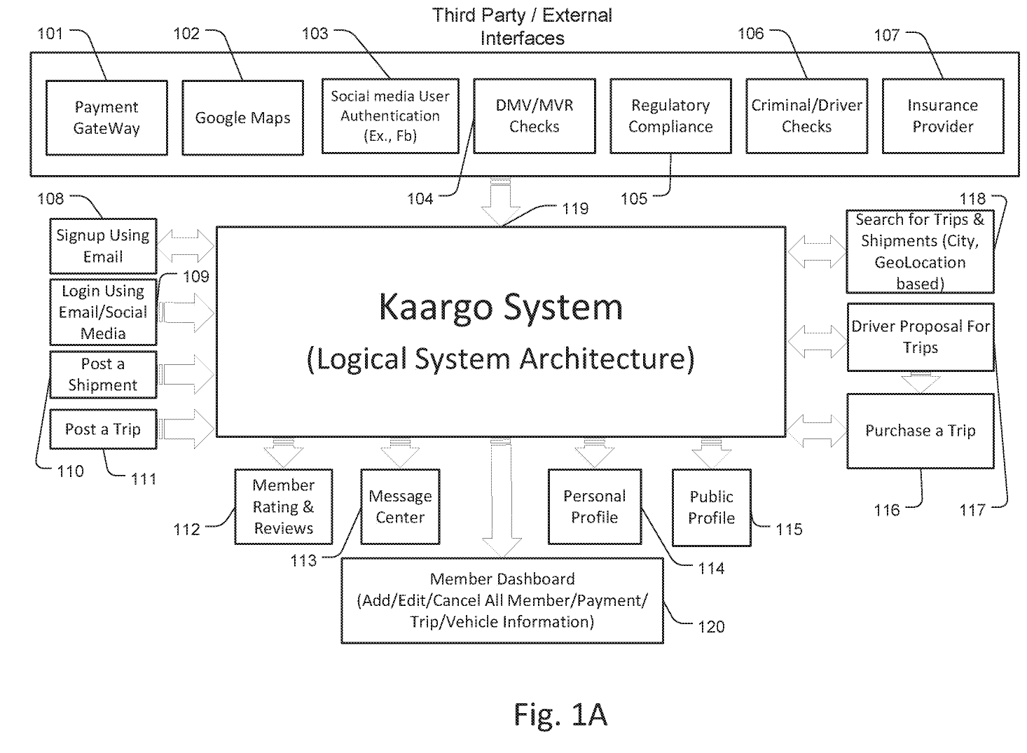

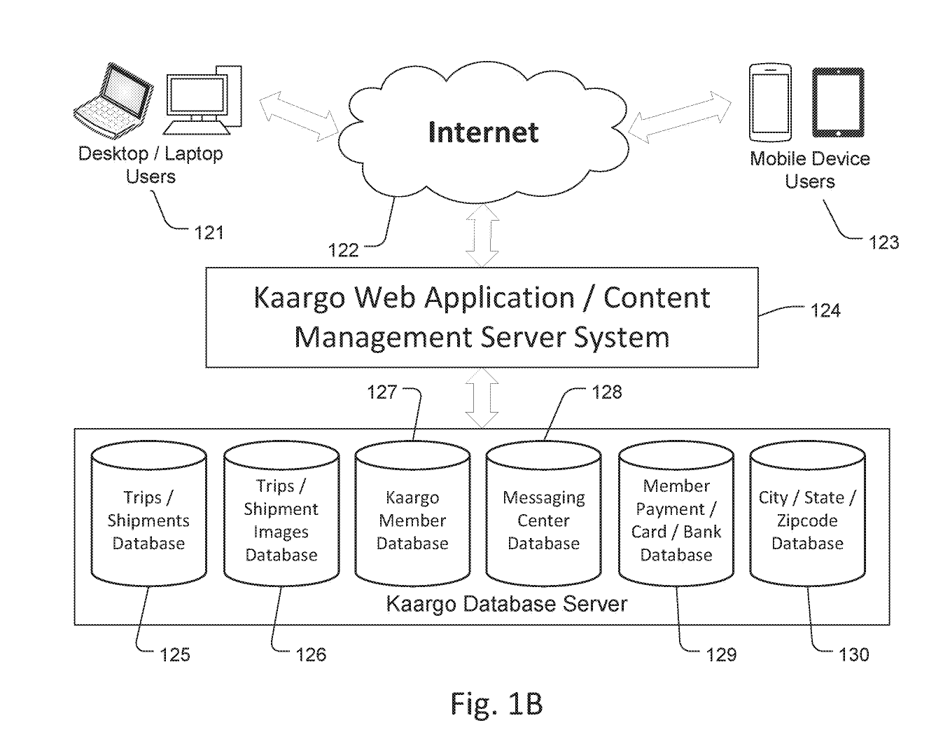

FIG. 1A is block diagram of the system architecture for logical processes used in an embodiment of the present invention. The system architecture of FIG. 1A, which is implemented on a server system, includes logical processes to implement a marketplace platform facilitating connection of consumer vehicle drivers with consumer shippers. In this marketplace there are consequently two classes of users: consumer vehicle drivers and consumer shippers. A consumer vehicle driver or a consumer shipper (whom we refer to collectively sometimes as a “member” or a “user”) can register in the marketplace using the Signup Using Email process 108. A Login Using Email/Social Media process 109 implements login by the consumer vehicle driver or consumer shipper. A consumer shipper can invoke the Post a Shipment process 110 and a consumer driver can invoke the Post a Trip process 111. The posted trips and posted shipments can be searched using the Search for Trips & Shipments process 118. There is a separate Driver Proposal for Trips process 117, which relates to the Purchase a Trip process 116, by which the consumer shipper can purchase a trip from the consumer driver. Each member can establish and update a personal profile using the Personal Profile process 114 and a public profile using the Public Profile process 115. Using the Message Center process 113, a member can send a message via the server system to another member. Ratings and reviews of a member (for which contributions can be posted by other members) are handled by Member Rating & Reviews process 112. A member can view and edit information pertaining to that member in the marketplace via the Member Dashboard process 120. Additionally, this embodiment provides processes for various external interfaces, including Payment Gateway process 101, Google® Maps process 102, Social Media User Authentication process 103, DMV/MVR Checks process 104, Regulatory Compliance process 105, Criminal/Driver Checks process 106, and Insurance Provider process 107. The foregoing processes are discussed in further detail below.

FIG. 1B is a block diagram of system architecture showing the storage modules used in connection with the embodiment of FIG. 1A. The storage modules of FIG. 1B, which are implemented in a storage database system on a server system, include logical database entities in the form of database tables to store all the data that is generated in the system. These storage modules are accessed by the members via the Kaargo marketplace through computer desktops and computer laptops 121 or through mobile phone devices or mobile tablet devices 123. All interactions between the member devices, the marketplace and storage databases occur over the internet 122. These interactions and communications among different entities are controlled and coordinated by the content management server system 124, which provides the Kaargo web application. The trips and shipments database 125 is used to store all persistent data related to all trips and shipments. The trips and shipments images database 126 is used to store various images such as vehicle images, item images used in the trips and shipments process. The member database 127 is used to store all member details. The messaging center database 128 is used to store all the messages and communication that occur between different members, as well as communication between the members and the Kaargo business entity. The member payment/card/bank database 129 is used to store various payments and credit/debit card information used in the system. The City, state, zip code database 130 is used to store the listing of all the cities and their corresponding zip codes. Use of the foregoing databases is discussed in further detail below in connection with logical processes used in embodiments of the present invention.

The platform established by the Kaargo web application uses a number of mechanisms (which we here call “pillars”) to increase security (and thereby to reduce risk) associated with use of the platform. One pillar is to require the shipper to provide a photograph of the shipment. The driver is provided with an instruction to refuse the shipment if the photograph does not match the item to be shipped (regardless whether the difference appears to be innocuous). Additional pillars include the following, where the code “M” means that the pillar is mandatory and the code “O” means that the pillar is optional):
Agreement to terms of service of the platform (M)
Minimum age requirement (M)
Credit card, address, and related personal information (M)
Profile picture and description (O), although failure to provide this information will decrease the likelihood of a transaction with this member, because failure to supply this information may cause the member to be viewed as potentially and comparatively less trustworthy
Community affiliations (universities, groups, affiliations) badges (O)
Facebook, Google verification badge (O)
Shipper declaration (M) and driver declaration (M), required each time something is shipped or driven; the driver's declaration must be agreed to by the driver, and the shipper's declaration must be agreed to by the shipper; the driver's declaration includes attestation of insurance, legal authority to operate vehicle, no DWI or criminal conviction, etc.; the shipper's declaration includes attestation that the shipment contains no item on a list of prohibited items, etc.
Rating and review (M), even though optional with typical web sites

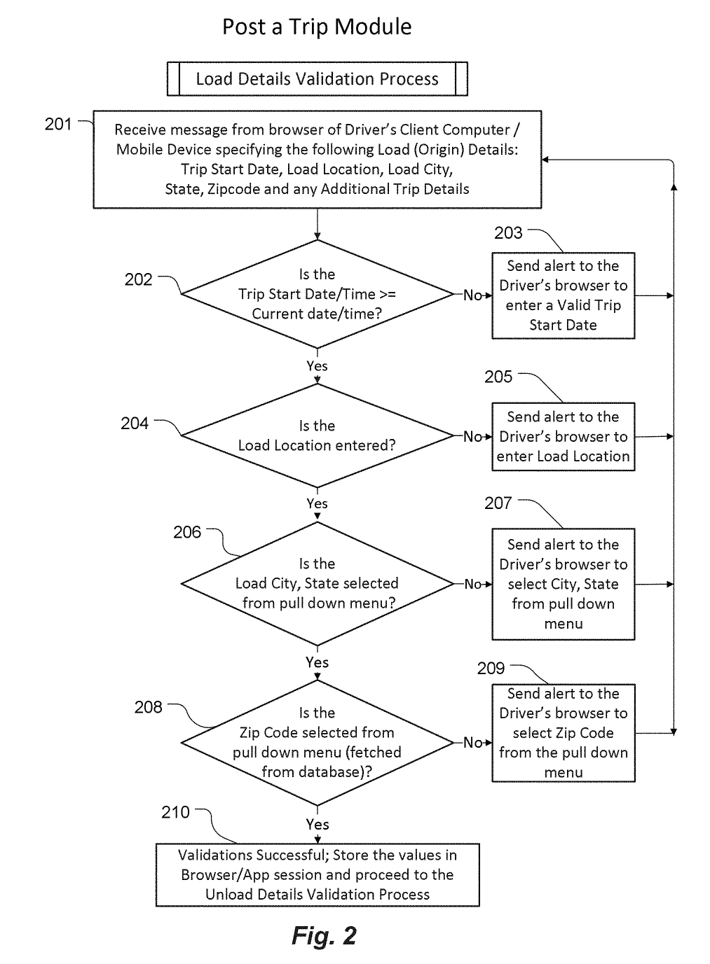

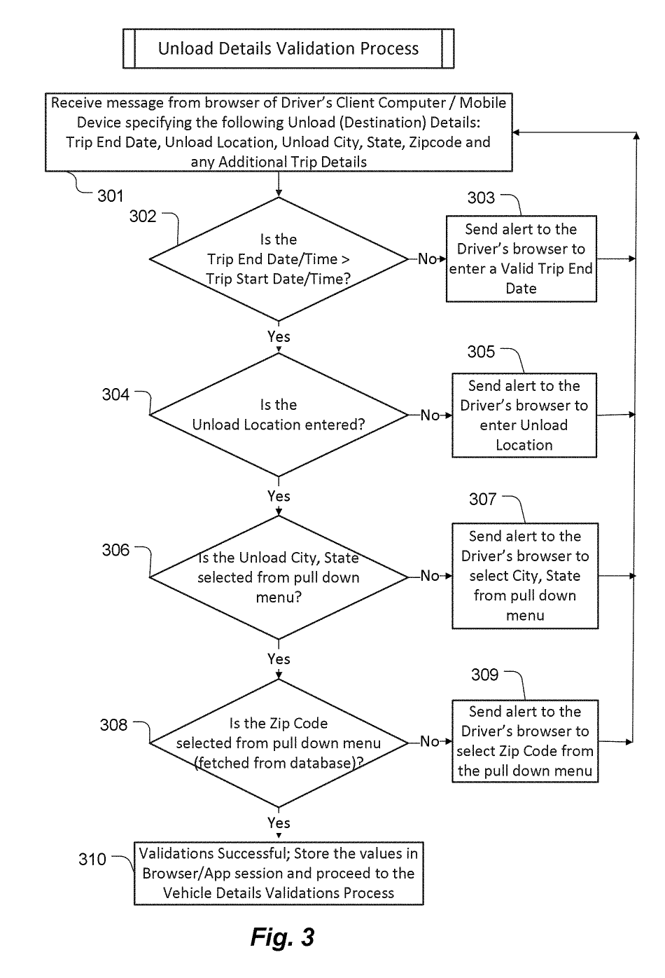

FIGS. 2-6 relate to logical flow for the Post a Trip module 111 of FIG. 1A. FIG. 2 is a block diagram of the load details validation process for the Post a Trip module 111 of FIG. 1A. In this module, in process 201, the server system receives a message from a computer client (sometimes called “client computer” or “client”) of a driver with load specific details such as trip start date/time, load location address, load city, state, zip code, and any other additional trip details. In subsequent processes, a series of validation tests are run. If any of the validations fail, appropriate alerts are sent to the client so that they can be rectified. Specifically, in process 202, it is determined whether the trip date and time are on or after the present date and time; if not, then, in process 203, an alert is sent to the driver's browser requiring entry of valid data. In process 204, there is testing whether the load location has been entered; if not, then, in process 205, an alert is sent to the driver's browser requiring entry of the appropriate data. In process 206, there is testing whether the load city and state have been entered from a pull-down menu; if not, then in process 207, an alert is sent to the driver's browser requiring use of the pull-down menu to enter the load city and state. In process 208, there is testing whether the zip code of the load location has been correctly entered; if not, then, in process 209, the driver is prompted to make a correction. If, after all of these tests, all data has been determined to have been entered correctly, then in process 210, the entered data is stored, and processing moves to the unload details validation processing of FIG. 3.

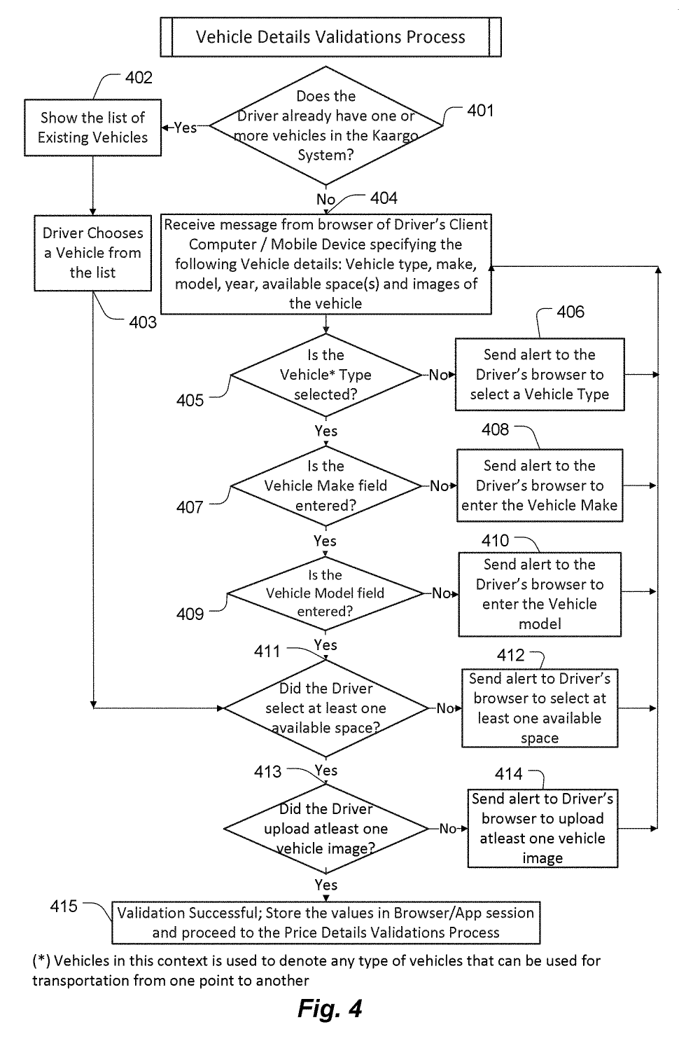

FIG. 3 is a block diagram of the unload details validation process for the Post a Trip module 111 of FIG. 1A. In this module, in process 301, the server system receives a message from computer client of a member with unload specific details such as trip start date/time, unload location address, unload city, state, zip code, and any other additional trip details. In subsequent processes, a series of validation tests are run. If any of the validations fail appropriate alerts are sent to the client so that they can be rectified. Specifically, in process 302, it is determined whether the unload trip date and time are on or after the load date and time; if not, then, in process 303, an alert is sent to the driver's browser requiring entry of valid data. In process 304, there is testing whether the unload location has been entered; if not, then, in process 305, an alert is sent to the driver's browser requiring entry of the appropriate data. In process 306, there is testing whether the unload city and state have been entered from a pull-down menu; if not, then in process 307, an alert is sent to the driver's browser requiring use of the pull-down menu to enter the unload city and state. In process 308, there is testing whether the zip code of the unload location has been correctly entered; if not, then, in process 309, the driver is prompted to make a correction. If, after all of these tests, all data has been determined to have been entered correctly, then in process 310, the entered data is stored and processing moves to the vehicle details validation processing of FIG. 4.

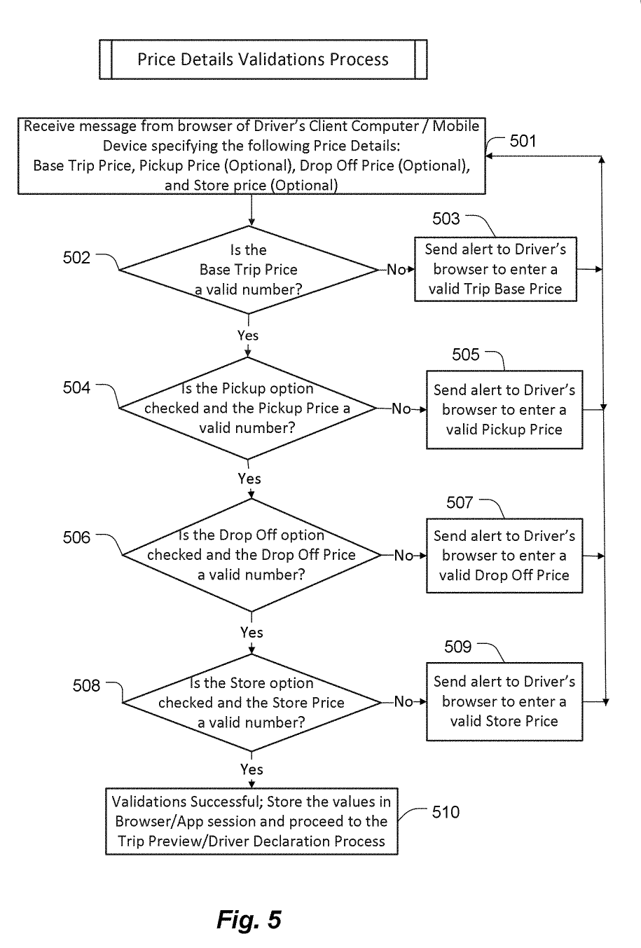

FIG. 4 is a block diagram of the vehicle details validation process for the Post a Trip module 111 of FIG. 1A. In this module, in process 401, there is testing whether the driver already has one or more vehicles in the system; if so, then, in process 402, the server system sends a message to computer client with a list of existing vehicles. In process 403, the driver chooses a vehicle from an existing list of vehicles. In process 401, there is testing whether the driver already has one or more vehicles in the system; if not, then in process 404, the server system receives a message from computer client with vehicle specific details such as vehicle type, vehicle make, vehicle model, year and available spaces in the vehicle. In process 405, there is testing whether the vehicle type is selected; if not, then in process 406, an alert is sent to the driver's browser requiring selection of the vehicle type. In process 407, there is testing whether the vehicle make field has been entered; if not, then in process 408, an alert is sent to the driver's browser requiring the driver to enter the vehicle make. In process 409, there is testing whether the vehicle model field has been entered; if not, then in process 410, an alert is sent to the driver's browser requiring the driver to enter the vehicle model. In process 411, there is testing whether the driver has selected at least one available space in the vehicle; if not, then in process 412, an alert is sent to the driver's browser requiring the driver to select at least one available space. In process 413, there is testing whether the driver has uploaded at least one photograph of the vehicle; if not, then in process 414, an alert is sent to the driver's browser requiring the driver to upload at least one photograph of the vehicle. If, after all of these tests, all data has been determined to have been entered correctly, then in process 415, the entered data is stored, and processing moves to the price details validation processing of FIG. 5. In a related embodiment, the driver may upload a photograph of the vehicle, which, after being uploaded, constitutes part of the information about the vehicle that is made available to a prospective shipper. The photograph of the vehicle provides the prospective shipper with additional information by which to assess suitability of the vehicle's space and dimensions for transporting the shipper's shipment.

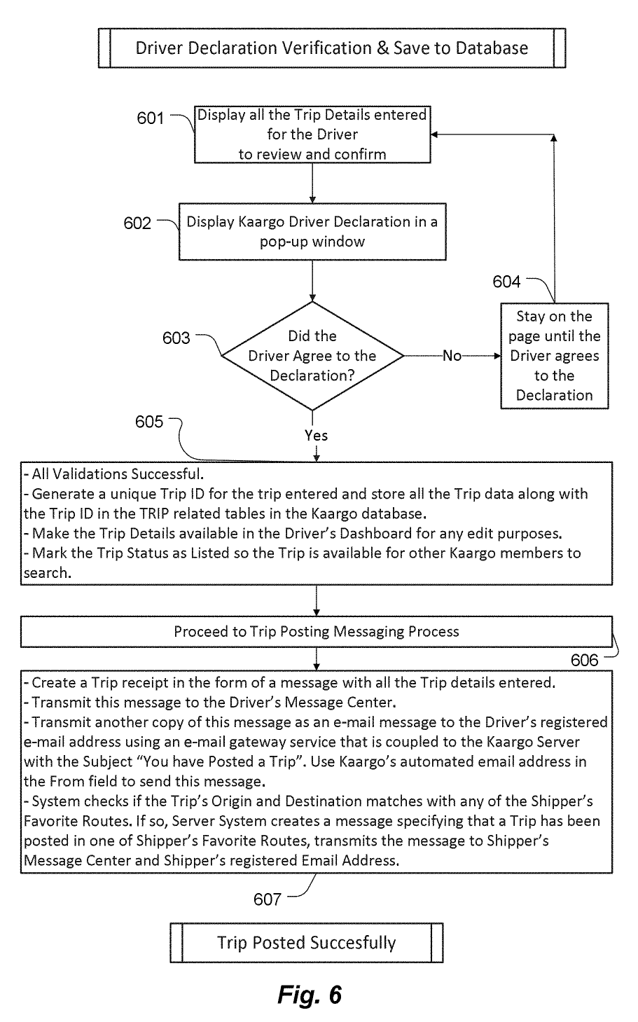

FIG. 5 is a block diagram of the price details validation process for the Post a Trip module 111 of FIG. 1A. In this module, in process 501, the server system receives a message from computer client with price specific details such as base trip price, pickup price, drop off price and storage or store price. In process 502, there is testing whether the base trip price is a valid number; if not, then in process 503, the driver is prompted to make a correction. In process 504, there is testing whether the pickup option is checked and whether the pickup price is a valid number; if not, then in process 505, the driver is prompted to make a correction. In process 506, there is testing whether the drop off option is checked and whether the drop off price is a valid number; if not, then in process 507, the driver is prompted to make a correction. In process 508, there is testing whether the store option is checked and whether the store price is a valid number; if not, then in process 509, the driver is prompted to make a correction. If, after all of these tests, all data has been determined to have been entered correctly, then in process 510, the entered data is stored, and processing moves to the driver declaration verification and saving to database process of FIG. 6.

FIG. 6 is a block diagram of the driver declaration verification and saving to database process for the Post a Trip module 111 of FIG. 1A. In this module, in process 601, all the trip related details are displayed for the driver to review and confirm. In process 602, a driver declaration is displayed in a pop-up window. In process 603, there is testing whether the driver agreed to the declaration, without which the driver will not be able to proceed with the trip posting; if not, then in process 604, the driver is prompted to agree to the declaration. If, after all of these tests, all data has been determined to have been entered correctly, then in process 605, a unique Trip ID number is generated for the trip and all the trip related data entered is stored in database. These details also become available in the driver's dashboard for any trip edit purposes. The status of the trip is marked as listed so the trip becomes available when shippers search for matching trips or parameters. In process 606, trip posting messaging process starts. In process 607, server system creates a trip receipt in the form of a message with all the trip details; server system transmits this message to the driver's message center; server system transmits another copy of this message as an e-mail message to the driver's registered e-mail address using an e-mail gateway service with the subject “You have Posted a Trip” with the server system's automated e-mail address in the From field of this message. In addition, the server system checks if the Trip's origin and destination matches with any favorite routes pre-specified at any time earlier by any of the shippers, then, the server system creates an alert in the form of a message with the origin city and destination city details; the server system transmits this message to the shipper's message center; the server system transmits another copy of this message as an e-mail message to the shipper's registered e-mail address using an e-mail gateway service with the subject “Favorite Route Alert” with the server system's automated e-mail address in the From field of this message. After all this processing, the trip is considered to have been posted successfully. In a related embodiment of the present invention, the driver is offered an opportunity to add other optional add-on services such as pick up, drop off and storage, which are reflected as part of the terms of a posted trip.

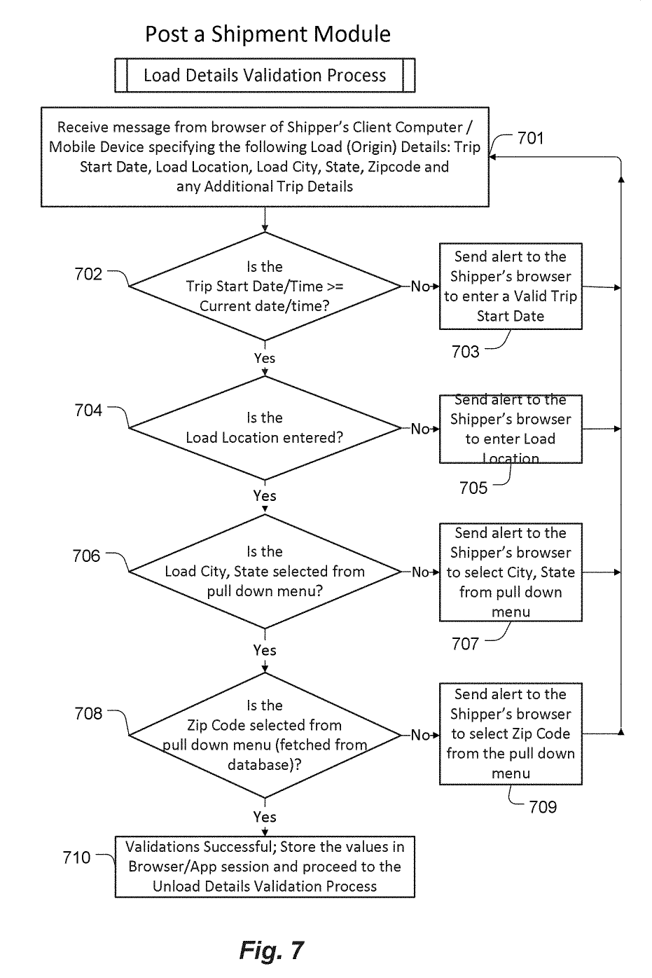

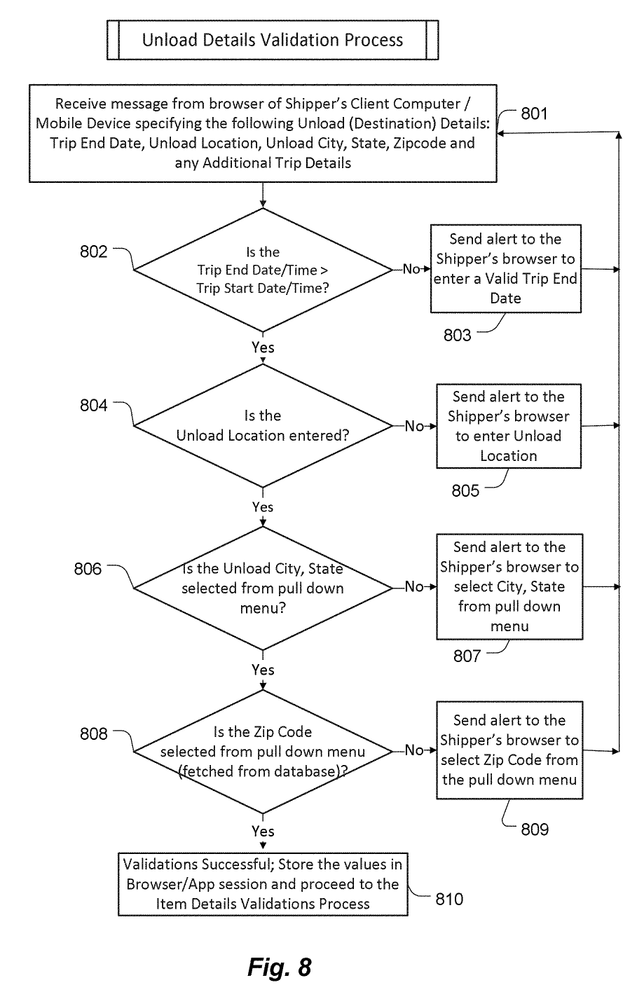

FIGS. 7-10 relate to logical flow for the Post a Shipment module 110 of FIG. 1A. FIG. 7 is a block diagram of the load details validation process for the Post a Shipment module 110 of FIG. 1A. In this module, in process 701, the server system receives a message from the computer client with load specific details such as trip start date/time, load location address, load city, state, zip code, and any other additional trip details. In subsequent processes, a series of validation tests are run. If any of the validations fail, appropriate alerts are sent to the client so that they can be rectified. Specifically, in process 702, it is determined whether the trip date and time are on or after the present date and time; if not, then, in process 703, an alert is sent to the shipper's browser requiring entry of valid data. In process 704, there is testing whether the load location has been entered; if not, then, in process 705, an alert is sent to the shipper's browser requiring entry of the appropriate data. In process 706, there is testing whether the load city and state have been entered from a pull-down menu; if not, then in process 707, an alert is sent to the shipper's browser requiring use of the pull-down menu to enter the load city and state. In process 708, there is testing whether the zip code of the load location has been correctly entered; if not, then, in process 709, the shipper is prompted to make a correction. If, after all of these tests, all data has been determined to have been entered correctly, then, in process 710, the entered data is stored, and processing moves to the unload details validation processing of FIG. 8.

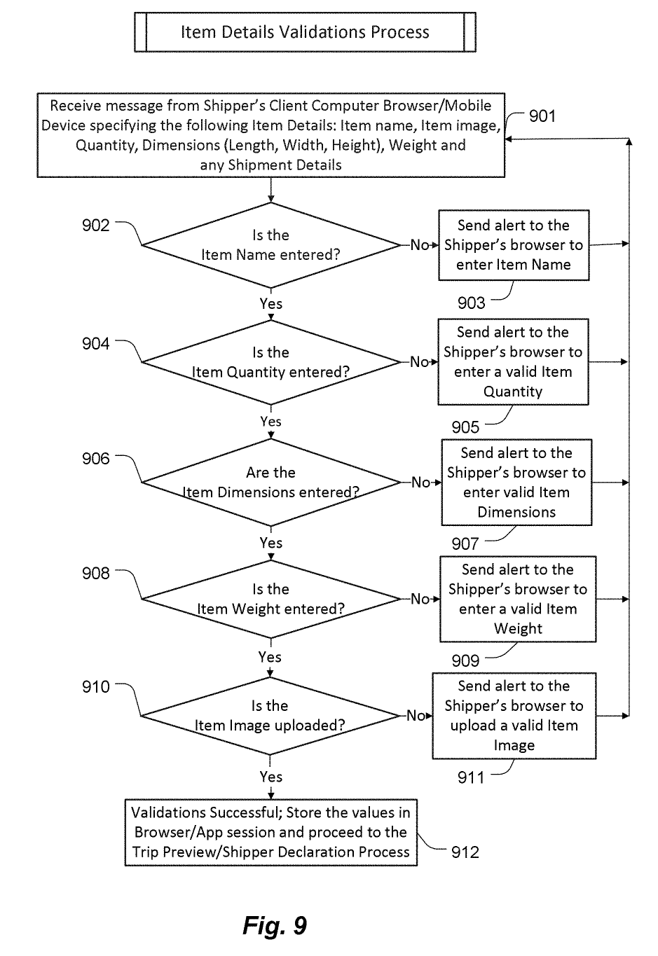

FIG. 8 is a block diagram of the unload details validation process for the Post a Shipment module 110 of FIG. 1A. In this module, in process 801, the server system receives a message from the computer client with unload specific details such as trip start date/time, unload location address, unload city, state, zip code, and any other additional trip details. In subsequent processes, a series of validation tests are run. If any of the validations fail appropriate alerts are sent to the client so that they can be rectified. Specifically, in process 802, it is determined whether the unload trip date and time are on or after the load date and time; if not, then, in process 803, an alert is sent to the shipper's browser requiring entry of valid data. In process 804, there is testing whether the unload location has been entered; if not, then, in process 805, an alert is sent to the shipper's browser requiring entry of the appropriate data. In process 806, there is testing whether the unload city and state have been entered from a pull-down menu; if not, then in process 807, an alert is sent to the shipper's browser requiring use of the pull-down menu to enter the unload city and state. In process 808, there is testing whether the zip code of the unload location has been correctly entered; if not, then, in process 809, the shipper is prompted to make a correction. If, after all of these tests, all data has been determined to have been entered correctly, then in process 810, the entered data is stored and processing moves to the items details validation processing of FIG. 9.

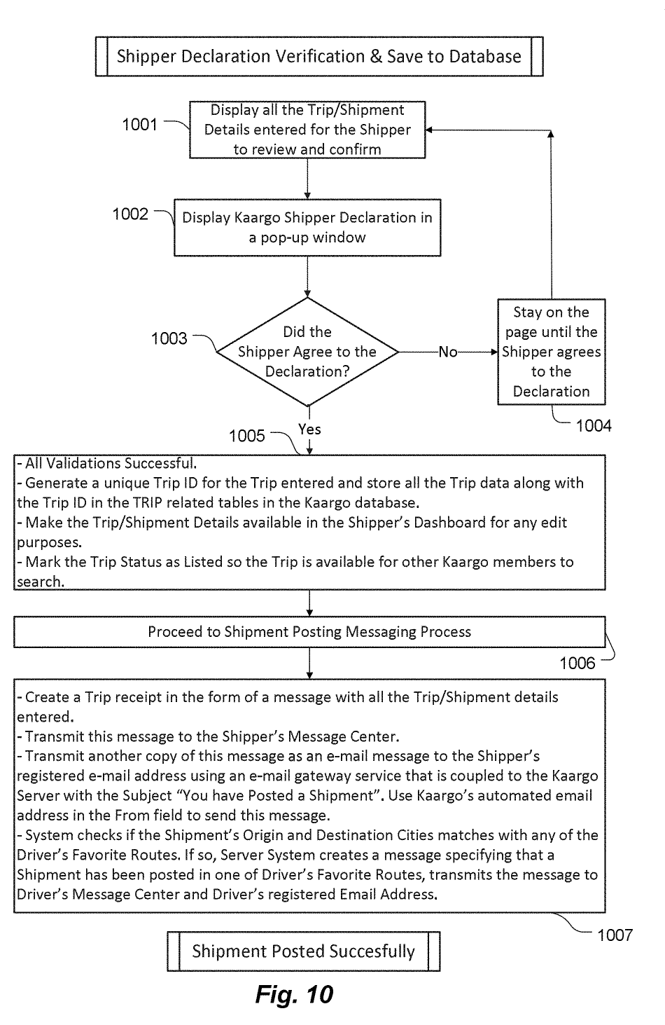

FIG. 9 is a block diagram of the item details validation process for the Post a Shipment module 110 of FIG. 1A. In this module, in process 901, the server system receives a message from shipper's computer client with item specific details such as item name, item image, quantity, dimensions, weight and any other additional shipment details. In subsequent processes, a series of validation tests are run. If any of the validations fail, appropriate alerts are sent to the shipper's browser so that they can be rectified. Specifically, in process 902, it is determined whether the item name is entered; if not, then, in process 903, an alert is sent to the shipper's browser requiring entry of valid data. In process 904, there is testing whether the item quantity has been entered; if not, then, in process 905, an alert is sent to the shipper's browser requiring entry of the appropriate data. In process 906, there is testing whether the item dimensions are entered; if not, then in process 907, an alert is sent to the shipper's browser requiring entry of the appropriate data. In process 908, there is testing whether the item weight has been entered; if not, then, in process 909, the shipper is prompted to make a correction. In process 910, there is testing whether the mandatory item photograph has been uploaded; if not, then, in process 911, the shipper is prompted to upload a valid item photograph. If, after all of these tests, all data has been determined to have been entered correctly, then in process 912, the entered data is stored and processing moves to the shipper declaration verification and saving to database process of FIG. 10. The shipper is required, for each shipment, to upload a photograph of the shipment, which, after being uploaded, constitutes part of the information about the shipment that is made available to a prospective driver. The server system provides a mandatory instruction to the driver that the driver should refuse the shipment if the item presented to be shipped does not match the uploaded photograph of the item to be shipped. The combination of the uploaded photograph and the instruction to refuse the shipment if it fails to match the uploaded photograph is one of the features of the present embodiment that reduces the transactional risk of using the platform.

FIG. 10 is a block diagram of the shipper declaration verification and saving to database process for the Post a Shipment module 110 of FIG. 1A. In this module, in process 1001, all the trip and shipment related details are displayed for the shipper to review and confirm. In process 1002, shipper declaration is displayed in a pop-up window. In process 1003, there is testing whether the shipper agreed to the declaration, without which, the shipper will not be able to proceed with the shipment posting; if not, then in process 1004, the shipper is prompted to agree to the declaration. If, after all of these tests, all data has been determined to have been entered correctly, then in process 1005, a unique Trip ID number is generated for the trip and all the trip related data entered is stored in database. These details also become available in the shipper's dashboard for any trip or shipment edit purposes. The status of the shipment is marked as listed so the shipment becomes available when drivers search for matching shipments. In process 1006, shipment posting messaging process starts. In process 1007, server system creates a trip receipt in the form of a message with all the trip and shipment details; the server system transmits this message to the shipper's message center; the server system transmits another copy of this message as an e-mail message to the shipper's registered e-mail address using an e-mail gateway service with the subject “You have Posted a Shipment” with the server system's automated e-mail address in the From field of this message. In addition, the server system checks if the shipment's origin and destination matches with any favorite routes specified by any of the drivers, then, the server system creates an alert in the form of a message with the origin city and destination city details; the server system transmits this message to the driver's message center; the server system transmits another copy of this message as an e-mail message to the driver's registered e-mail address using an e-mail gateway service with the subject “Favorite Route Alert” with the server system's automated e-mail address in the From field of this message. After all this processing, the shipment is considered to have been posted successfully.

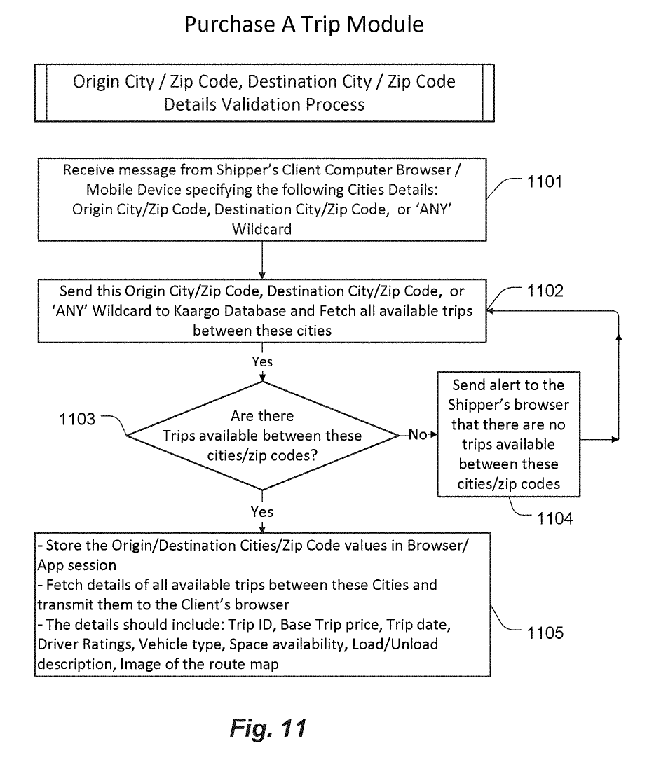

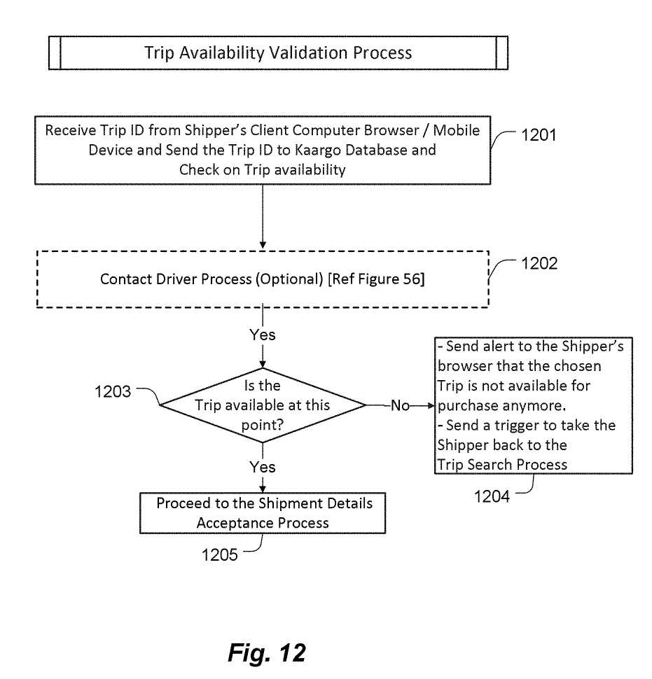

FIGS. 11-16 relate to logical flow for the Purchase a Trip module 116 of FIG. 1A. FIG. 11 is a block diagram of the origin city, destination city details validation process for the Purchase a Trip module 116 of FIG. 1A. In this module, in process 1101, the server system receives a message from shipper's computer client with origin city and destination city details. In process 1102, the server system sends a message to the shipper's computer client providing details of all available trips between the origin city and destination city. In process 1103, there is testing whether there are trips available between origin city and destination city; if not, then, in process 1104, an alert is sent to the shipper's browser that there are no trips available between the origin city and destination city. If, after these tests, it has been determined that there are trips available between the origin city and the destination city, then in process 1105, the entered data is stored in the browser session; the server system fetches details of all available trips between the origin city and the destination city, including information such as trip ID, base trip price, trip date, driver ratings, vehicle type, space availability, load description, unload description, image of the route map, and transmits them to the shipper's computer client, and processing moves to the trip availability validation processing of FIG. 12.

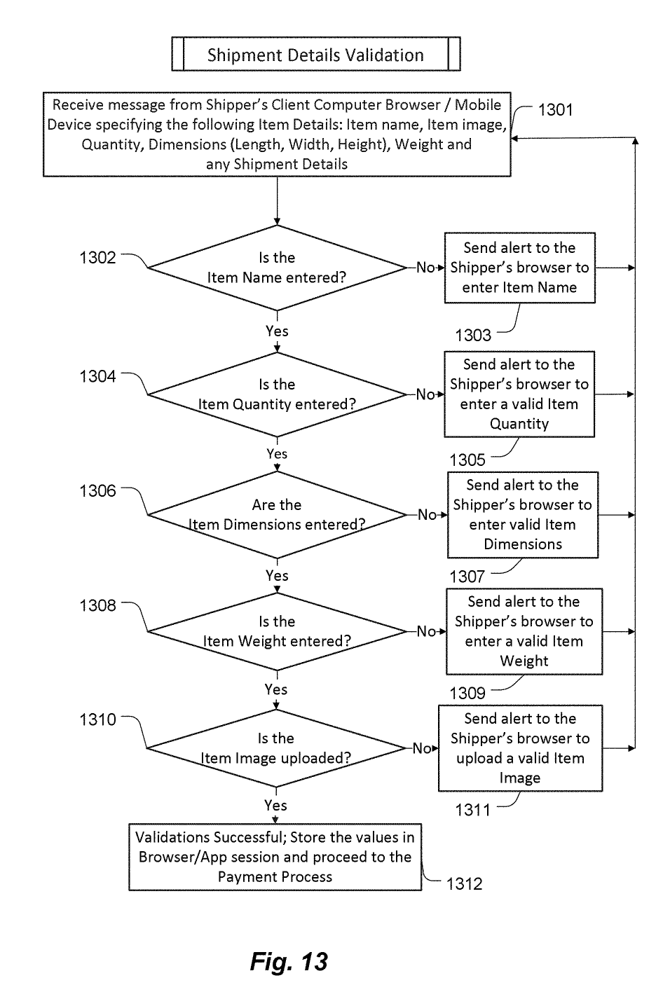

FIG. 12 is a block diagram of the trip availability validation process for the Purchase a Trip module 116 of FIG. 1A. In this module, in process 1201, the server system receives a message from the shipper's computer client with trip ID; subsequently, the server system sends the trip ID to the trips database to check on trips availability for that particular trip ID. In process 1202, there is optionally provided a facility for the shipper to contact the driver via message center module 113 of FIG. 1A. In process 1203, there is testing whether the trip is available for purchase at that point; if not, then in process 1204, the server system transmits a message to the shipper's computer client that the chosen trip is no longer available for purchase; subsequently, the server system transmits a message to the shipper's computer client to take the shipper back to the trip search process. If, after the above test, if the trip is available for purchase at this point, then in process 1205, the processing moves to the shipment details validation process of FIG. 13.

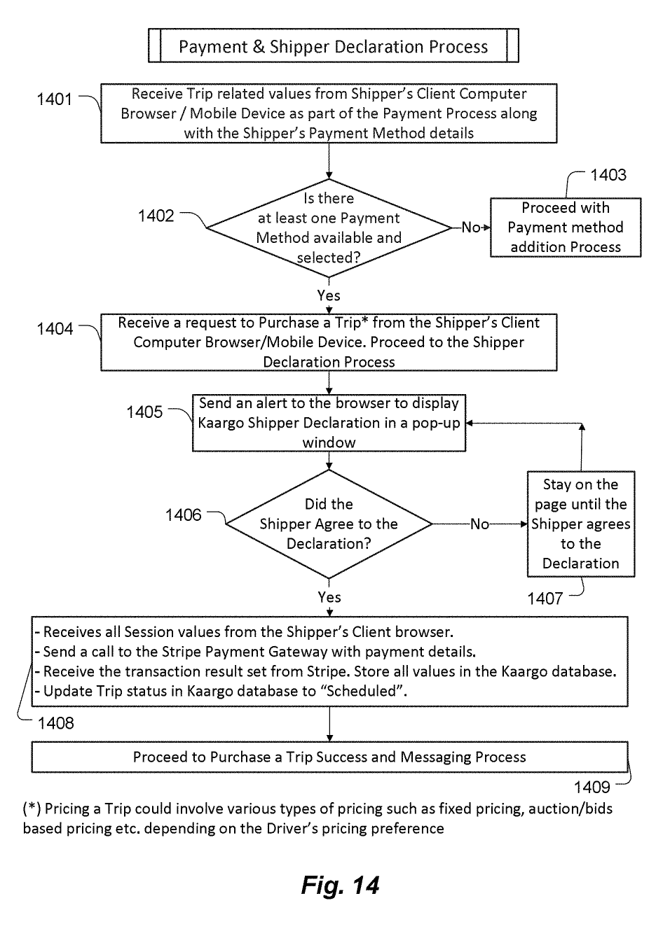

FIG. 13 is a block diagram of the shipment details validation process for the Purchase a Trip module 116 of FIG. 1A. In this module, in process 1301, the server system receives a message from the computer client of the shipper with item specific details such as item name, item image, quantity, dimensions, weight and any other additional shipment details. In subsequent processes, a series of validation tests are run. If any of the validations fail, appropriate alerts are sent to the client so that they can be rectified. Specifically, in process 1302, it is determined whether the item name is entered; if not, then, in process 1303, an alert is sent to the shipper's browser requiring entry of valid data. In process 1304, there is testing whether the item quantity has been entered; if not, then, in process 1305, an alert is sent to the shipper's browser requiring entry of the appropriate data. In process 1306, there is testing whether the item dimensions are entered; if not, then in process 1307, an alert is sent to the shipper's browser requiring entry of the appropriate data. In process 1308, there is testing whether the item weight has been entered; if not, then, in process 1309, the shipper is prompted to make a correction. In process 1310, there is testing whether the item photograph has been uploaded; if not, then, in process 1311, the shipper is prompted to upload a valid item photograph. If, after all of these tests, all data has been determined to have been entered correctly, then in process 1312, the entered data is stored and processing moves to the payment and shipper declaration verification process of FIG. 14. As previously described, the shipper is required, for each shipment, to upload a photograph of the shipment, which, after being uploaded, constitutes part of the information about the shipment that is made available to a prospective driver. The server system provides an instruction to the driver that the driver should refuse the shipment if the item to be shipped does not match the uploaded photograph of the item to be shipped. The combination of the uploaded photograph and the instruction to refuse the shipment if it fails to match the uploaded photograph is one of the features of the present embodiment that reduces the transactional risk of using the platform.

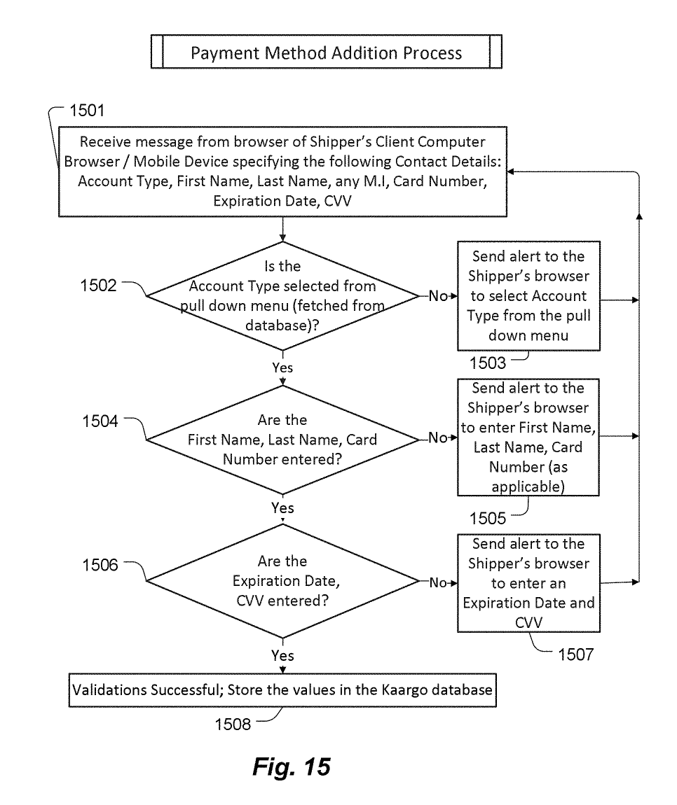

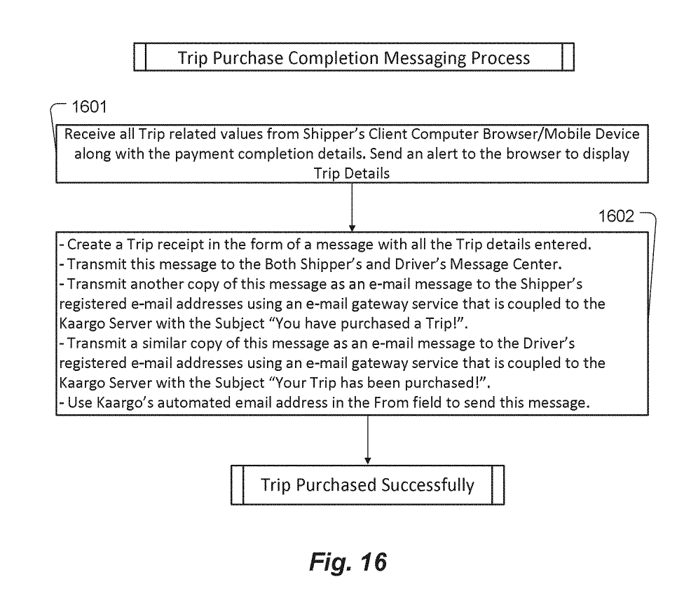

FIG. 14 is a block diagram of the payment and shipper declaration verification and saving to database process for the Purchase a Trip module 116 of FIG. 1A. In this module, in process 1401, the server system receives a message from the computer client of the shipper with the shipper's chosen payment method details such as payment mode, credit or debit card number, expiration date. In process 1402, there is testing whether there is at least one payment method available in the system and selected; if not, then in process 1403, the shipper is prompted to proceed with payment method addition process of FIG. 15. In process 1404, server system receives a message from shipper's computer client to purchase a trip. In process 1405, shipper declaration is displayed in a pop-up window. In process 1406, there is testing whether the shipper agreed to the declaration, without which, the shipper will not be able to proceed with the trip purchase; if not, then in process 1407, the shipper is prompted to agree to the declaration. If, after all of these tests, all data has been determined to have been entered correctly, then in process 1408, a call is made to the payment gateway using a remote API connection along with the shipper's payment details. Subsequently, server system receives the transaction results from the payment gateway, and other trip and purchase related data is stored in database. The server system updates the trip status to “Scheduled”. In process 1409, the processing moves to trip purchase completion messaging process of FIG. 16.

FIG. 15 is a block diagram of the optional payment method addition process for the Purchase a Trip module 116 of FIG. 1A. In this module, in process 1501, the server system receives a message from shipper's computer client with the shipper's account specific details such as shipper's first name, last name, middle initial, credit or debit card number, expiration date and CVV details. In subsequent processes, a series of validation tests are run. If any of the validations fail, appropriate alerts are sent to the shipper's client so that they can be rectified. Specifically, in process 1502, there is testing whether account type is selected from the pull down menu; if not, then, in process 1503, an alert is sent to the shipper's browser requiring entry of valid data. In process 1504, there is testing whether the first name, last name and credit or debit card number have been entered; if not, then, in process 1505, an alert is sent to the shipper's browser requiring entry of the appropriate data. In process 1506, there is testing whether the expiration date and CVV have been entered; if not, then in process 1507, the shipper is prompted to make a correction. If, after all of these tests, all data has been determined to have been entered correctly, then in process 1508, the entered data is stored and processing moves to trip purchase completion messaging processing of FIG. 16.

FIG. 16 is a block diagram of the trip purchase completion messaging process for the Purchase a Trip module 116 of FIG. 1A. In this module, in process 1601, the server system receives a message from shipper's computer client with all the trip and payment completion details. In process 1602, the server system performs a series of actions. Specifically, server system creates a trip receipt in the form of a message with all the trip details; server system transmits this message to both the shipper's and driver's message center; server system transmits another copy of this message as an e-mail message to the shipper's registered e-mail address using an e-mail gateway service with the subject “You have purchased a Trip” with the server system's automated e-mail address in the From field of this message. In addition, server system transmits another copy of this message as an e-mail message to the driver's registered e-mail address using an e-mail gateway service with the subject “Your Trip has been purchased” with the server system's automated e-mail address in the From field of this message. After all these processing, the trip is considered to have been purchased successfully.

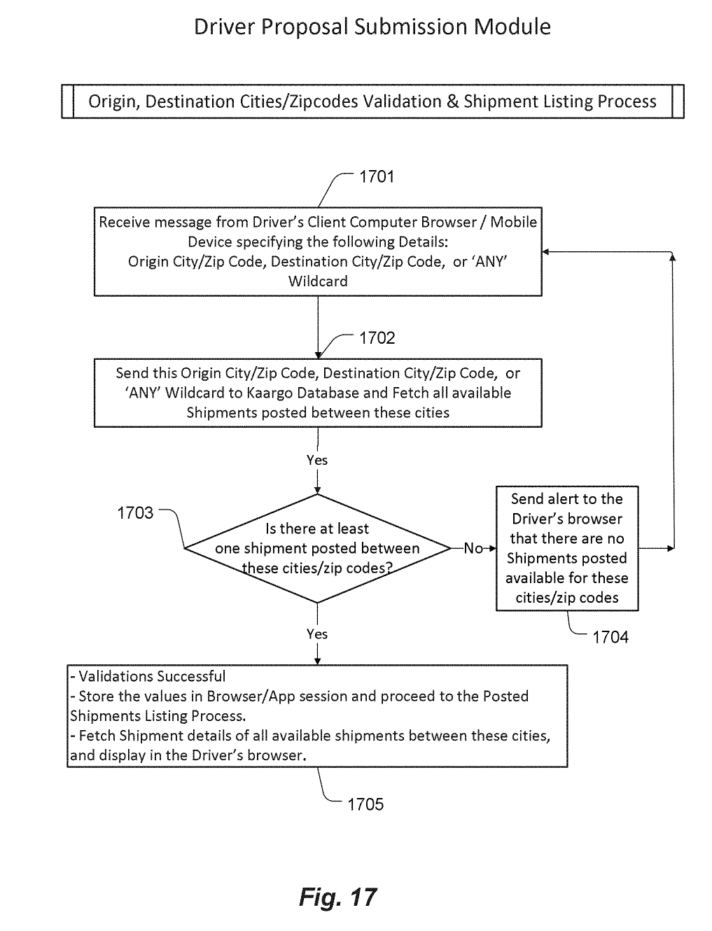

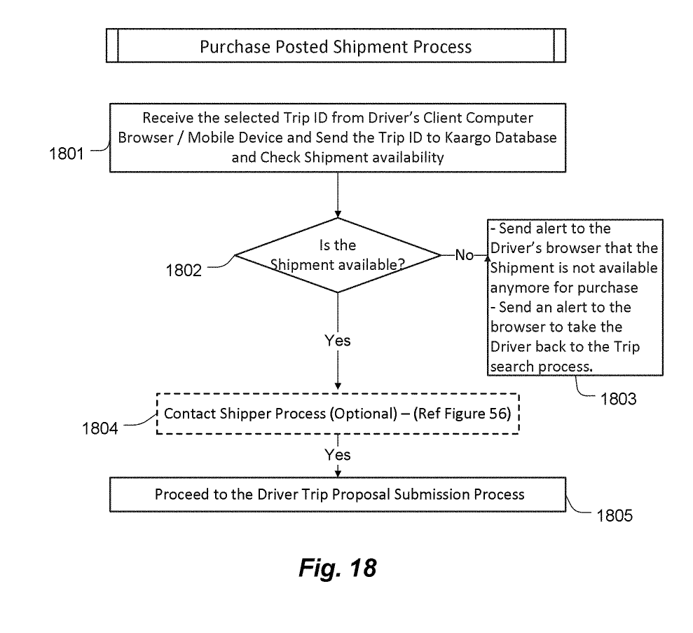

FIGS. 17-19 relate to logical flow for the Driver Proposal module 117 of FIG. 1A. FIG. 17 is a block diagram of the driver trip proposal submission process for the Driver Proposal Submission module 117 of FIG. 1A. In this module, in process 1701, the server system receives a message from the computer client with origin city and destination city details. In process 1702, the server system sends a message to the computer client details of all available shipments between the origin city and the destination city. In process 1703, there is testing whether there is at least one shipment available between the origin city and the destination city; if not, then, in process 1704, an alert is sent to the driver's browser that there are no shipments available between the origin city and the destination city. If, after these tests, if it has been determined that there are shipments available between origin city and destination city, then in process 1705, the entered data is stored in the browser session; the server system fetches details of all available shipments between the origin city and the destination city, such as trip ID, trip date, shipper ratings, item, item description, item dimensions (length, width, height), item quantity, item image for each item in the shipment, and transmits them to computer client, and processing moves to the purchase posted shipment processing of FIG. 18.

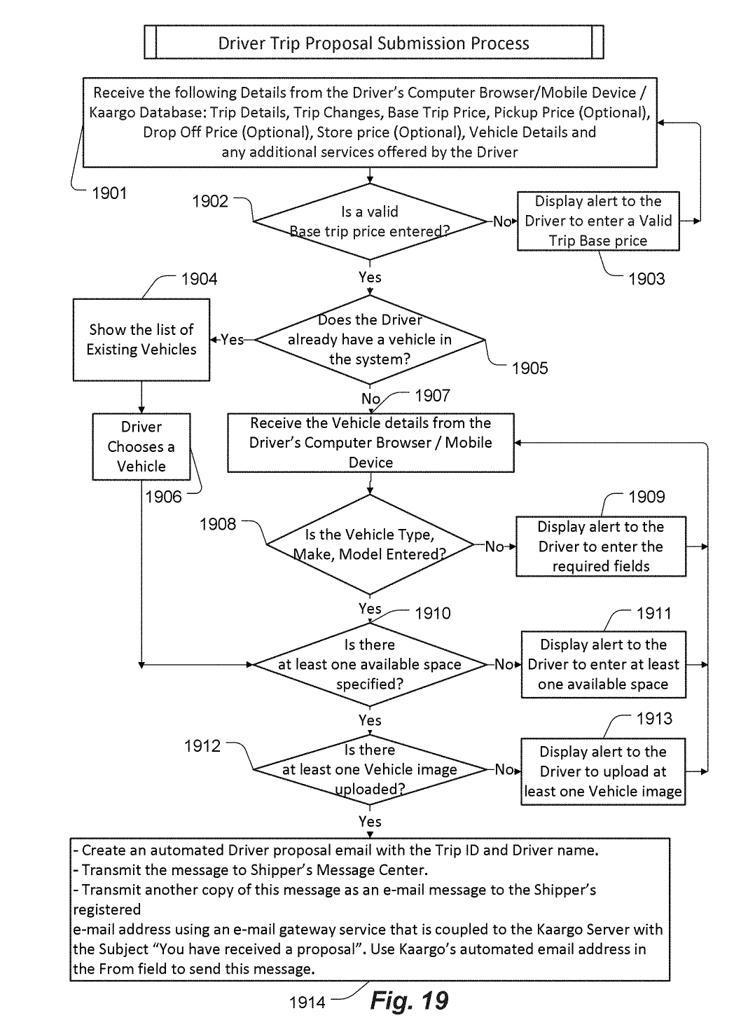

FIG. 18 is a block diagram of the purchase proposed trip process for the Driver Proposal Submission module 117 of FIG. 1A. In this module, in process 1801, the server system receives a message from the computer client of a driver with trip ID. The server system sends the trip ID to database to check for shipment availability. In process 1802, there is testing whether a shipment is available; if not, then in process 1803, the server system transmits a message to the driver's browser that the shipment is no longer available for driver proposal; the server system transmits a message to the computer client of the driver to take the driver back to the trip search process. In process 1804, there is a facility available for the driver to optionally contact a shipper via message center module 113 of FIG. 1A. In process 1805, the processing moves to driver trip proposal submission process of FIG. 19.

FIG. 19 is a block diagram of the driver trip proposal submission process for the Driver Proposal Submission module 117 of FIG. 1A. In this module, in process 1901, the server system receives a message from computer client of the driver with the trip details such as trip ID, trip changes, base trip price, pick up price (optional), drop off price (optional) storage price (optional) and vehicle details. In process 1902, there is testing whether a valid base trip price is entered; if not, then in process 1903, the driver is prompted to make a correction. In process 1905, there is testing whether the driver already has a vehicle in the system; If so, then in process 1904, the server system transmits a message to the driver's computer client to display the list of existing vehicles; In process 1906, the driver chooses a vehicle, and processing proceeds to process 1910. In process 1907, server system receives a message from the computer client of the driver with vehicle details. In process 1908, there is testing whether the vehicle type, make and model have been entered; if not, then, in process 1909, an alert is sent to the driver's browser requiring entry of the appropriate data. In process 1910, there is testing whether at least one available space in the vehicle is specified; if not, then, in process 1911, an alert is sent to the driver's browser requiring entry of the appropriate data. In process 1912, there is testing whether the driver has uploaded at least one photograph of the vehicle; if not, then in process 1913, an alert is sent to the driver's browser requiring the driver to upload at least one photograph of the vehicle. If, after all of these tests, all data has been determined to have been entered correctly, then in process 1914, the server system performs a series of actions. Specifically, server system creates a driver proposal in the form of a message with trip ID and driver name; the server system transmits this message to the shipper's message center. In addition, server system transmits another copy of this message as an e-mail message to the shipper's registered e-mail address using an e-mail gateway service with the subject “You have received a proposal” with the server system's automated e-mail address in the From field of this message. After all this processing, the driver proposal is considered to have been submitted to the shipper successfully.

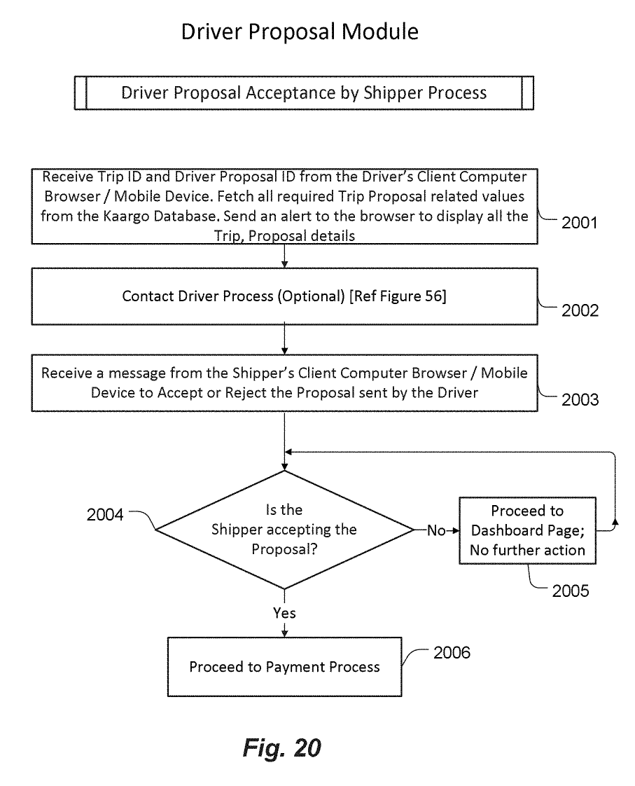

FIGS. 20-23 relate to logical flow for the driver proposal module 117 of FIG. 1A. FIG. 20 is a block diagram of the driver proposal acceptance by shipper process for the Driver Proposal module 117 of FIG. 1A. In this module, in process 2001, the server system receives a message from the shipper's computer client with the trip ID and driver proposal ID details. Subsequently, the server system fetches all required data from the database; the server system sends a message to shipper's computer client providing details of trips and proposals to be displayed. In process 2002, there is optionally provided a facility for the shipper to contact the driver via message center module 113 of FIG. 1A. In process 2003, the server system receives a message from shipper's computer client to accept or reject the proposal sent by the driver. In process 2004, there is testing whether the shipper is accepting the driver proposal; if not, then in process 2005, the shipper is redirected to the dashboard and no further action is required. In process 2006, the processing moves to the payment details process.

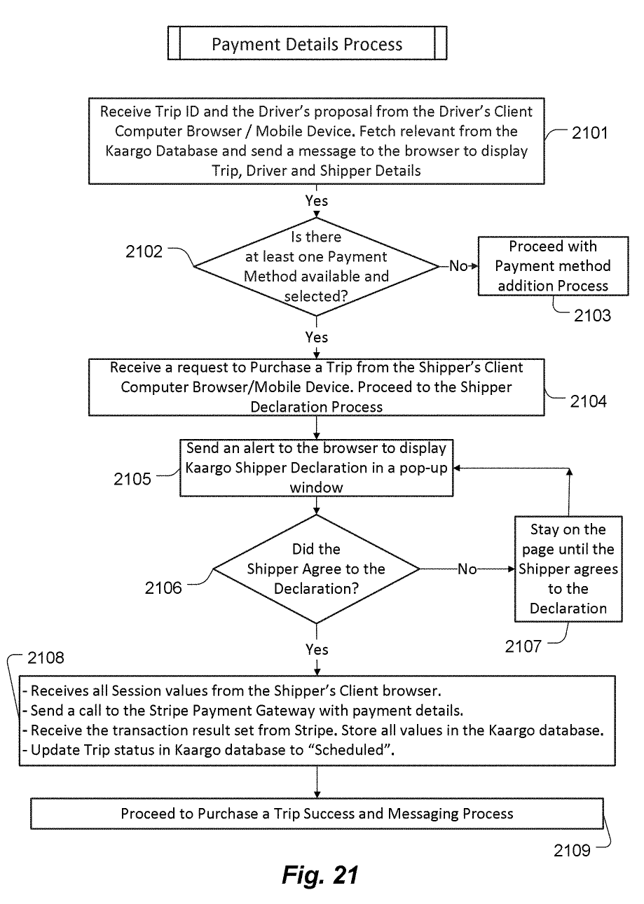

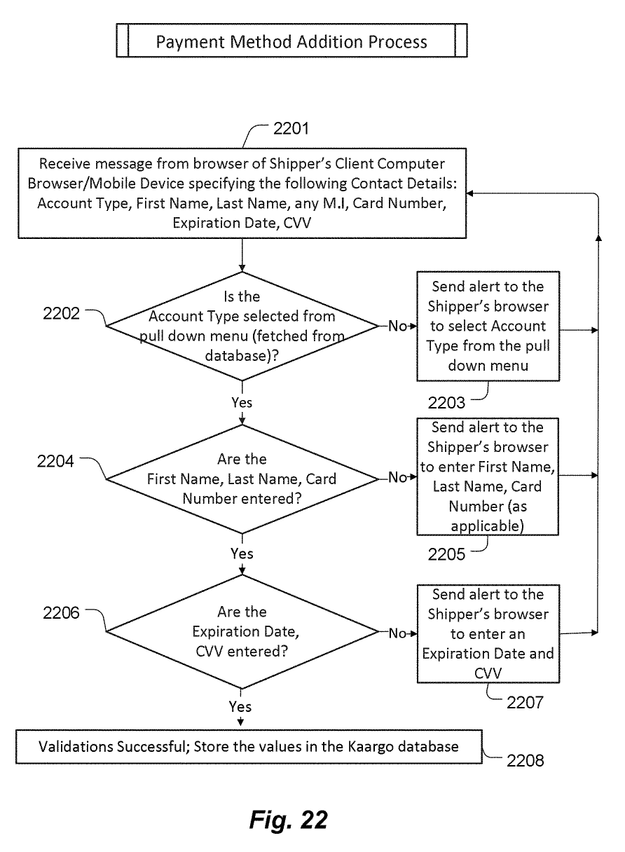

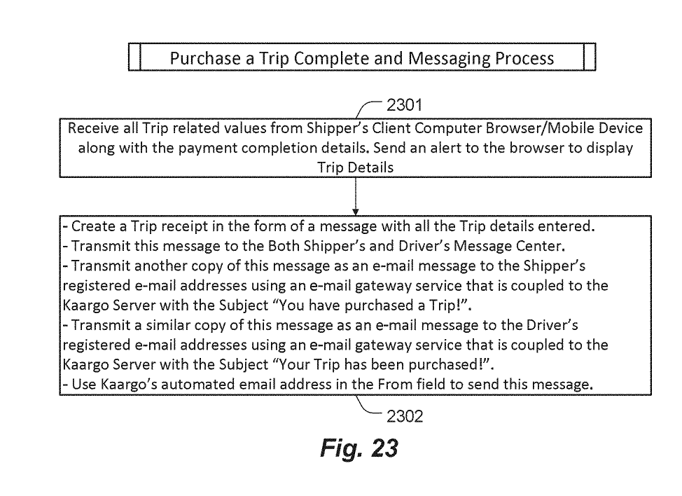

FIG. 21 is a block diagram of the payment details process for the Driver Proposal module 117 of FIG. 1A. In this module, in process 2101, the server system receives a message from shipper's computer client with trip ID and driver proposal details. Subsequently, the server system sends the trip ID to the trips database to fetch required trip, driver and shipper information; these details are displayed for the shipper to review and confirm. In process 2102, there is testing whether there is at least one payment method available in the system and selected; if not, then in process 2103, the shipper is prompted to proceed with payment method addition process of FIG. 22. In process 2104, the server system receives a message from the shipper's computer client to purchase a trip. In process 2105, the shipper declaration is displayed in a pop-up window. In process 2106, there is testing whether the shipper agreed to the declaration, without which, the shipper will not be able to proceed with the trip purchase; if not, then in process 2107, the shipper is prompted to agree to the declaration. If, after all of these tests, all data has been determined to have been entered correctly, then in process 2108, a call is made to the payment gateway using a remote API connection along with the shipper's payment details. Subsequently, the server system receives the transaction results from the payment gateway, and trip and purchase related data are stored in database. The server system updates the trip status to “Scheduled”. In process 2109, the processing moves to trip purchase completion messaging process of FIG. 23.

FIG. 22 is a block diagram of the payment method addition process for the Driver Proposal module 117 of FIG. 1A. In this module, in process 2201, the server system receives a message from the shipper's computer client with the member's account specific details such as member's first name, last name, middle initial, credit or debit card number, expiration date and CVV details. In subsequent processes, a series of validation tests are run. If any of the validations fail, appropriate alerts are sent to the shipper's client so that they can be rectified. Specifically, in process 2202, there is testing whether account type is selected from the pull down menu; if not, then, in process 2203, an alert is sent to the shipper's browser requiring entry of valid data. In process 2204, there is testing whether the first name, last name and credit or debit card number have been entered; if not, then, in process 2205, an alert is sent to the shipper's browser requiring entry of the appropriate data. In process 2206, there is testing whether the expiration date and CVV have been entered; if not, then in process 2207, the shipper is prompted to make a correction. If, after all of these tests, all data has been determined to have been entered correctly, then in process 2208, the entered data is stored and processing moves to trip purchase completion messaging processing of FIG. 23.

FIG. 23 is a block diagram of the Purchase a Trip completion and messaging process for the Driver Proposal module 117 of FIG. 1A. In this module, in process 2301, the server system receives a message from shipper's computer client with all the trip and payment completion details. In process 2302, the server system performs a series of actions. Specifically, server system creates a trip receipt in the form of a message with all the trip details; the server system transmits this message to both the shipper's and driver's message center; the server system transmits another copy of this message as an e-mail message to the shipper's registered e-mail address using an e-mail gateway service with the subject “You have purchased a Trip” with the server system's automated e-mail address in the From field of this message. In addition, the server system transmits another copy of this message as an e-mail message to the driver's registered e-mail address using an e-mail gateway service with the subject “Your Trip has been purchased” with the server system's automated e-mail address in the From field of this message. After all these processing, the trip is considered to have been purchased successfully.

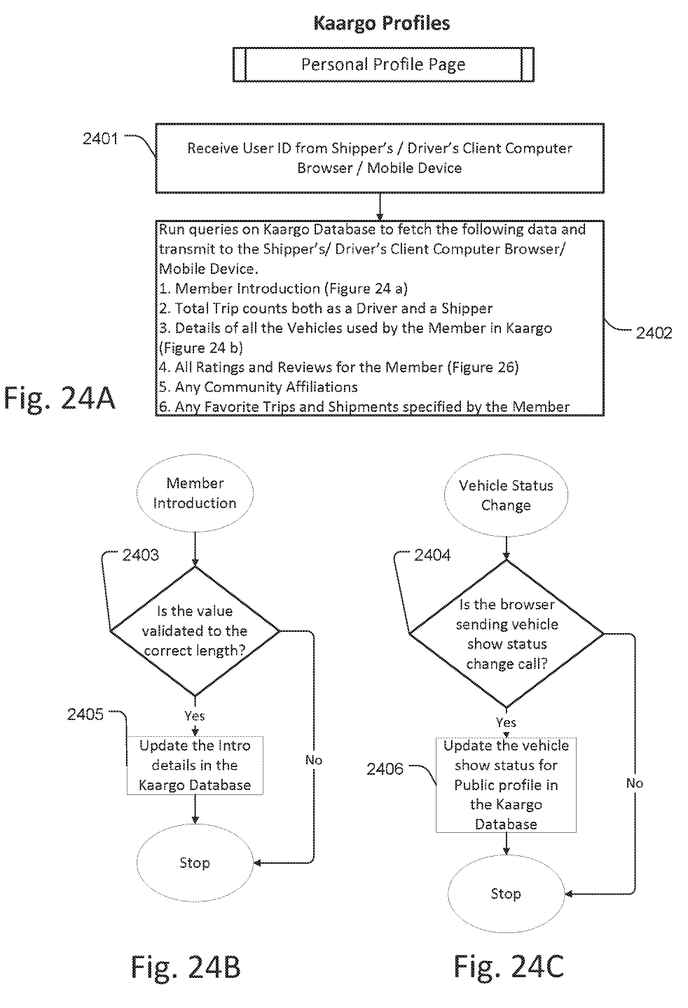

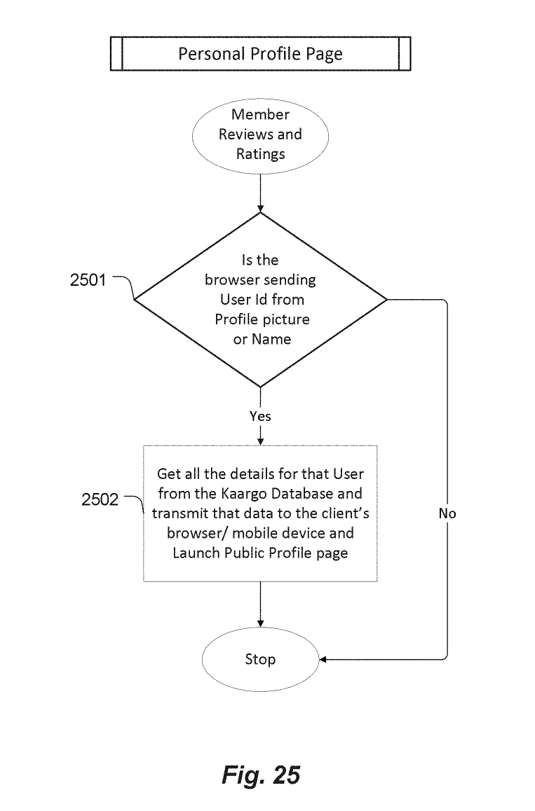

FIGS. 24-25 relate to logical flow for the member personal profiles module 114 of FIG. 1A. FIGS. 24A-24C are block diagrams of the member introduction and vehicle status change processes for the Member Personal Profile module 114 of FIG. 1A. In this module, in process 2401, shown in FIG. 24A, the server system receives a message from the computer client with user ID details. In process 2402, shown in FIG. 24A, the server system performs a series of actions. Specifically, the server system fetches member introduction data, such as member photographs, total trip count as a driver and a shipper, total shipments, details of all vehicles used by the member, any community affiliations, any Favorite Trips and Shipments routes specified by the member and member ratings and review and transmits this message to the member's client computer. FIG. 24B is a block diagram of the member introduction process for the Member Personal Profile module 114 of FIG. 1A. In process 2403 for member introduction, there is testing whether the member introduction value is validated to the correct length; if so, then, in process 2405, the computer client sends a message to the server system to update the member introduction details in database. FIG. 24C is a block diagram of the Vehicle Status Change process for the Member Personal Profile module 114 of FIG. 1A. In process 2404 for vehicle status change, there is testing whether there is vehicle show status change; if so, then, in process 2406, the computer client sends a message to the server system to update the vehicles show status change in the database.

FIG. 25 is a block diagram of the member reviews and ratings process for the Member Personal Profile module 114 of FIG. 1A. In this module, in process 2501, there is testing whether the client computer is sending member's user Id details to the server system; if so, then, in process 2502, the server system fetches all the details for that member from database, and transmits the data to the client computer and transmits a message to the client computer to launch Member Public Profile page.

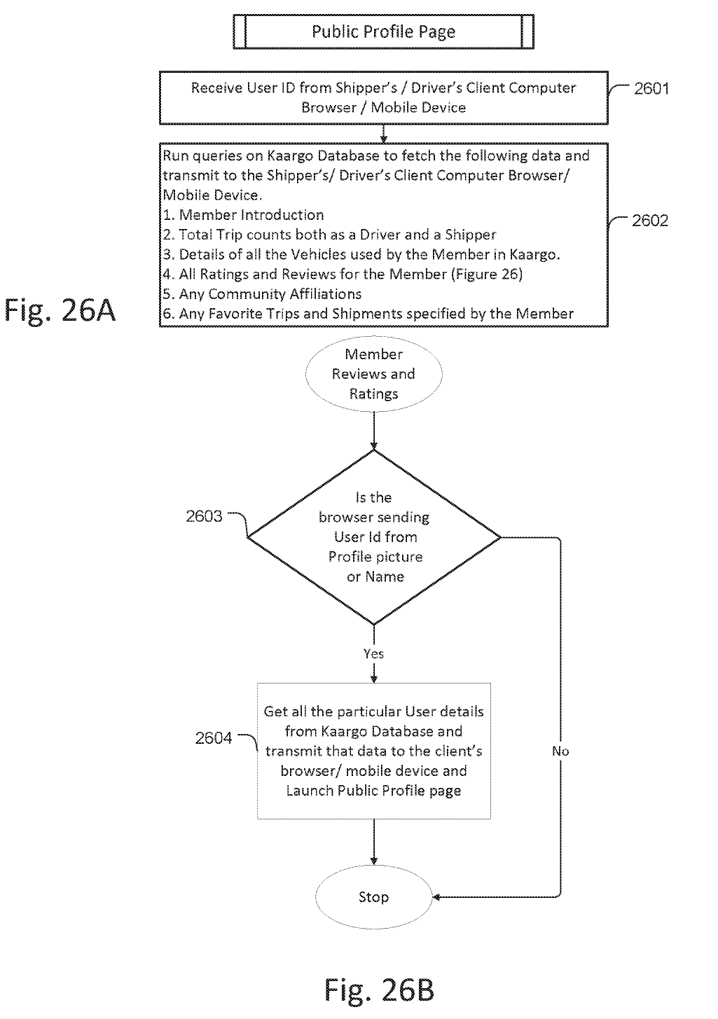

FIGS. 26A-26B are block diagrams of the member reviews and ratings process for the Member Public Profile module 115 of FIG. 1A. In this module, in process 2601, shown in FIG. 26A, the server system receives a message from the computer client with user ID details. In process 2602, the server system performs a series of actions. Specifically, server system fetches member introduction data, such as member photographs, total trip count as a driver and a shipper, total shipments, details of all vehicles used by the member, any community affiliations, any Favorite Trips and Shipment routes specified by the member and ratings and review for the member and transmits this message to the client computer. In process 2603, shown in FIG. 26B, for member reviews and ratings, there is testing whether the client computer is sending the member's user ID details to the server system; if so, then, in process 2604, the server system fetches all the details for that member from database, and transmits the data to the client computer and transmits a message to the client computer to launch the Member Public Profile page.

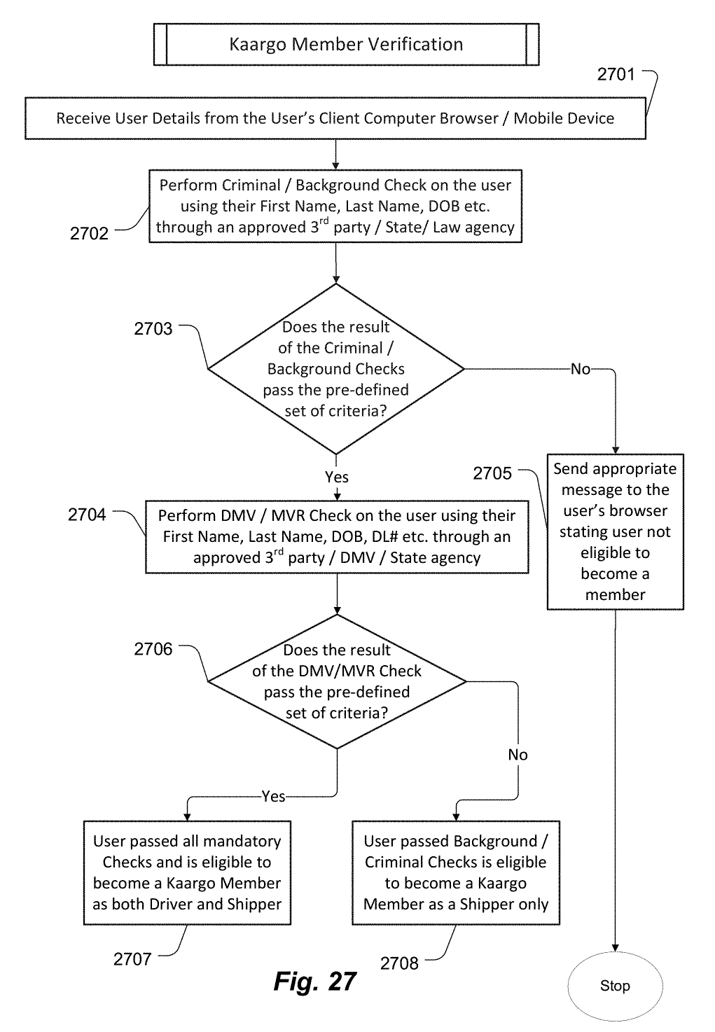

FIG. 27 is a block diagram of the member verification process for the DMV/MVR Checks module 104 and Criminal/Driver Checks module 106 of FIG. 1A. In this module, in process 2701, the server system receives a message from the computer client with user first name, last name, address, date of birth details. In process 2702, the server system performs a criminal/background check on the user using the details provided through an approved third party state or law enforcement agency. In process 2703, there is testing whether the result of the criminal check passed a pre-defined set of criteria. If not, then, in process 2705, the server system transmits a message to the member's browser stating the user is not eligible to become a Kaargo member and further processing stops. In process 2704, the server system performs a DMV/MVR check on the user using the details provided through an approved third party state or law enforcement agency. In process 2706, there is testing whether the result of the DMV/MVR check passed a pre-defined set of criteria. If not, then in process 2708, the server system transmits a message to the member's browser that user has passed only some of the mandatory checks, and hence, the user is eligible to become a Kaargo member as a shipper only and further processing stops. In process 2707, the server system transmits a message to the member's browser that the user has passed all mandatory checks and is eligible to become a Kaargo member, both, as a shipper and a driver.

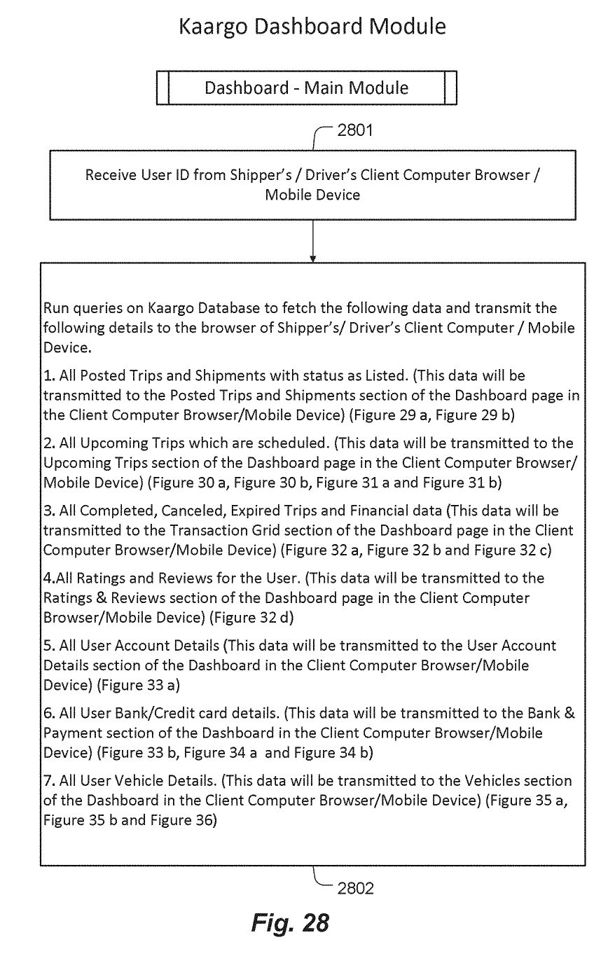

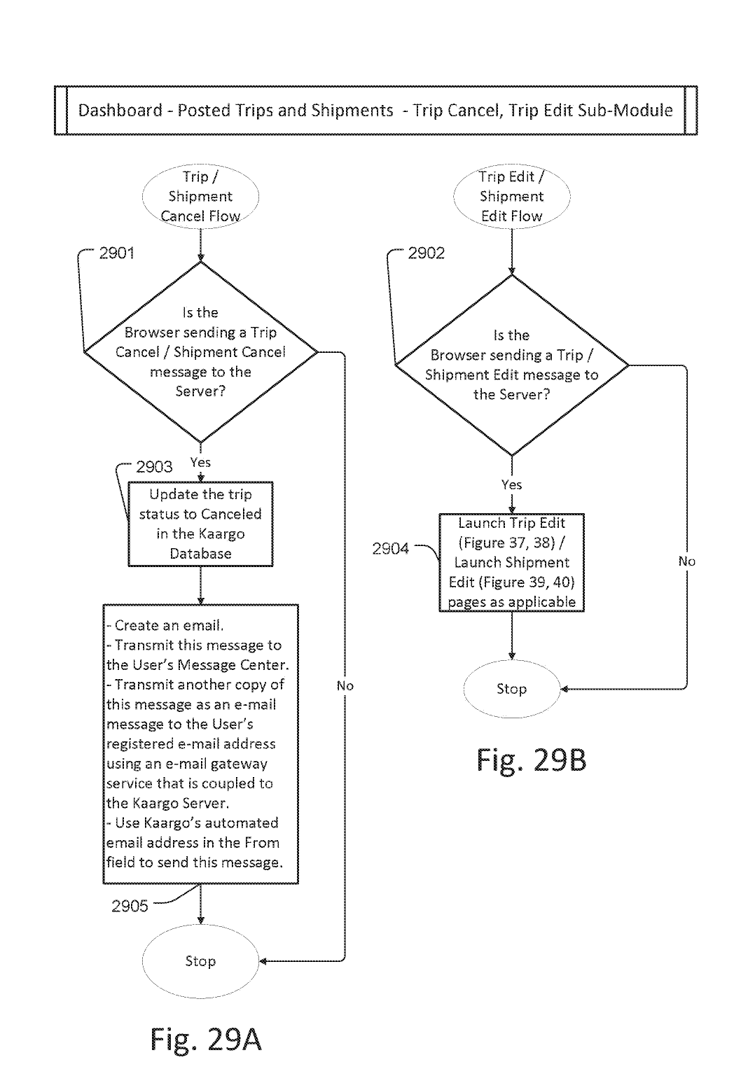

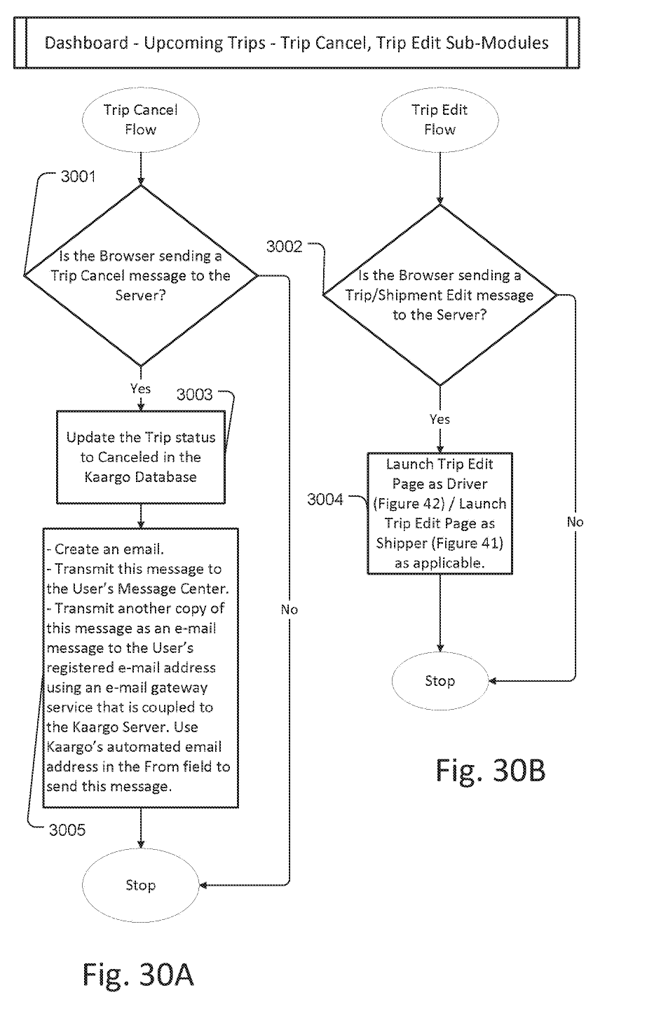

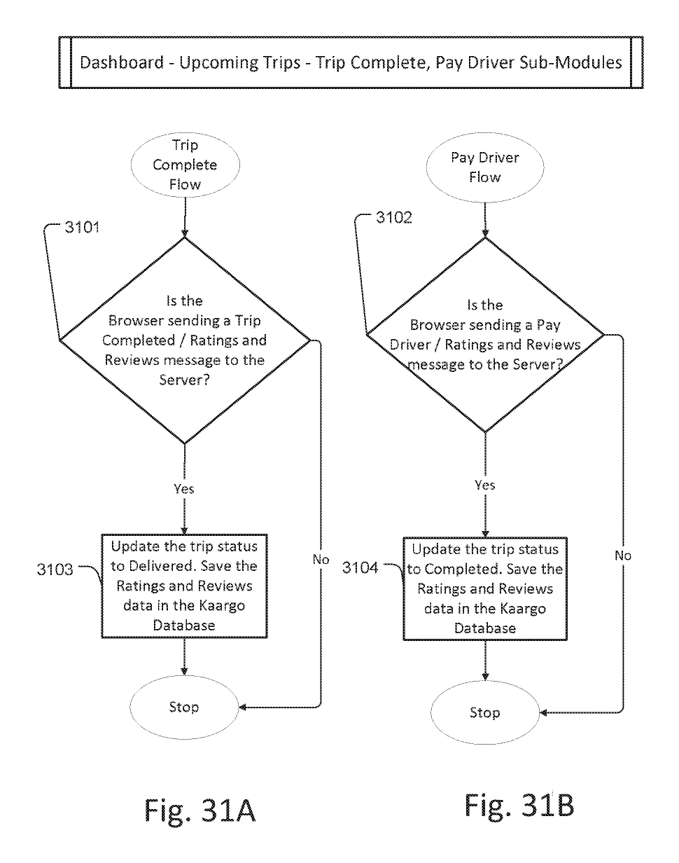

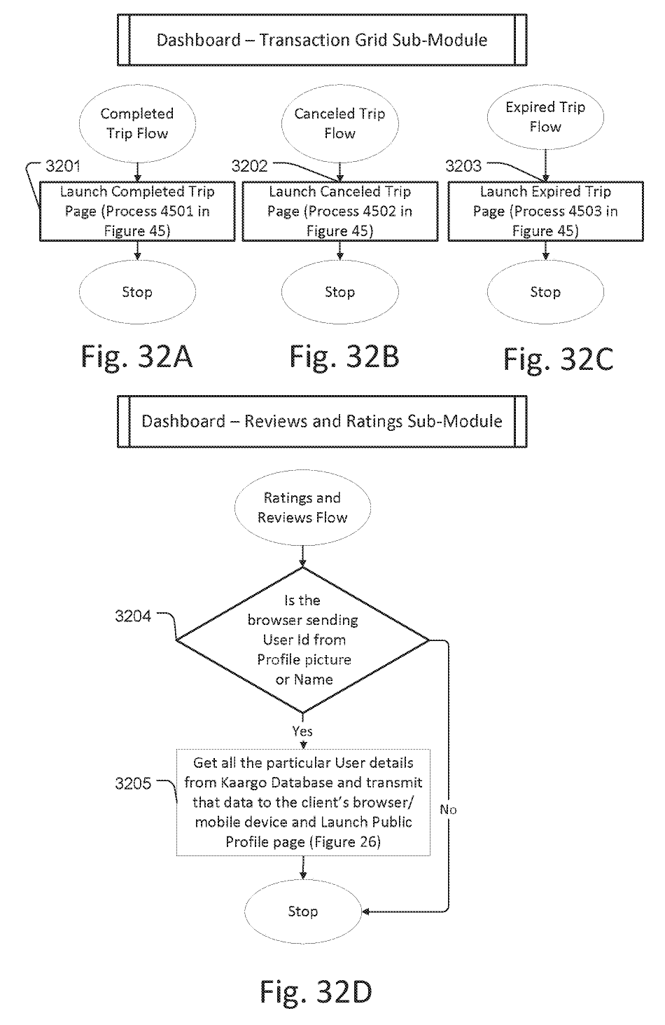

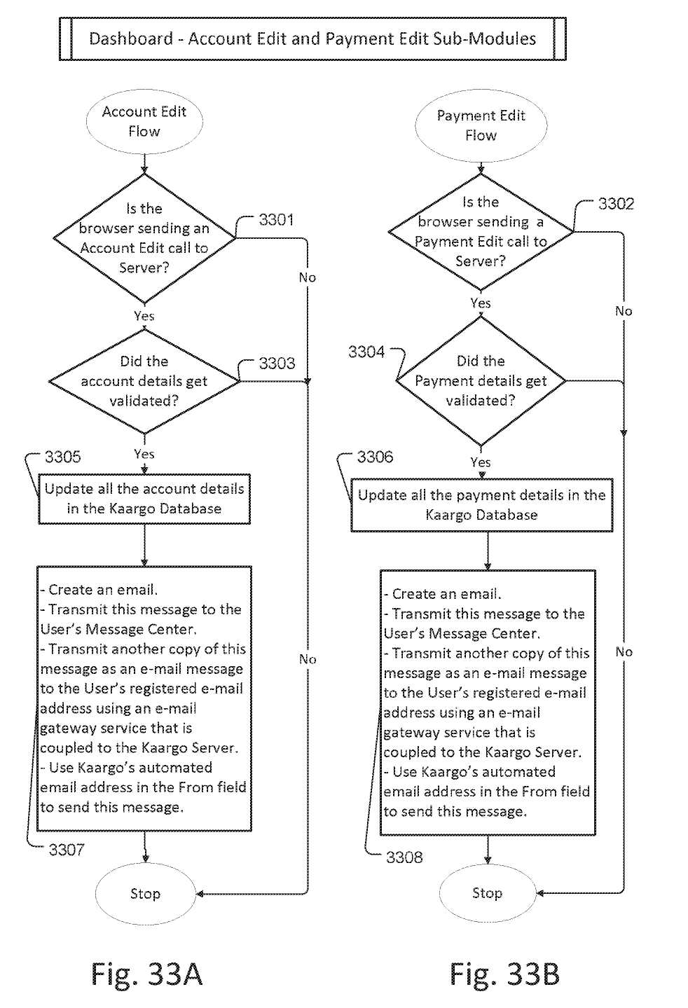

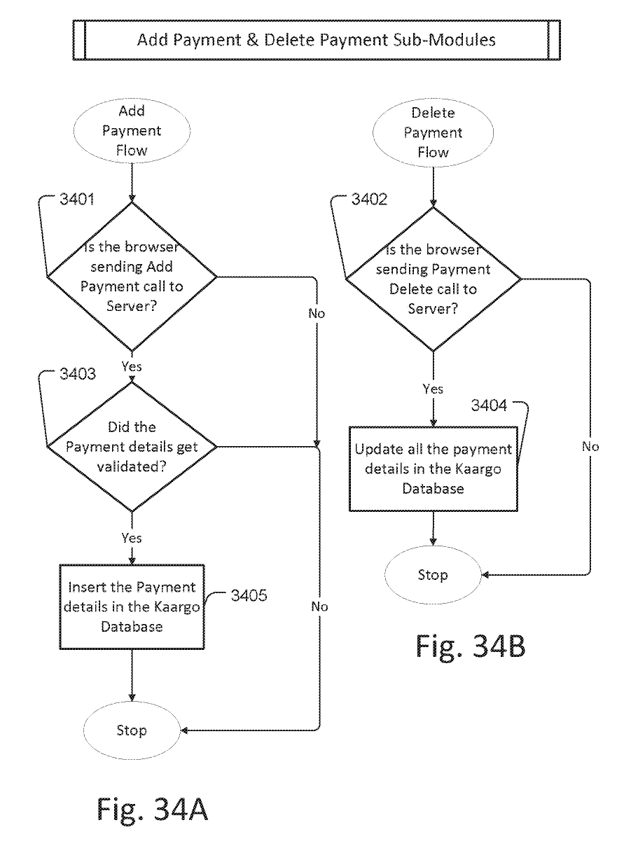

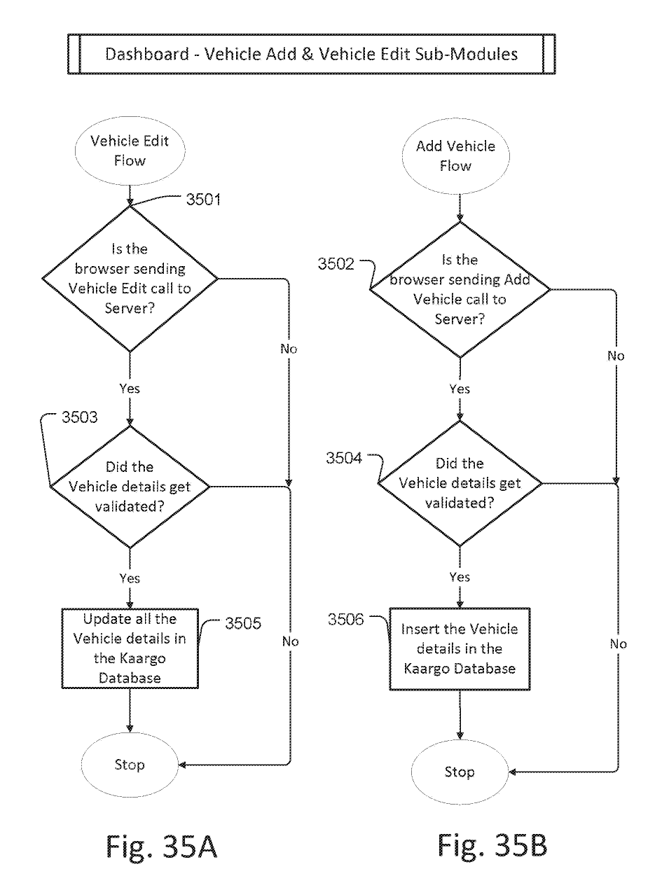

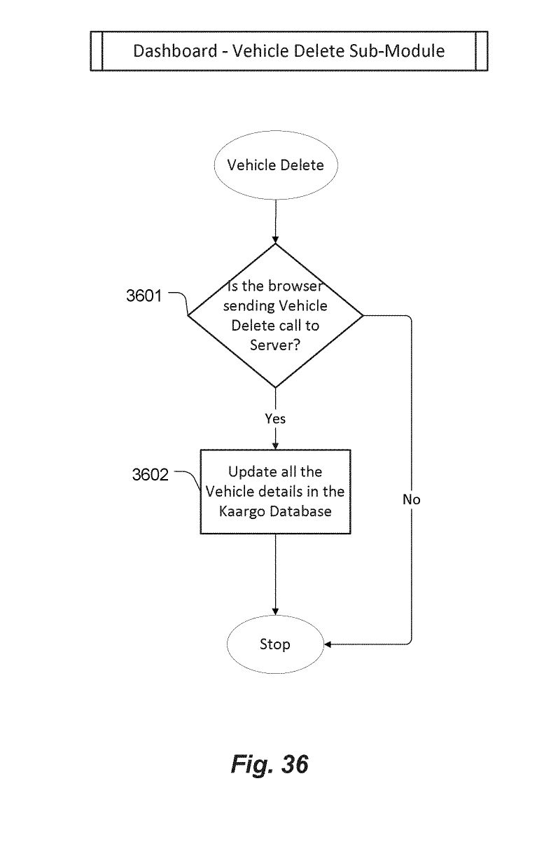

FIGS. 28-36 relate to logical flow for the Member Dashboard module 120 of FIG. 1A. FIG. 28 is a block diagram of logical flow for the various sub-modules of the Member Dashboard module 120 of FIG. 1A. In this module, in process 2801, the server system receives a message from the computer client with user ID details. In process 2802, the server system performs a series of actions. Specifically, the server system performs queries on the database to retrieve all posted trips and shipments that belong to the member with status as Listed and transmits them to the computer client for displaying in the Posted Trips and Shipments section of the dashboard processing of FIG. 29A and FIG. 29B. The server system performs queries on database to retrieve all upcoming trips and shipments that belong to the member with status as Scheduled and transmits them to computer client for displaying in the Upcoming Trips and Shipments section of the dashboard processing of FIG. 30A, FIG. 30B, FIG. 31A and FIG. 31B. The server system performs queries on the database to retrieve all completed, canceled and expired trips and shipments that belong to the member and transmits them to the computer client for displaying in the Transaction Grid section of the dashboard processing of FIG. 32A, FIG. 32B and FIG. 32C. The server system performs queries on the database to retrieve all ratings and reviews for the member and transmits them to the computer client for displaying in the Ratings and Reviews section of the dashboard processing of FIG. 32D. The server system performs queries on the database to retrieve all account details for the member and transmits them to the computer client for displaying in the User Accounts Details section of the dashboard processing of FIG. 33A. The server system performs queries on the database to retrieve member's bank, credit card and debit card details and transmits them to computer client for displaying in the Bank and Payment section of the dashboard processing of FIG. 33B, FIG. 34A and FIG. 34B. The server system performs queries on database to retrieve all vehicle details for the member and transmits them to computer client for displaying in the Vehicles section of the dashboard processing of FIG. 35A, FIG. 35B and FIG. 36.

FIG. 29A and FIG. 29B are block diagrams of logical flow for the trip cancel and trip edit processes of the posted trips and posted shipments sub-modules of the Member Dashboard module 120 of FIG. 1A. FIG. 29A is a block diagram of logical flow for the trip cancel process of the posted trips and posted shipments sub-modules of the Member Dashboard module 120 of FIG. 1A. In process 2901, as part of trip cancel flow, there is testing whether the computer client is sending a trip cancel message to the server system. If not, then the process terminates. If so, then in process 2903, the server system updates the trip status to “Canceled” in the database. In process 2905, server system creates a trip cancelation receipt in the form of a message with the trip details; server system transmits this message to the member's message center; server system transmits another copy of this message as an e-mail message to the member's registered e-mail address using an e-mail Gateway service with the subject “You have canceled your Trip” with the server system's automated e-mail address in the From field of this message.

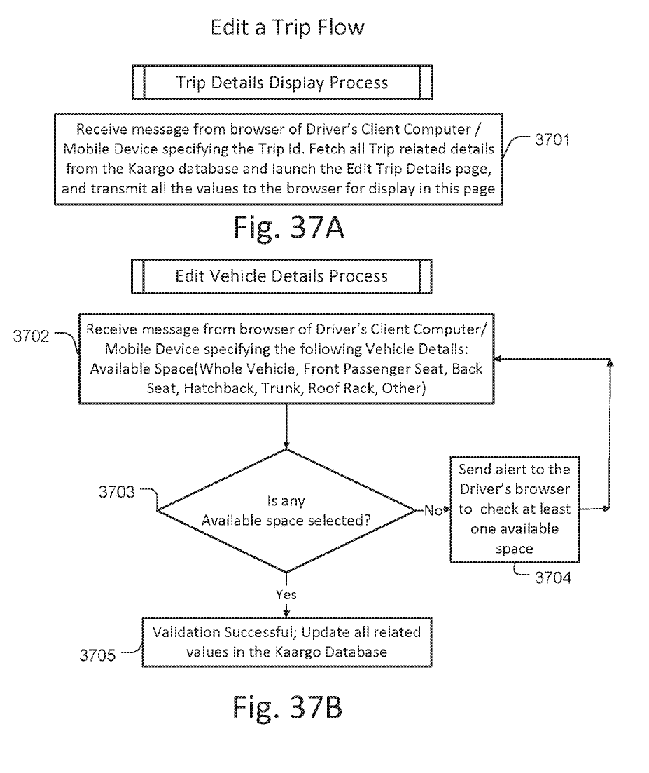

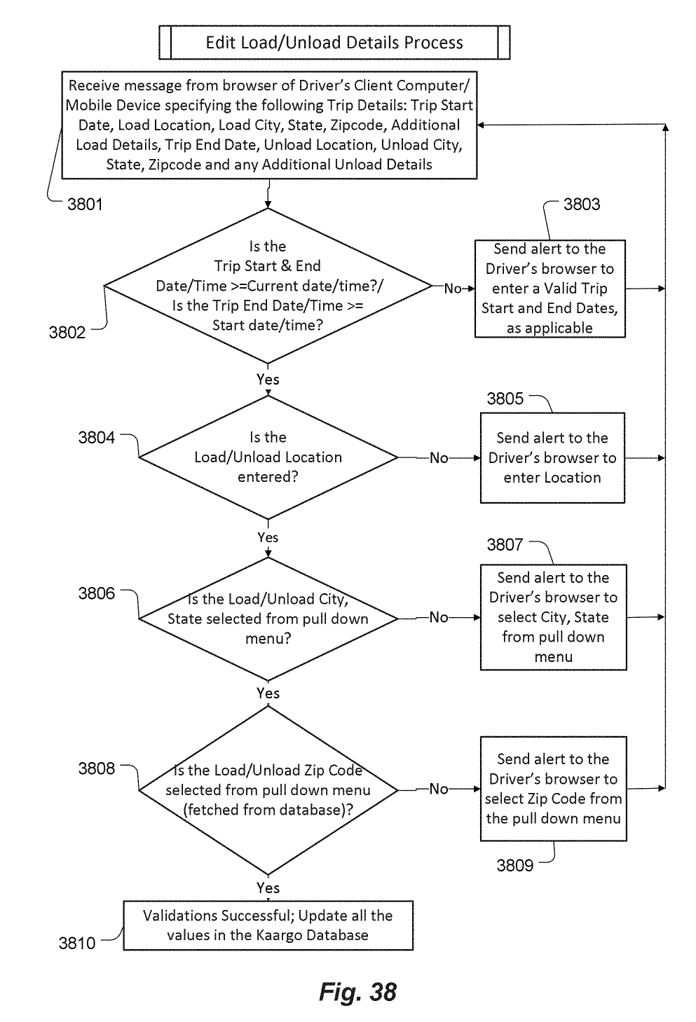

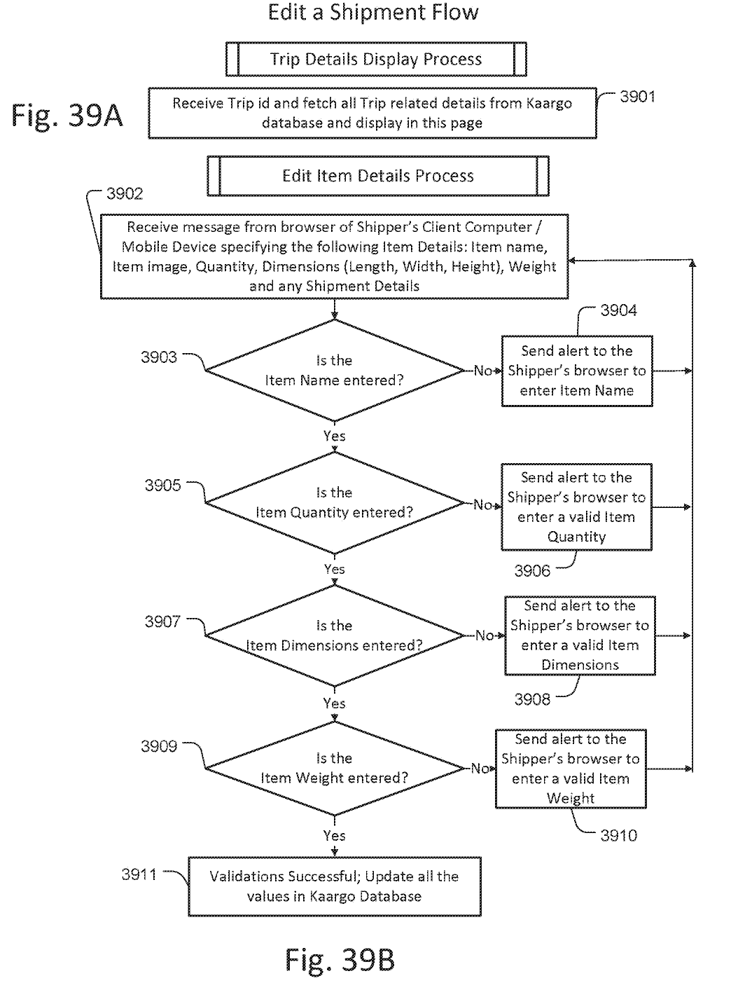

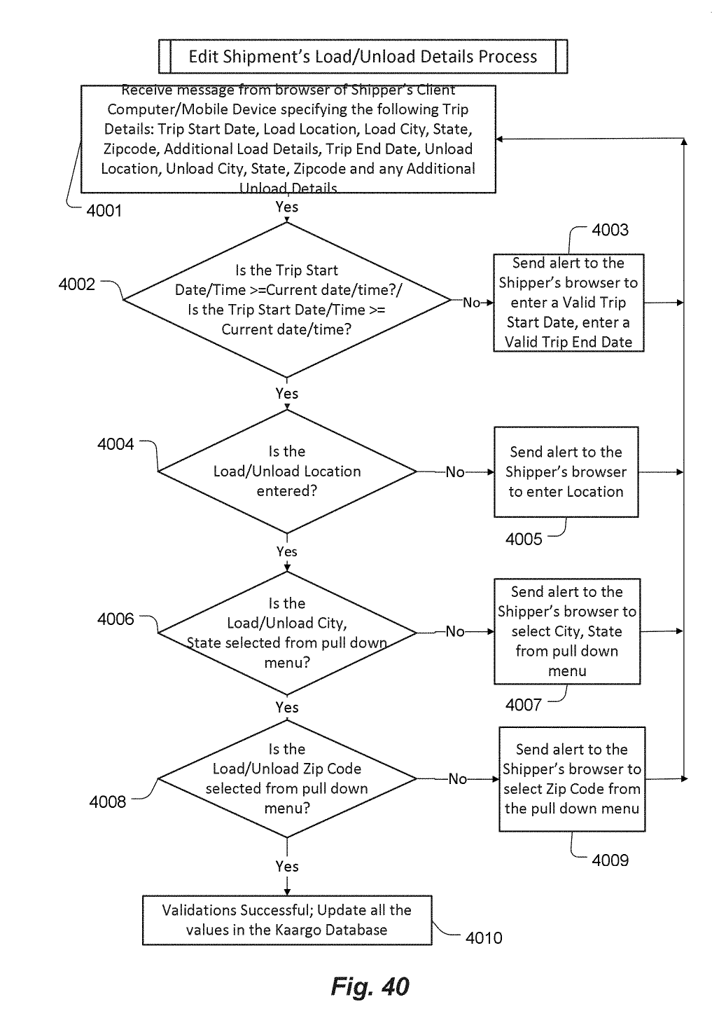

FIG. 29B is a block diagram of logical flow for the trip edit process of the posted trips and posted shipments sub-modules of the Member Dashboard module 120 of FIG. 1A. In process 2902, as part of trip or shipment edit flow, there is testing whether the computer client is sending a trip cancel message or a shipment cancel message to the server system. If not, then the process terminates. If so, then in process 2904, the server system transmits a message to the computer client to launch Trip Edit page for processing of trip edits of FIGS. 37A-37B and FIG. 38, or launch Shipment Edit page for processing of shipment edits of FIGS. 39A-39B and FIG. 40 as applicable.

FIG. 30A and FIG. 30B are block diagrams of logical flow for the trip cancel and trip edit sub-modules of the Upcoming trips section in the Member Dashboard module 120 of FIG. 1A. FIG. 30A is a block diagram of logical flow for the trip cancel process of the upcoming trips and upcoming shipments sub-modules of the Member Dashboard module 120 of FIG. 1A. In process 3001, as part of upcoming trip cancel flow, there is testing whether the computer client is sending a trip cancel message to the server system. If not, then the process terminates. If so, then in process 3003, the server system updates trip status to “Canceled” in database. In process 3005, server system creates a trip cancelation receipt in the form of a message with the trip details; server system transmits this message to the message center of both driver and shipper; server system transmits another copy of this message as an e-mail message to the member's registered e-mail address using an e-mail gateway service with the subject “You have canceled your Trip” with the server system's automated e-mail address in the From field of this message. Server system also transmits a copy of this message as an e-mail message to the other party's registered e-mail address using an e-mail Gateway service with the subject “Your Trip has been canceled” with the server system's automated e-mail address in the From field of this message. In the above e-mail messages, the term “Shipment” is used in the place of “Trip” if the shipment gets canceled.

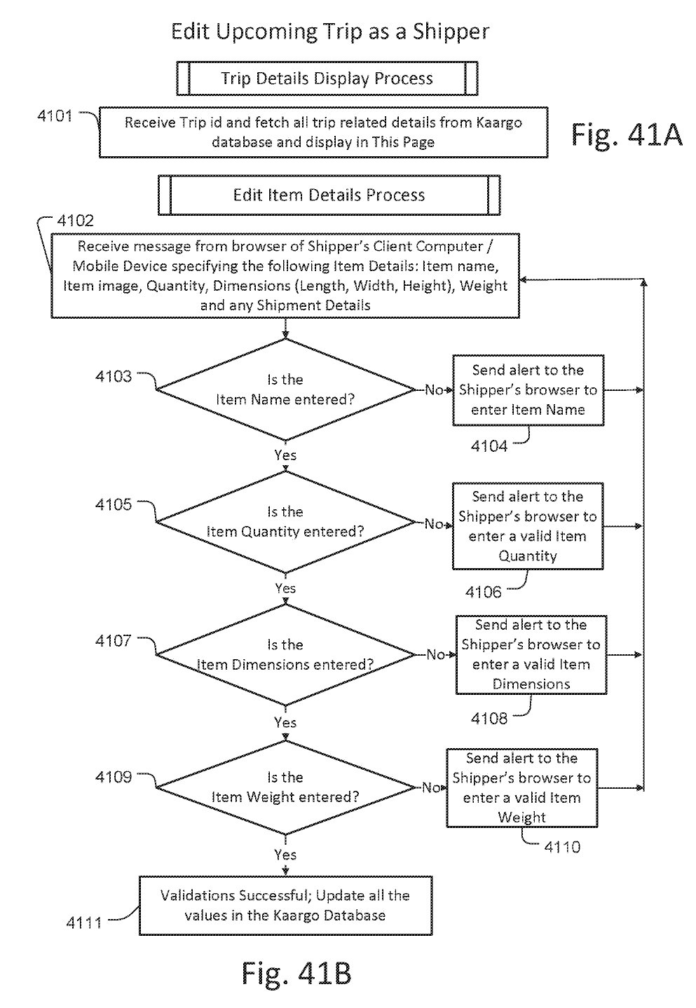

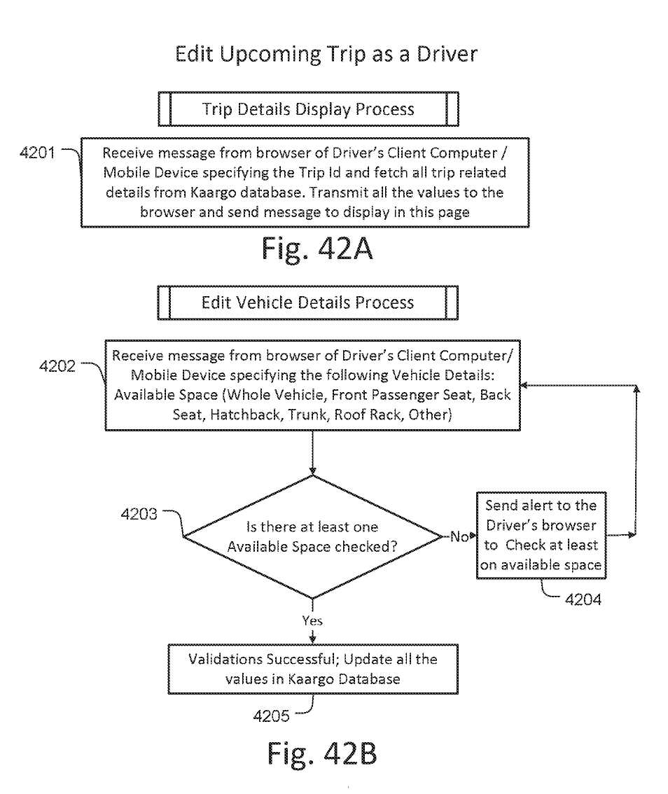

FIG. 30B is a block diagram of logical flow for the trip edit process of upcoming trips and shipments sub-modules of the Member Dashboard module 120 of FIG. 1A. In process 3002, as part of trip or shipment edit flow, there is testing whether the computer client is sending a trip cancel message or a shipment cancel message to the server system. If not, then the process terminates. If so, then in process 3004, the server system transmits a message to the computer client to launch Trip Edit page as a driver for processing of trip edits of FIGS. 42A-42B or launch Trip Edit page as a shipper for processing of trip edits of FIGS. 41A-41B as the case may be.

FIG. 31A and FIG. 31B are block diagrams of logical flow for the trip complete and pay driver sub-modules of the Upcoming trips section in the Member Dashboard module 120 of FIG. 1A. FIG. 31A is a block diagram of logical flow for the trip complete process of the upcoming trips sub-module of the Member Dashboard module 120 of FIG. 1A. In process 3101, as part of upcoming trip complete flow, there is testing whether the computer client is sending a trip complete, ratings & review message to the server system. If not, then the process terminates. If so, then in process 3103, the server system updates trip status to “Completed” in database, and entered data is stored.

FIG. 31B is a block diagram of logical flow for the pay driver process of the upcoming trips sub-module of the Member Dashboard module 120 of FIG. 1A. In process 3102, as part of upcoming trips pay driver flow, there is testing whether the computer client is sending a pay driver, ratings & review message to the server system. If not, then the process terminates. If so, then in process 3104, the server system updates trip status to “Completed” in database, and entered data is stored.

FIGS. 32A through FIG. 32D are block diagrams of logical flow for various functions within the Transaction Grid and Reviews and Ratings sub-modules of the Member Dashboard module 120 of FIG. 1A. FIG. 32A is a block diagram of logical flow for the completed trip flow process of the Transaction Grid sub-module of the Member Dashboard module 120 of FIG. 1A. In process 3201, the server system transmits a message to the computer client to launch a completed trip page. FIG. 32B is a block diagram of logical flow for the canceled trip flow process of the Transaction Grid sub-module of the Member Dashboard module 120 of FIG. 1A. In process 3202, the server system transmits a message to the computer client to launch a canceled trip page. FIG. 32C is a block diagram of logical flow for the expired trip flow process of the Transaction Grid sub-module of the Member Dashboard module 120 of FIG. 1A. In process 3203, the server system transmits a message to the computer client to launch an expired trip page. FIG. 32D is a block diagram of logical flow for the ratings and review flow process of the Reviews and Ratings sub-module of the Member Dashboard module 120 of FIG. 1A. In process 3204, there is testing whether the computer client is sending user ID to the server system; if not, the process terminates. In process 3205, the server system fetches user details from the database, and transmits them to the computer client, and sends a message to the computer client to launch the public profile page of FIGS. 26A-26B.

FIG. 33A and FIG. 33B are block diagrams of logical flow for the Account edit and Payment edit sub-modules of the Member Dashboard module 120 of FIG. 1A. FIG. 33A is a block diagram of logical flow for the account edit process of the Dashboard Account Edit and Payment Edit sub-module of the Member Dashboard module 120 of FIG. 1A. In process 3301, there is testing whether the computer client is sending an account edit call to the server system. If so, in process 3303, there is testing whether the account details get validated. If so, in process 3305, the server system updates all the account details in the database. In process 3307, the server system performs a series of actions. Specifically, the server system creates an account edit receipt in the form of a message with account details; the server system transmits this message to the member's message center; In addition, the server system transmits another copy of this message as an e-mail message to the member's registered e-mail address using an e-mail Gateway service with the subject “Your account details have been edited” with the server system's automated e-mail address in the From field of this message. After all these processing, the account edit process is considered to have been completed successfully.

FIG. 33B is a block diagram of logical flow for the payment edit process of the Dashboard Account Edit and Payment Edit sub-module of the Member Dashboard module 120 of FIG. 1A. In process 3302, there is testing whether the computer client is sending a payment edit call to the server system. If so, in process 3304, there is testing whether the payment details have been validated. If so, in process 3306, the server system updates all the payment details in the database. In process 3308, the server system performs a series of actions. Specifically, the server system creates a payment edit receipt in the form of a message with relevant payment details; the server system transmits this message to the member's message center. In addition, the server system transmits another copy of this message as an e-mail message to the member's registered e-mail address using an e-mail Gateway service with the subject “Your payment details have been edited” with the server system's automated e-mail address in the From field of this message. After all this processing, the payment edit process is considered to have been completed successfully.

FIGS. 34A and FIG. 34B are block diagrams of logical flow for the Add payment and Delete payment sub-modules of the Member Dashboard module 120 of FIG. 1A. FIG. 34A is a block diagram of logical flow for the add payment process of the Dashboard Add Payment and Delete Payment Edit sub-modules of the Member Dashboard module 120 of FIG. 1A. In process 3401, there is testing whether computer client is sending an add payment call to the server system. If so, in process 3403, there is testing whether the payment details have been validated. If so, in process 3405, server system updates payment details in the database. After this processing, the add payment process is considered to have been completed successfully.

FIG. 34B is a block diagram of logical flow for the delete payment process of the Dashboard Add Payment and Delete Payment Edit sub-modules of the Member Dashboard module 120 of FIG. 1A. In process 3402, there is testing whether computer client is sending a delete payment call to the server system. If so, in process 3404, server system updates payment details in database. After this processing, the delete payment process is considered to have been completed successfully.

FIG. 35A and FIG. 35B are block diagrams of logical flow for the vehicle add and vehicle edit sub-modules of the Member Dashboard module 120 of FIG. 1A. FIG. 35A is a block diagram of logical flow for the vehicle edit process of the Dashboard Vehicle Add and Vehicle Edit sub-modules of the Member Dashboard module 120 of FIG. 1A. In process 3501, there is testing whether the computer client is sending a vehicle edit call to the server system. If so, in process 3503, there is testing whether the vehicle details have been validated. If so, in process 3505, the server system updates all the vehicle details in the database. After this processing, the vehicle edit process is considered to have been completed successfully. FIG. 3 5B is a block diagram of logical flow for the vehicles add process of the Dashboard Vehicle Add and Vehicle Edit sub-modules of the Member Dashboard module 120 of FIG. 1A. In process 3502, there is testing whether computer client is sending vehicle add call to the server system. If so, in process 3504, there is testing whether the vehicle details have been validated. If so, in process 3506, server system updates all the vehicle details in database. After this processing, the vehicles add process is considered to have been completed successfully.

FIG. 36 is a block diagram of logical flow for the Vehicle delete sub-module of the Member Dashboard module 120 of FIG. 1A. In process 3601, there is testing whether the computer client is sending a vehicle delete call to the server system. If so, in process 3602, the server system updates all the details for the vehicle in the database. After this processing, the vehicle delete process is considered to have been completed successfully.

FIGS. 37-45 relate to logical flow of the various edits sub-modules of the dashboard module 120 of FIG. 1A. FIGS. 37A-37B are block diagrams of logical flow for the edit vehicle details process of the Member Dashboard module 120 of FIG. 1A. In this module, in process 3701, shown in FIG. 37A, the server system receives a message from computer client with trip ID details. Subsequently, the server system fetches all required trip data from database; the server system sends a message to the computer client to launch the Edit Trip Details page and transmits all the data to the computer client. In process 3702, shown in FIG. 37B, the server system receives a message from the computer client with the vehicle available space details. In process 3703, there is testing whether at least one available space is selected; if not, then, in process 3704, the user is prompted to make a correction. If, after this test, if validation is successful, in process 3705, the server system updates all the details for the vehicle in database.

FIG. 38 is a block diagram of logical flow for the edit load/unload details process of the Member Dashboard module 120 of FIG. 1A. In this module, in process 3801, the server system receives a message from the computer client with load and unload specific details such as trip start date/time, load location address, load city, load state, load zip code, additional load details, trip end date/time, unload location address, unload city, unload state, unload zip code and additional unload details. In subsequent processes, a series of validation tests are run. If any of the validations fail, appropriate alerts are sent to the driver's client computer so that they can be rectified. Specifically, in process 3802, it is determined whether the trip start date and time and trip end date and time is later than the current date and time; if not, then, in process 3803, an alert is sent to the driver's browser requiring entry of valid data. In process 3804, there is testing whether the load and unload location have been entered; if not, then, in process 3805, an alert is sent to the driver's browser requiring entry of the appropriate data. In process 3806, there is testing whether the load and unload city and state have been entered from a pull-down menu; if not, then in process 3807, an alert is sent to the driver's browser requiring use of the pull-down menu to enter the unload city and state. In process 3808, there is testing whether the zip code of the load and unload locations have been entered from a pull-down menu; if not, then, in process 3809, an alert is sent to the driver's browser requiring use of the pull-down menu to enter the zip code of the load and unload city and state. If, after all of these tests, all data has been determined to have been entered correctly, then in process 3810, the entered data is stored in database.

FIGS. 39A-39B are block diagrams of logical flow for the edit a shipment sub-module of the Member Dashboard module 120 of FIG. 1A. In this module, in process 3901, shown in FIG. 39A, the server system receives a message from the shipper's computer client with trip ID details. Subsequently, the server system fetches trip details, and transmits them to the shipper's computer client. In process 3902, shown in FIG. 39B, the server system receives a message from the shipper's computer client with item name, item image, dimensions (which is made up of length, width and height), item weight and any shipment details. In subsequent processes, a series of validation tests are run. If any of the validations fail appropriate alerts are sent to the client so that they can be rectified. Specifically, in process 3903, it is determined whether the item name is entered; if not, then, in process 3904, an alert is sent to the shipper's browser requiring entry of valid data. In process 3905, there is testing whether the item quantity has been entered; if not, then, in process 3906, an alert is sent to the shipper's browser requiring entry of the appropriate data. In process 3907, there is testing whether the item dimensions are entered; if not, then in process 3908, an alert is sent to the shipper's browser requiring entry of the appropriate data. In process 3909, there is testing whether the item weight has been entered; if not, then, in process 3910, the shipper is prompted to make a correction. If, after all of these tests, all data has been determined to have been entered correctly, then in process 3911, the entered data is stored in the database.

FIG. 40 is a block diagram of logical flow for the edit shipment's load/unload details process sub-module of the Member Dashboard module 120 of FIG. 1A. In this module, in process 4001, the server system receives a message from the shipper's computer client with load and unload specific details such as trip start date/time, load location address, load city, load state, load zip code, additional load details, trip end date/time, unload location address, unload city, unload state, unload zip code and additional unload details. In subsequent processes, a series of validation tests are run. If any of the validations fail appropriate alerts are sent to the shipper's client so that they can be rectified. Specifically, in process 4002, it is determined whether the trip start date and time and trip end date and time are later than the current date and time; if not, then, in process 4003, an alert is sent to the shipper's browser requiring entry of valid data. In process 4004, there is testing whether the load and unload location have been entered; if not, then, in process 4005, an alert is sent to the shipper's browser requiring entry of the appropriate data. In process 4006, there is testing whether the load and unload city and state have been entered from a pull-down menu; if not, then in process 4007, an alert is sent to the shipper's browser requiring use of the pull-down menu to enter the unload city and state. In process 4008, there is testing whether the zip code of the load and unload locations have been entered from a pull-down menu; if not, then, in process 4009, an alert is sent to the shipper's browser requiring use of the pull-down menu to enter the zip code of the load and unload city and state. If, after all of these tests, all data has been determined to have been entered correctly, then in process 4010, the entered data is stored in the database.

FIGS. 41A-41B are block diagrams of logical flow for the edit upcoming trip as a shipper sub-module of the Member Dashboard module 120 of FIG. 1A. In this module, in process 4101, shown in FIG. 41A, the server system receives a message from the shipper's computer client with trip ID details. Subsequently, the server system fetches trip details, and transmits them to the computer client. In process 4102, shown in FIG. 41B, the server system receives a message from the shipper's computer client with item name, item image, dimensions (which is made up of length, width and height), item weight and any shipment details. In subsequent processes, a series of validation tests are run. If any of the validations fail, appropriate alerts are sent to the shipper's computer client so that they can be rectified. Specifically, in process 4103, it is determined whether the item name is entered; if not, then, in process 4104, an alert is sent to the shipper's browser requiring entry of valid data. In process 4105, there is testing whether the item quantity has been entered; if not, then, in process 4106, an alert is sent to the shipper's browser requiring entry of the appropriate data. In process 4107, there is testing whether the item dimensions are entered; if not, then in process 4108, an alert is sent to the shipper's browser requiring entry of the appropriate data. In process 4109, there is testing whether the item weight has been entered; if not, then, in process 4110, the shipper is prompted to make a correction. If, after all of these tests, all data has been determined to have been entered correctly, then in process 4111, the entered data is stored in the database.

FIGS. 42A-42B are block diagrams of logical flow for the edit upcoming trip as a driver sub-module of the Member Dashboard module 120 of FIG. 1A. In this module, in process 4201, shown in FIG. 42A, the server system receives a message from the driver's computer client with trip ID details. Subsequently, the server system fetches all required trip data from the database; the server system sends a message to the driver's computer client to launch Edit Trip Details page and transmits all the data to the computer client. In process 4202, shown in FIG. 42B, the server system receives a message from the driver's computer client with vehicle available space details. In process 4203, there is testing whether at least one available space is selected; if not, then, in process 4204, the driver is prompted to make a correction. If, after this test, if validation is successful, in process 4205, the server system updates all the details for the vehicle in the database.

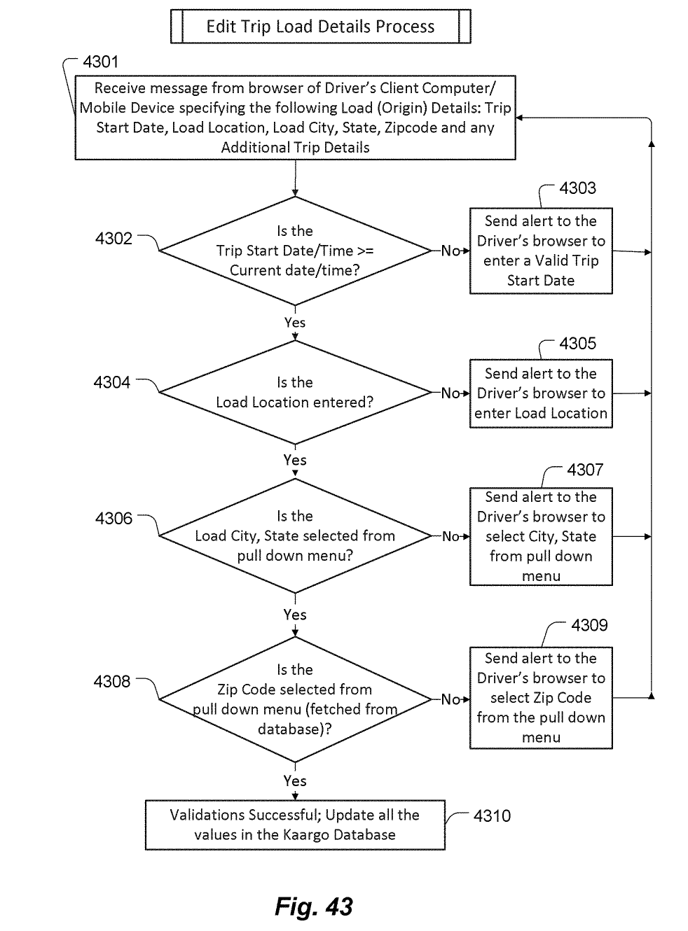

FIG. 43 is a block diagram of logical flow for the edit trip load details sub-module of the Member Dashboard module 120 of FIG. 1A. In this module, in process 4301, the server system receives a message from the computer client of the driver with load specific details such as trip start date/time, load location address, load city, load state, load zip code and any additional load details. In subsequent processes, a series of validation tests are run. If any of the validations fail appropriate alerts are sent to the driver's client so that they can be rectified. Specifically, in process 4302, it is determined whether the trip start date and time are later than the current date and time; if not, then, in process 4303, an alert is sent to the driver's browser requiring entry of valid data. In process 4304, there is testing whether load location has been entered; if not, then, in process 4305, an alert is sent to the driver's browser requiring entry of the appropriate data. In process 4306, there is testing whether the load city and state has been entered from a pull-down menu; if not, then in process 4307, an alert is sent to the driver's browser requiring use of the pull-down menu to enter the load city and state. In process 4308, there is testing whether the zip code of the load location has been entered from a pull-down menu; if not, then, in process 4309, an alert is sent to the driver's browser requiring use of the pull-down menu to enter the zip code of the load city and state. If, after all of these tests, all data has been determined to have been entered correctly, then in process 4310, the entered data is stored in the database.

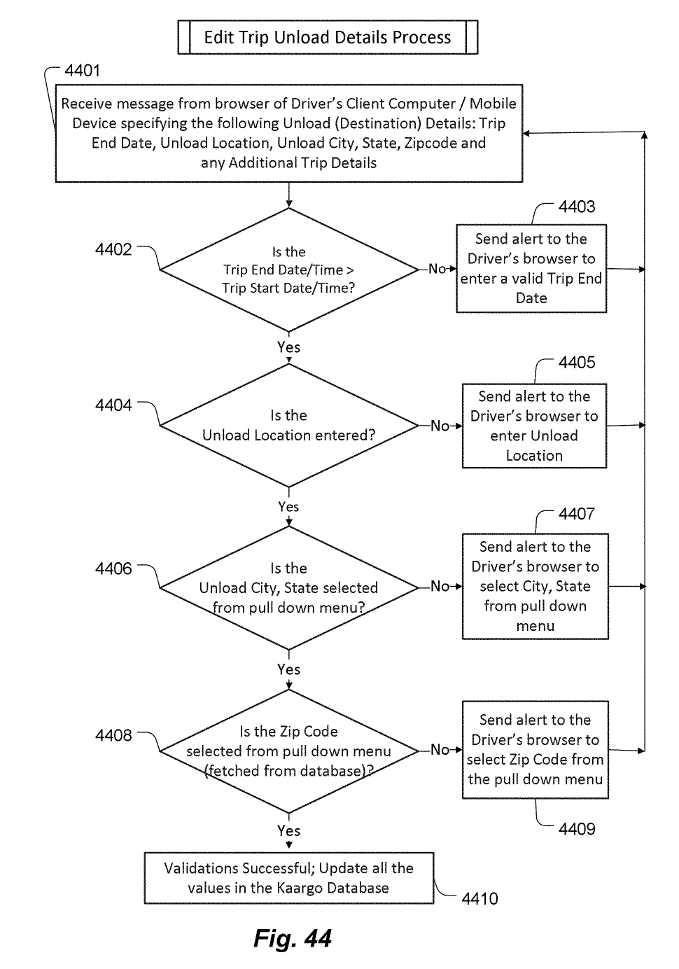

FIG. 44 is a block diagram of logical flow for the edit trip unload details sub-module of the Member Dashboard module 120 of FIG. 1A. In this module, in process 4401, the server system receives a message from the computer client of the driver with unload specific details such as trip end date/time, unload location address, unload city, unload state, unload zip code and any additional unload details. In subsequent processes, a series of validation tests are run. If any of the validations fail, appropriate alerts are sent to the driver's computer client so that they can be rectified. Specifically, in process 4402, it is determined whether trip end date and time are later than trip start date and time; if not, then, in process 4403, an alert is sent to the driver's browser requiring entry of valid data. In process 4404, there is testing whether the unload location has been entered; if not, then, in process 4405, an alert is sent to the driver's browser requiring entry of the appropriate data. In process 4406, there is testing whether the unload city and state have been entered from a pull-down menu; if not, then in process 4407, an alert is sent to the driver's browser requiring use of the pull-down menu to enter the unload city and state. In process 4408, there is testing whether the zip code of the unload location has been entered from a pull-down menu; if not, then, in process 4409, an alert is sent to the driver's browser requiring use of the pull-down menu to enter the zip code of the unload city and state. If, after all of these tests, all data has been determined to have been entered correctly, then in process 4410, the entered data is stored in the database.

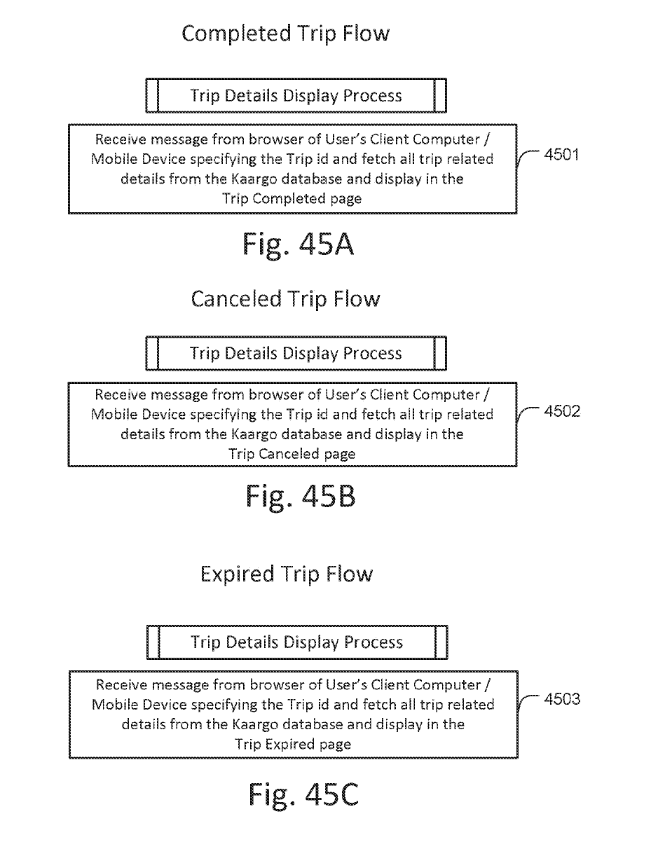

FIGS. 45A-45C are block diagrams of logical flow for the completed, canceled and expired trip sub-modules of the Member Dashboard module 120 of FIG. 1A. In the completed trip sub-module, in process 4501, shown in FIG. 45A, the server system receives a message from the member's computer client with trip ID; subsequently, the server system fetches all details for the completed trip; the server system sends a message to the member's computer client to display trips details in the trip completed page. In the canceled trip sub-module, in process 4502, shown in FIG. 45B, the server system receives a message from the member's computer client with trip ID; subsequently, the server system fetches all details for the canceled trip; the server system sends a message to the member's computer client to display trips details in the trip canceled page. In the expired trip sub-module, in process 4503, shown in FIG. 45C, the server system receives a message from the member's computer client with the trip ID; subsequently, the server system fetches all details for the expired trip; the server system sends a message to the member's computer client to display trips details in the trip expired page.

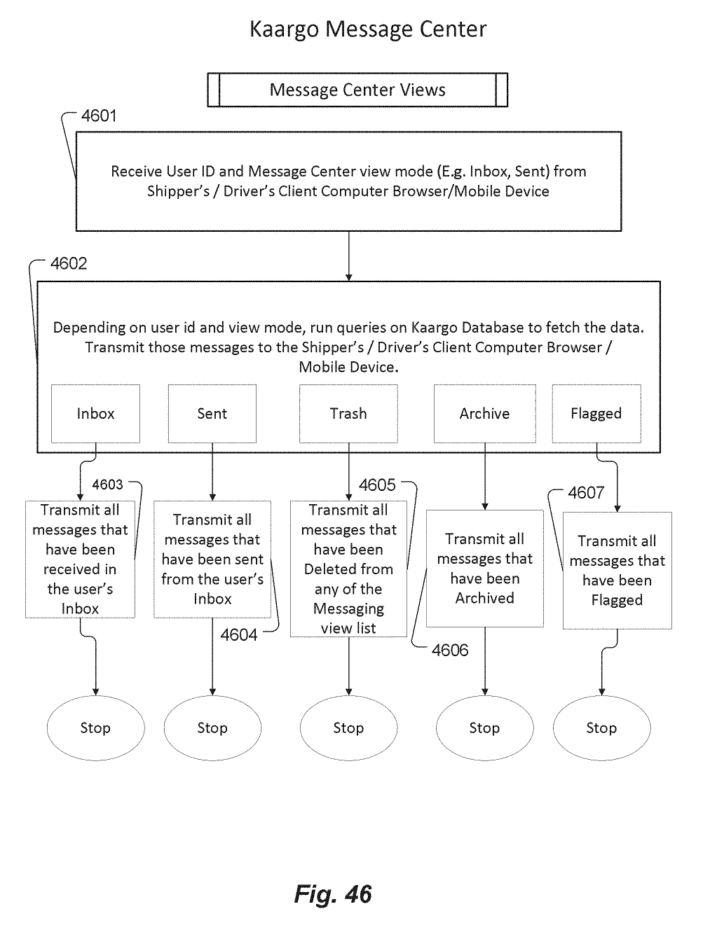

FIGS. 46-51 relate to logical flow for the various sub-modules of the Message Center 113 of FIG. 1A. FIG. 46 is a block diagram of logical flow for the various message center views of the Message Center module 113 of FIG. 1A. In this module, in process 4601, the server system receives a message from the member's computer client with user ID and message center view mode details. In process 4602, various actions are taken by the server system depending on the view mode. In process 4602, if the view mode received by the server system from the member's client computer is inbox, then, in process 4603, the server system fetches appropriate messages from database, and transmits them to the member's client computer for displaying in the message center inbox page. In process 4602, if the view mode received by the server system from the client computer is sent, then, in process 4604, the server system fetches appropriate messages from database, and transmits them to the member's client computer for displaying in the message center sent messages page. In process 4602, if the view mode received by the server system from the member's client computer is trash, then, in process 4605, the server system fetches appropriate messages from database, and transmits them to the member's client computer for displaying in the message center trash page. In process 4602, if the view mode received by the server system from the client computer is archive, then, in process 4606, the server system fetches appropriate messages from the database, and transmits them to the member's client computer for displaying in the message center archive page. In process 4602, if the view mode received by the server system from the client computer is flagged, then, in process 4607, the server system fetches appropriate messages from the database, and transmits them to the member's client computer for displaying in the message center flagged page.

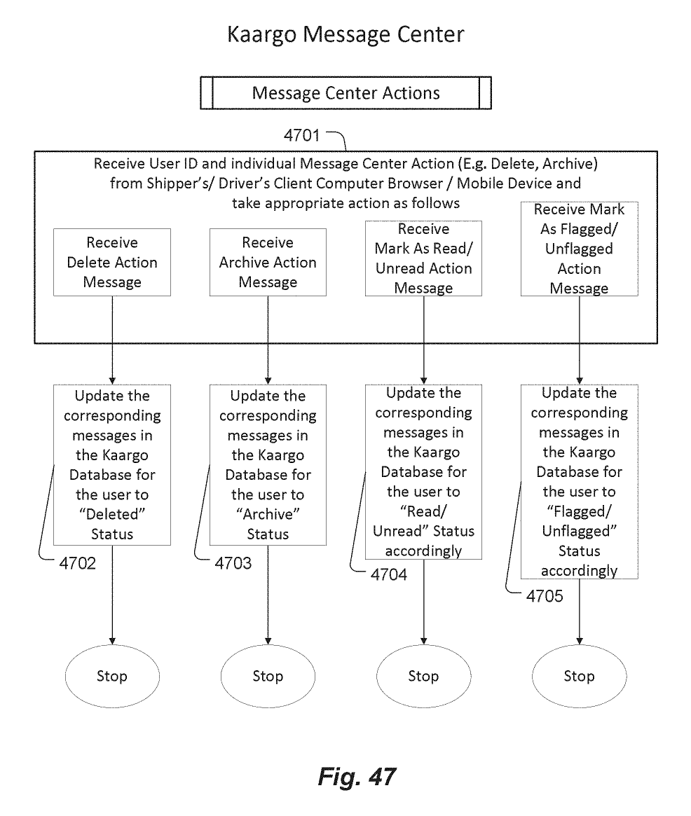

FIG. 47 is a block diagram of logical flow for the various message center actions of the Message Center module 113 of FIG. 1A. In this module, in process 4701, the server system receives a message from the member's computer client with user ID and actions that need to be taken on the member's message center. In process 4701, various actions are taken by the server system depending on the message center action received from the client computer. In process 4701, if the message center action received by the server system from the member's client computer is delete action, then, in process 4702, the server system updates the appropriate messages in the message center to deleted status. In process 4701, if the message center action received by the server system from the member's client computer is archive action, then, in process 4703, the server system updates the appropriate messages in the message center to archive status. In process 4701, if the message center action received by the server system from the member's client computer is mark as read or mark as unread action, then, in process 4704, the server system updates the appropriate messages in the message center to read or unread status as appropriate. In process 4701, if the message center action received by the server system from the member's client computer is mark as flagged or mark as unflagged action, then, in process 4705, the server system updates the appropriate messages in the message center to flagged or unflagged status as appropriate.

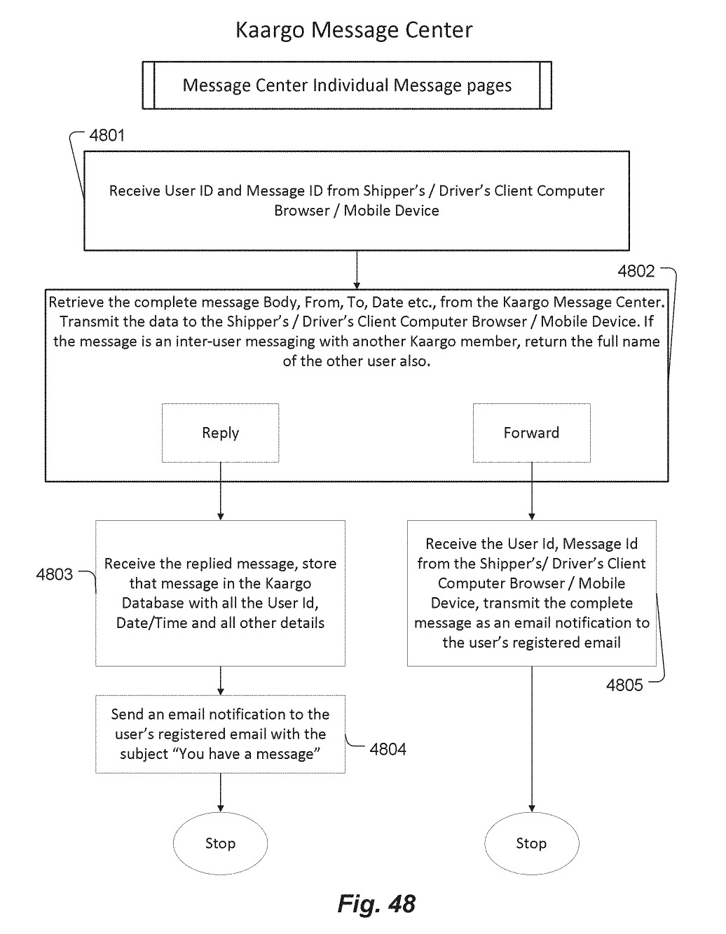

FIG. 48 is a block diagram of logical flow for the individual pages of the Message Center module 113 of FIG. 1A. In this module, in process 4801, the server system receives a message from the member's computer client with user ID and message ID details. In process 4802, various actions are taken by the server system depending on the requested action from the computer client. In process 4802, the server system retrieves message title, message body, from username, to username, message date details from the message center, and transmits them to the member's client computer for displaying in the message center. Subsequently, in process 4802, if the action received by the server system from the member's client computer is reply, then, in process 4803, the server system receives the replied message from the computer client, and stores the message details in database. In addition, in process 4804, server system transmits an e-mail message to the user's registered e-mail address using an e-mail gateway service with the subject “You have a message” with the server system's automated e-mail address in the From field of this message. In process 4802, if the action received by the server system from the member's client computer is forward, then, in process 4805, the server system receives the user ID and message ID details from computer client, and transmits the complete message as a forwarded e-mail message to the user's registered e-mail address using an e-mail gateway service with the same subject as the original message with the server system's automated e-mail address in the From field of this message.

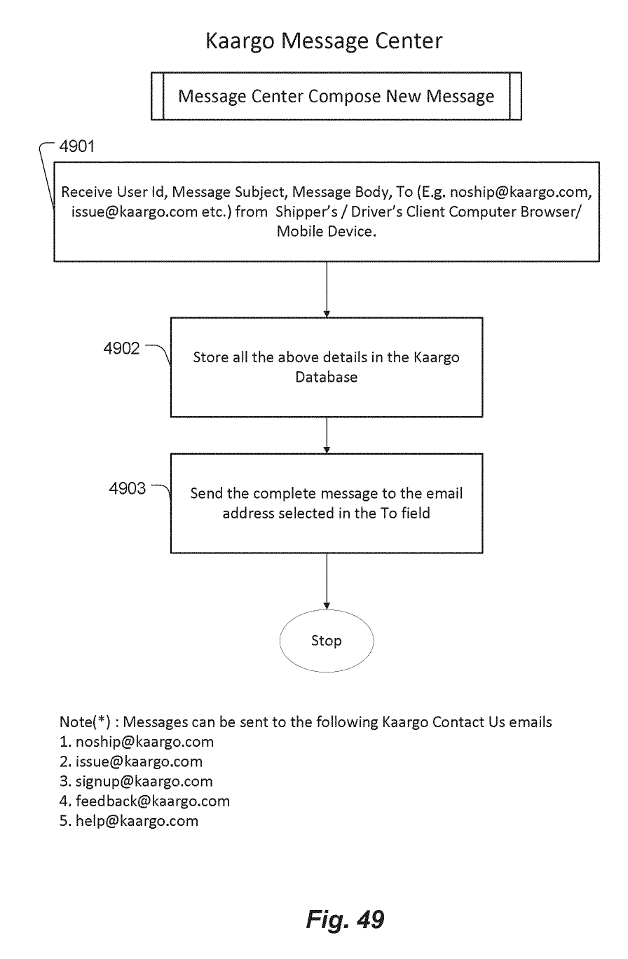

FIG. 49 is a block diagram of logical flow for the compose new message page of the Message Center module 113 of FIG. 1A. In this module, in process 4901, the server system receives a message from the member's computer client with user ID, message subject, message body and message recipient details. In process 4902, the server system stores all of these values in database. In process 4903, the server system transmits an e-mail message to the recipient e-mail address in the To field using an e-mail gateway service with the complete message with the server system's automated e-mail address in the From field of this message.

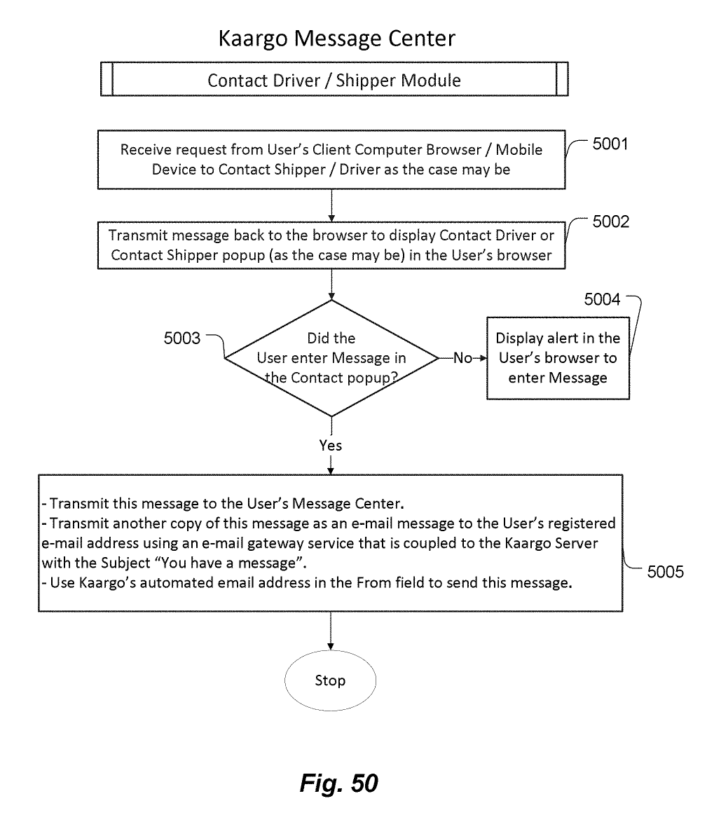

FIG. 50 is a block diagram of logical flow for the contact driver/shipper sub-module of the Message Center module 113 of FIG. 1A. In this module, in process 5001, the server system receives a message from the member's computer client to contact driver or shipper, as the case may be. In process 5002, the server system transmits a message to the member's client computer to display Contact Driver or Contact Shipper popup as applicable. In process 5003, there is testing whether the user entered any message in the contact popup screen; if not, then, in process 5004, an alert is sent to the user's browser requiring entry of the appropriate data. In process 5005, the server system transmits this message to the member's message center. In addition, the server system transmits a copy of this message as an e-mail message to the user's registered e-mail address using an e-mail gateway service with the subject “You have a message” with the server system's automated e-mail address in the From field of this message.

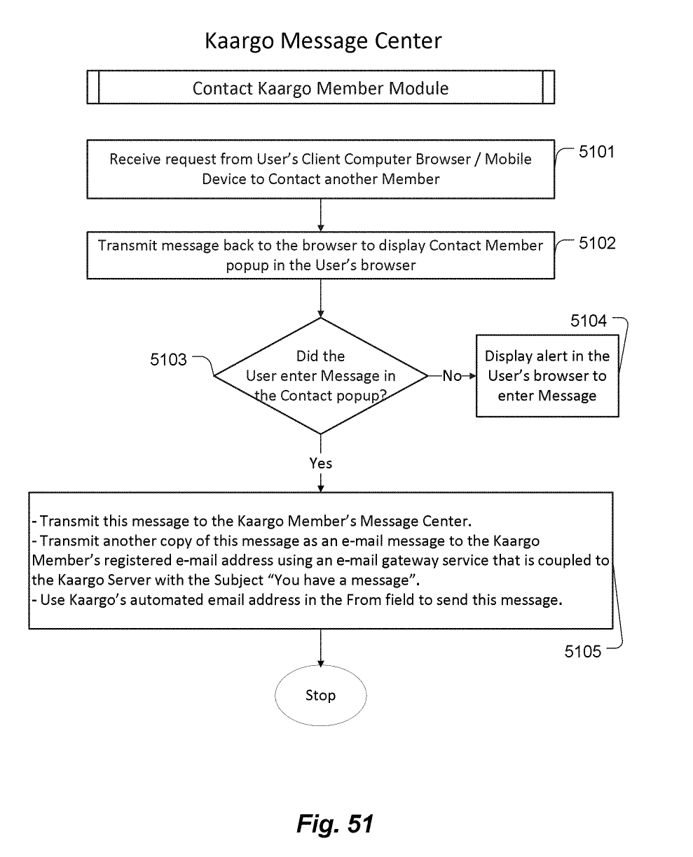

FIG. 51 is a block diagram of logical flow for the contact Kaargo member sub-module of the Message Center module 113 of FIG. 1A. In this module, in process 5101, the server system receives a message from member's computer client to contact another member. In process 5102, the server system transmits a message to the client computer to display the Contact Member popup. In process 5103, there is testing whether the user entered any message in the contact popup screen; if not, then, in process 5104, an alert is sent to the user's browser requiring entry of the appropriate data. In process 5105, the server system transmits this message to the member's message center. In addition, the server system transmits a copy of this message as an e-mail message to the user's registered e-mail address using an e-mail gateway service with the subject “You have a message” with the server system's automated e-mail address in the From field of this message.

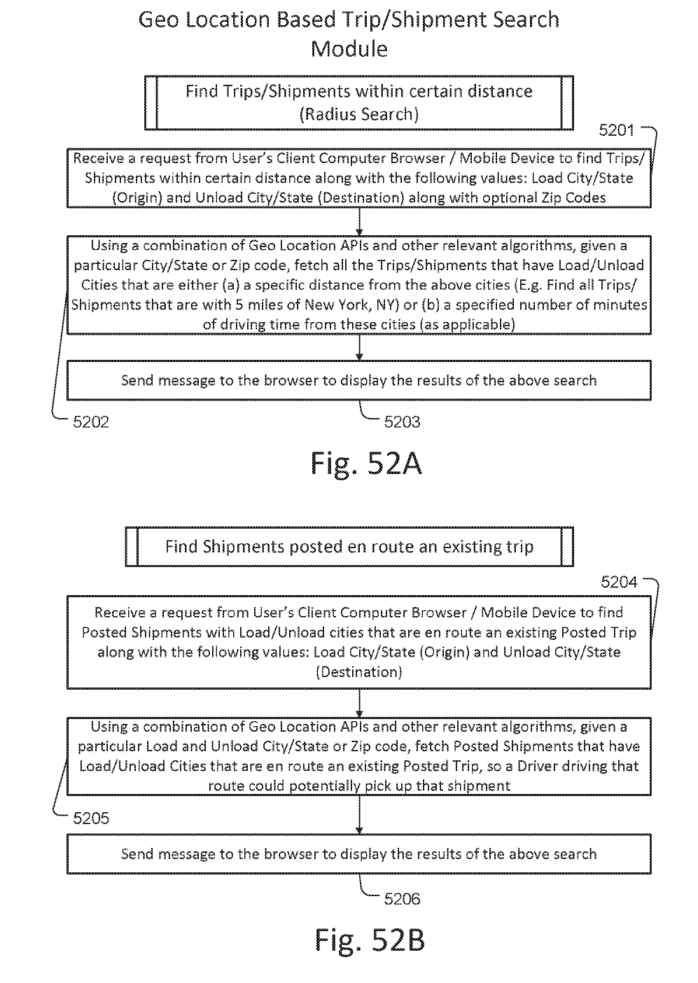

FIG. 52A and FIG. 52B are block diagrams of logical processes in the find trips or shipments within certain distance and find shipments posted en route for existing trips sub-modules in the Geo-location based search for trips and shipments module 118 of FIG. 1A. FIG. 52A is a block diagram of logical flow for finding trips or shipments within certain distance or within certain driving time sub-module of the Geo-location based search, also referred to as radius search, for trips and shipments module 118 of FIG. 1A. In process 5201, the server system receives a message from member's computer client with either origin load city, state or origin zip code, and destination unload city, state or destination zip code. In process 5202, the server system employs a combination of geo location based APIs (application programming interface) and other relevant matching algorithms, to fetch all the trips or shipments that have load (origin) or unload (destination) cities, either within a specific distance from a given city, state or zip code, also referred to as radius search, or fetch all the trips or shipments that have load (origin) or unload (destination) cities within a specified number of minutes of driving time from these cities, or some combination thereof. In process 5203, the server system transmits a message to the member's computer client to display the results of this radius search. FIG. 52B is a block diagram of logical flow for finding trips or shipments en route for an existing trip. In process 5204, the server system receives a message from the member's computer client with either origin load city, state or origin zip code, and destination unload city, state or destination zip code. In process 5205, the server system employs a combination of geo location based APIs (application programming interface) and other relevant matching algorithms, to fetch all the trips or shipments that have load (origin) or unload (destination) cities that are en route a given pair of cities. In process 5206, the server system transmits a message to the member's computer client to display the results of this radius search.

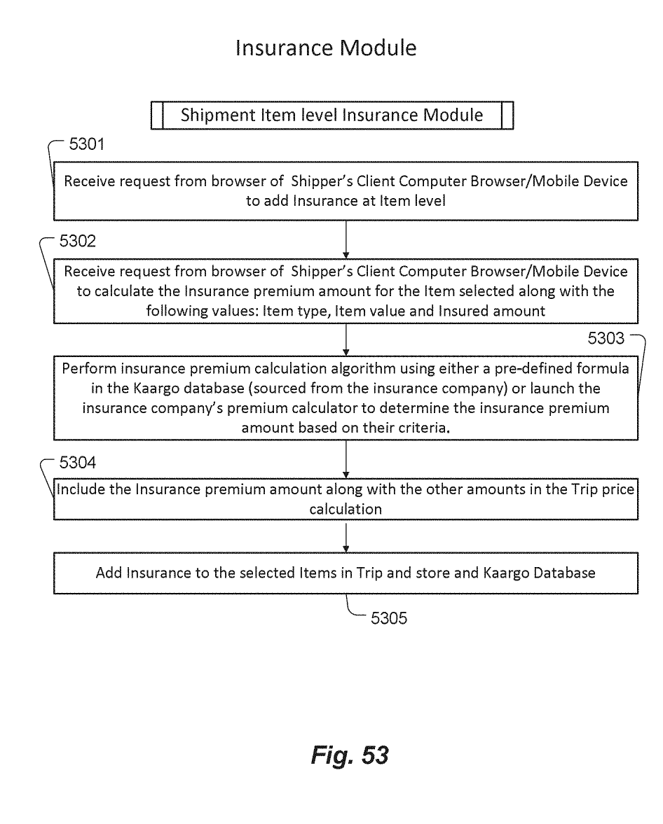

FIG. 53 is a block diagram of logical processes in the Insurance sub-module of the Insurance module 107 of FIG. 1A. In process 5301, the server system receives a message from the member's computer client with a request to add insurance at the shipment item level. In process 5302, the server system receives a message from the member's computer client with item type, item description, item value and insured amount details to calculate the shipment item's insurance premium amount. In process 5303, the server system performs insurance premium calculation either using a pre-defined premium rate and formula in the database, a customized algorithm, or by making a direct or remote call to the insurance company's computer system to calculate the insurance premium amount for the items to be insured, or some combination thereof. In process 5304, the server system transmits a message to the member's computer client to include the insurance premium amount along with the other price details in the trip price calculation. In process 5305, the server system adds insurance premium amounts to the selected items in the trip and stores them in the database.

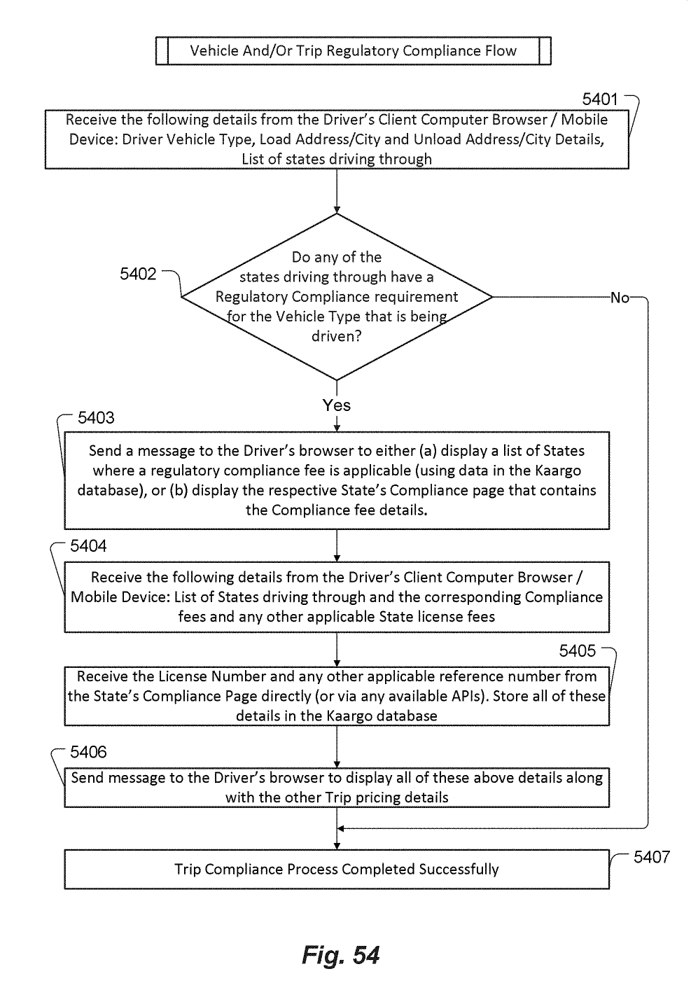

FIG. 54 is a block diagram of logical processes in the vehicle and trip regulatory compliance sub-module of the Regulatory Compliance module 105 of FIG. 1A. In process 5401, the server system receives a message from the driver's computer client with driver vehicle type, load address, unload address and a list of states the driver is driving through details. In process 5402, there is testing whether any of the states the driver is driving through has a regulatory compliance requirement for the vehicle type used in the trip. If so, then, in process 5403, the server system either sends a message to the driver's computer client with a list of states, from the database, where the regulatory compliance fee is applicable or displays the respective state's online vehicle compliance page that contains the compliance fee and other relevant details. In process 5404, the server system receives a message from the driver's computer client with a list of states the driver is driving through, and the corresponding compliance fees and any other state, county or city level license and any other applicable fees. In process 5405, the server system receives a message from the driver's computer client with a license or any other applicable reference number from the state's compliance page directly or via any available APIs; the server system stores all of these details in the database. In process 5406, the server system transmits a message to the driver's computer client to display all of the trip's compliance details along with other trip pricing details. If, after all of these processing completes successfully, in process 5407, the trip vehicle compliance processing is considered to have been completed successfully.

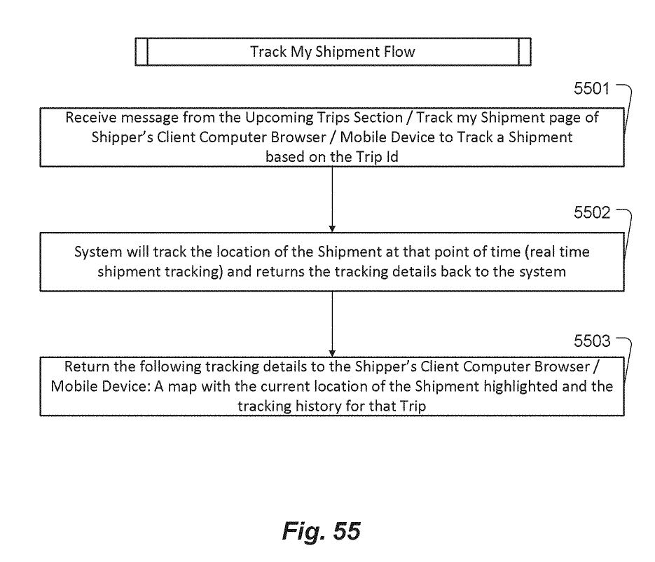

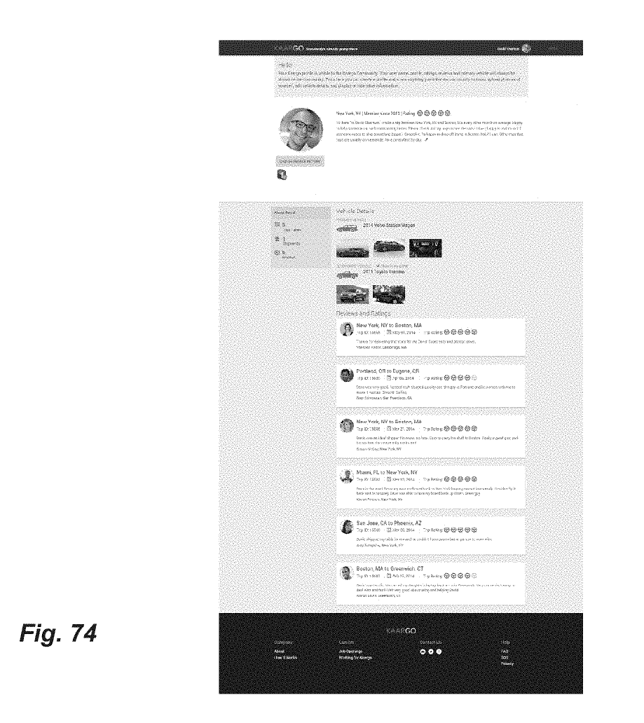

FIG. 55 is a block diagram of logical processes in the track my shipment sub-module of the Dashboard Compliance module 120 of FIG. 1A. In process 5501, the server system receives a message from the shipper's computer client of the shipper with trip ID details to track a shipment. In process 5502, the server system tracks the location of the shipment on a real time basis, using where applicable an application running on a mobile computer of the driver that is in communication with the server to transmit contemporaneous geolocation data to the server. In process 5503, the server system transmits a message to the shipper's computer client with a map that shows the current location of the shipment highlighted and a tracking history for that trip, as illustrated in FIG. 74. In order for the track my shipment sub-module to function, the application running on the mobile computer of the driver must have the interne connectivity and location services enabled, so that it can transmit contemporaneous geolocation data to the server at pre-defined regular intervals.

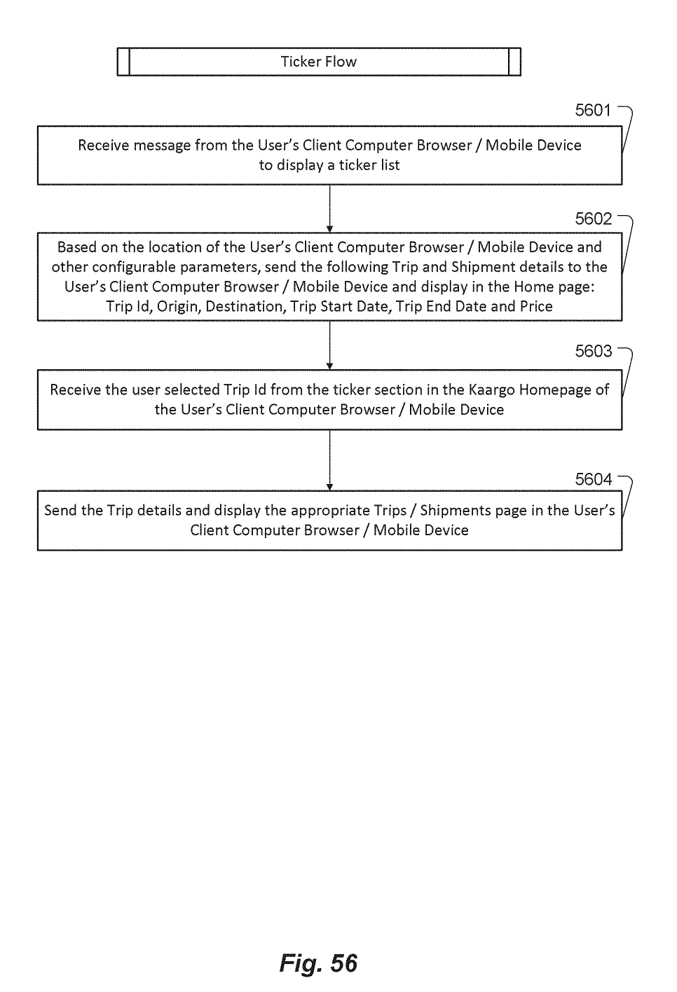

FIG. 56 is a block diagram of logical processes in the ticker sub-module of the search for trips and shipments module 118 of FIG. 1A. In process 5601, the server system receives a message from the user's computer client with a request to display a ticker list. In process 5602, the server system, based on the location of the user's computer client and other configurable parameters, transmits a message to the user's computer client with a running list of trip ID, origin, destination, trip start date, trip end date and trip price of all active, available trips and shipments in the system. In process 5603, the server system receives a message from the user's computer client with a user selected trip ID from the ticker section in the computer client. In process 5604, the server system transmits a message to the user's computer client with trip details to be displayed in the appropriate trips or shipments page.

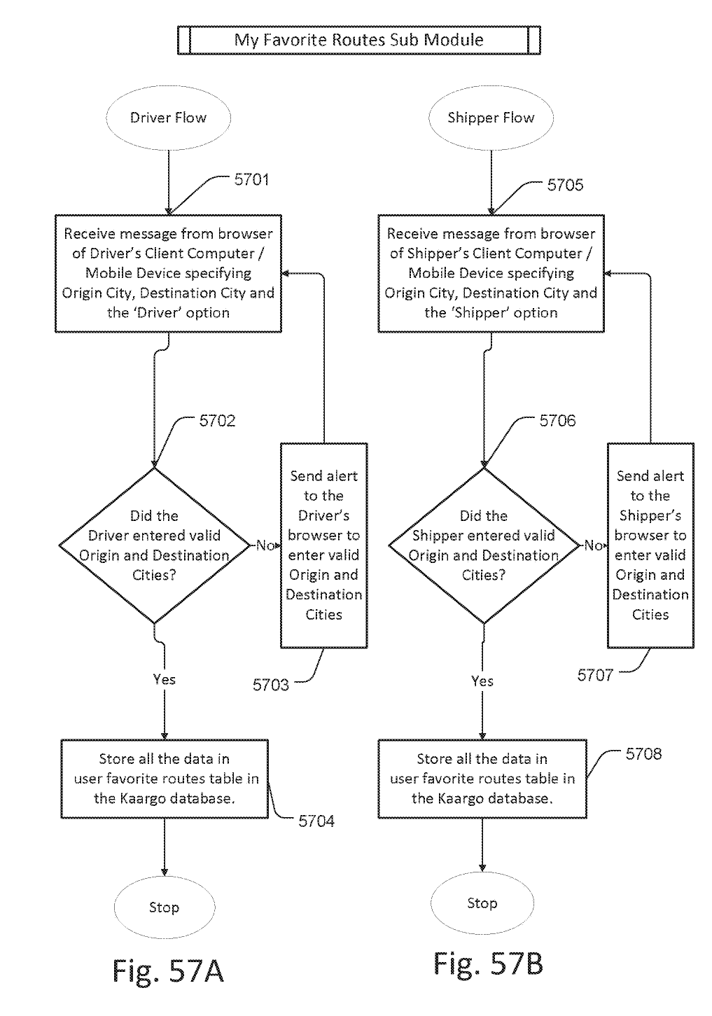

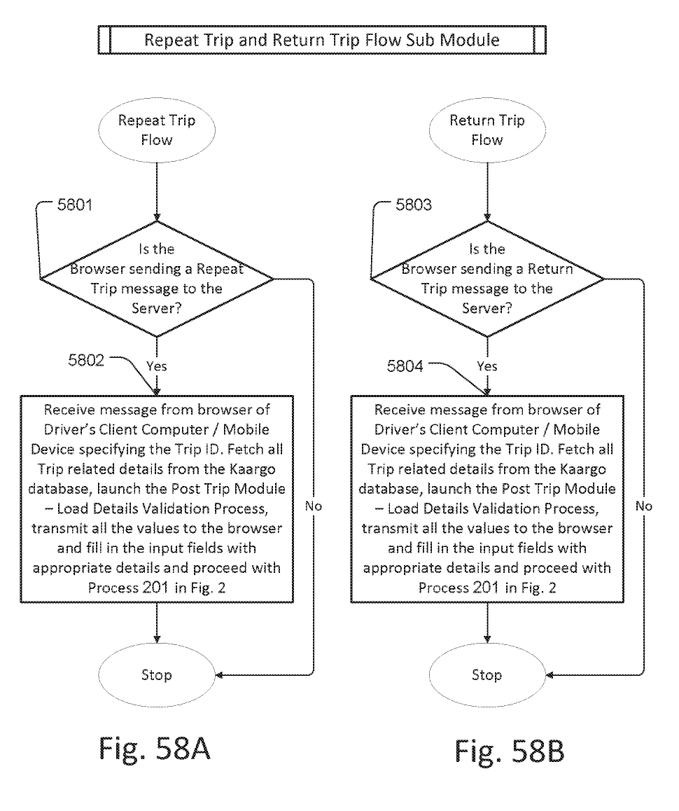

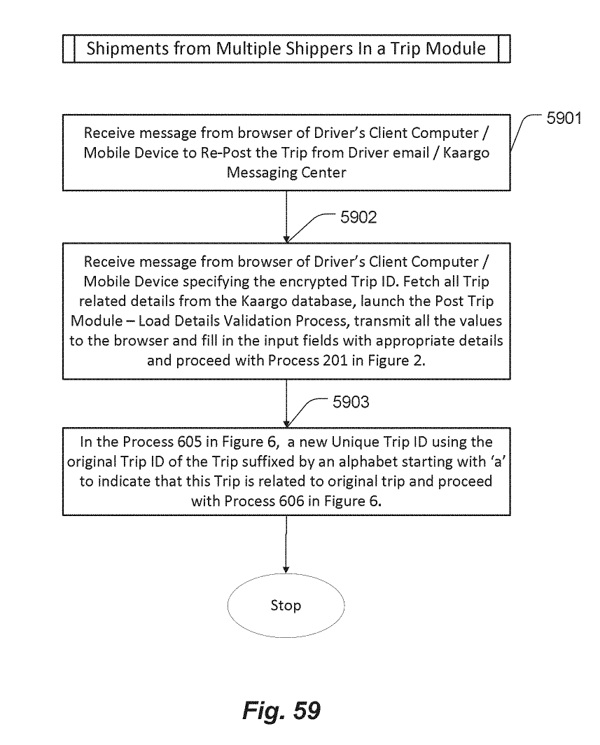

FIG. 57A and FIG. 57B are block diagrams of logical processes in the My Favorite routes sub-modules of the Profile module 114 of FIG. 1A. In process 5701, in the Driver flow, the server system receives a message from the driver's computer client with an origin city, destination city and the Driver option. In process 5702, there is testing whether a valid origin city and destination city have been entered; if not, then, in process 5703, an alert is sent to the driver's browser requiring entry of the appropriate data. In process 5704, the entered data is stored in the server system. In process 5705, in the Shipper flow, the server system receives a message from the shipper's computer client with an origin city, destination city and the Shipper option. In process 5706, there is testing whether a valid origin city and destination city have been entered; if not, then, in process 5707, an alert is sent to the shipper's browser requiring entry of the appropriate data. In process 5708, the entered data is stored in the server system.

FIG. 58A and FIG. 58B are block diagrams of logical processes in the repeat trip and return trip sub-modules of the Dashboard module 120 of FIG. 1A. In FIG. 58A, in process 5801, the server system receives a message from the driver's computer client with a trip ID. There is testing whether the driver's browser is sending a valid repeat trip message to the server system; if not, then, no action is required. In process 5802, the server system fetches all the trip related details from the database, launches the Post a Trip module, Load Details Validation process, and transmits all the trip related values to the driver's computer client, and the processing proceeds to Post a Trip process 201 as in FIG. 2. In FIG. 58B, in process 5802, the server system receives a message from the driver's computer client with a trip ID. There is testing whether the driver's browser is sending a valid return trip message to the server system; if not, then, no action is required. In process 5804, the server system fetches all the trip related details from the database, assigns the values as appropriate, launches the Post a Trip module, Load Details Validation process, and transmits all the trip related values to the driver's computer client, and the processing proceeds to Post a Trip process 201 as in FIG. 2.

FIG. 59 is a block diagram of logical processes in the shipments from multiple shippers in a trip module of the Purchase a Trip module 116 of FIG. 1A. In 5901, the server system receives a message from the driver's computer client through the driver's registered e-mail or through the member's message center an encrypted trip ID. In 5902, the server system fetches all the trip related details from the database, launches the Post a Trip module, Load Details Validation process, and transmits all the trip related values to the driver's computer client, and the processing proceeds to Post a Trip process 201 as in FIG. 2. In 5903, the server system creates a trip ID using the original trip ID of the Trip suffixed by an alphabet starting with “a” to indicate that this Trip is related to the original Trip, and the processing proceeds to Post a Trip process 606 as in FIG. 6.

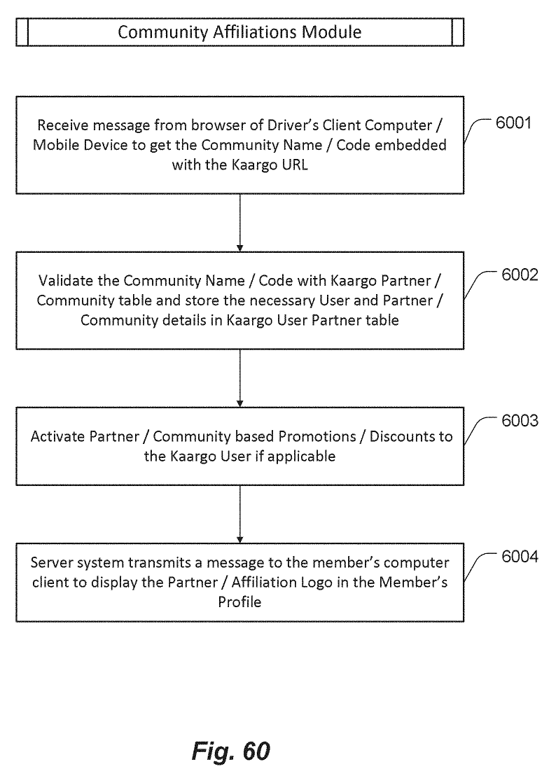

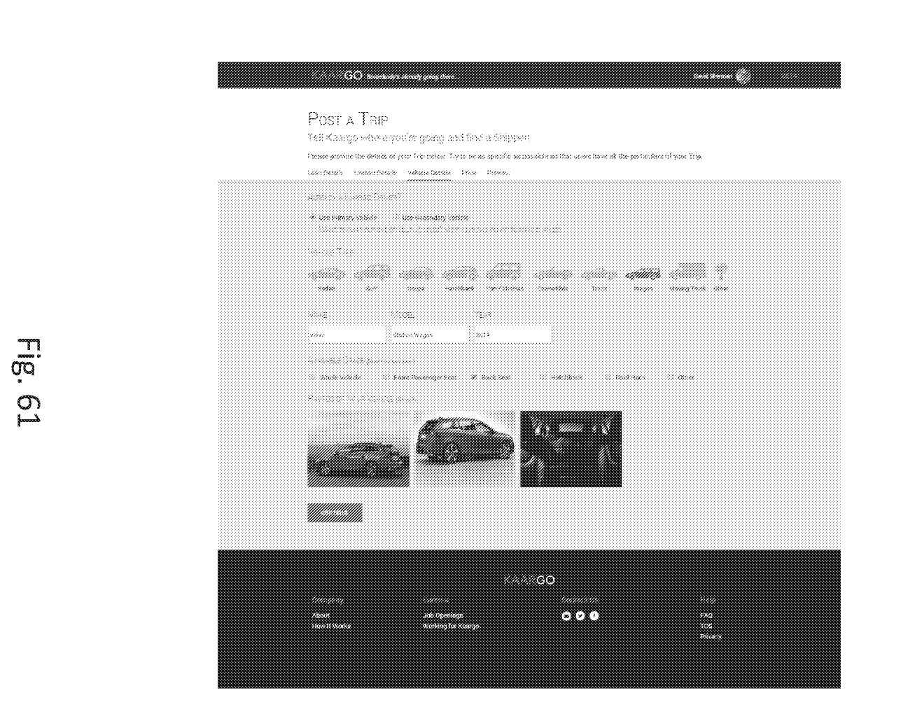

FIG. 60 is a block diagram of logical processes in the community affiliations module of the Public Profile module 115 of FIG. 1A. In 6001, the server system receives a message from the driver's computer client with the community name or code embedded within the Kaargo URL (i.e. Uniform Resource Location). In 6002, the server system validates the community name or code with the database. In 6003, the server system activates any promotions or discounts that are currently available for the community. Subsequently, in 6004, the server system transmits a message to the member's computer client to display the community or affiliation logo in the member's profile page.

FIG. 61 through FIG. 78 are representations of web pages, displayed on a client computer of a user, providing features and functionalities of a user interface in an embodiment suitable for use in connection with the embodiment of FIG. 1A.

FIG. 61 is a representation of a web page display of a post a trip sub-module which illustrates how vehicles types, vehicle images, make, model and year are captured in the user interface.

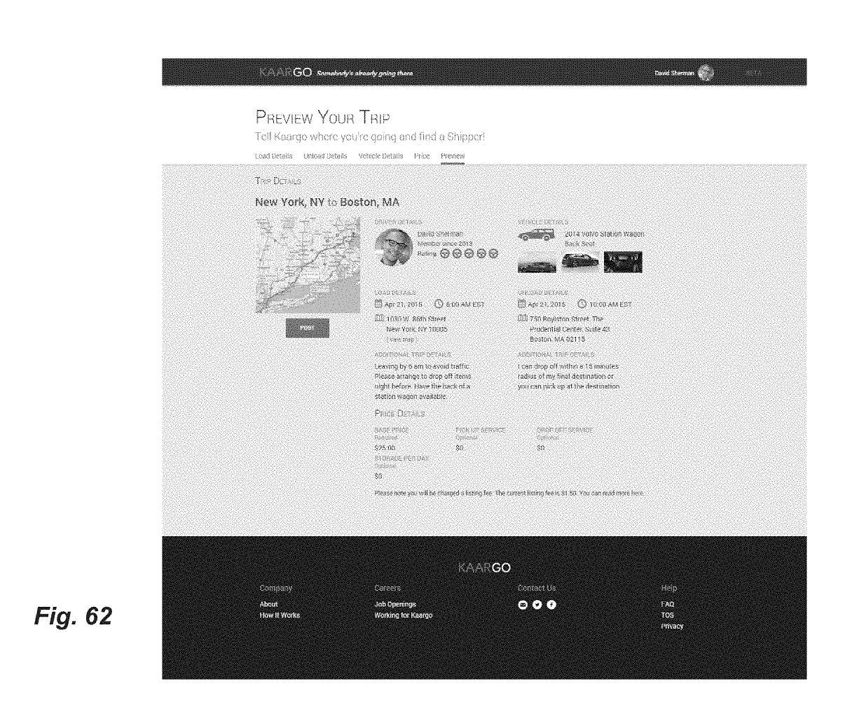

FIG. 62 is a representation of a web page display of a post a trip sub-module which illustrates how all the trip details are previewed before being posted in the user interface.

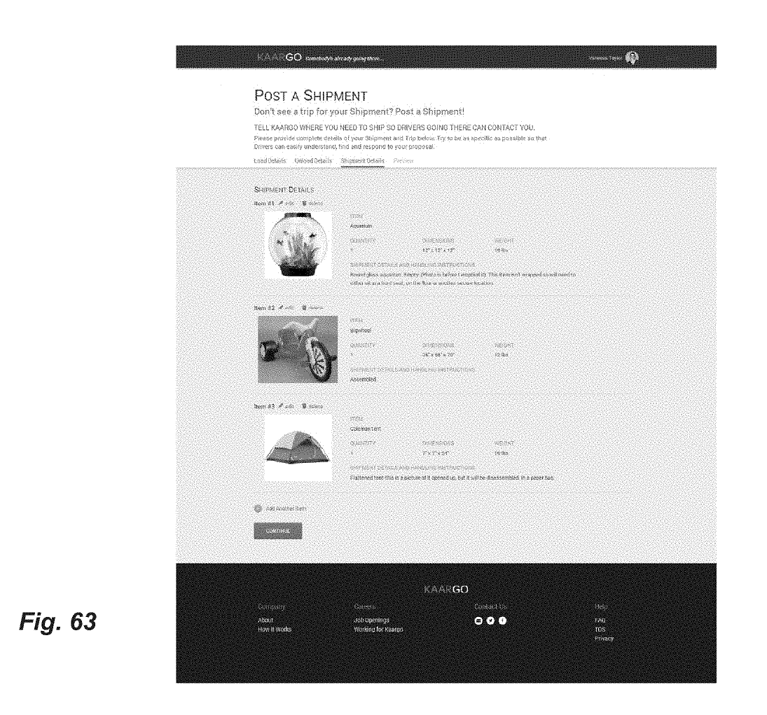

FIG. 63 is a representation of a web page display of a post a shipment sub-module which illustrates how multiple items, item images, quantity, dimension etc. are captured in the user interface.

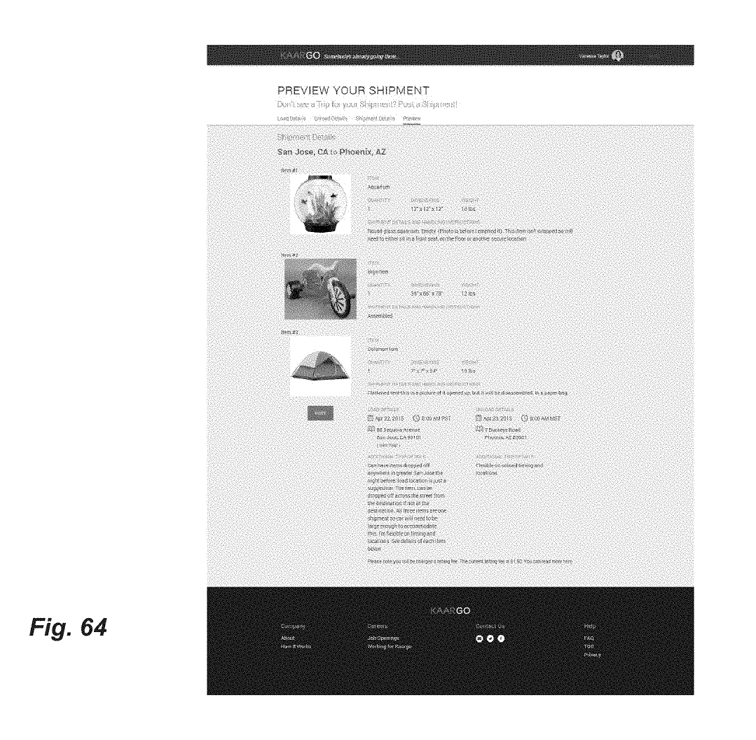

FIG. 64 is a representation of a web page display of a post a shipment sub-module which illustrates how all the shipment details are previewed before being posted in the user interface.

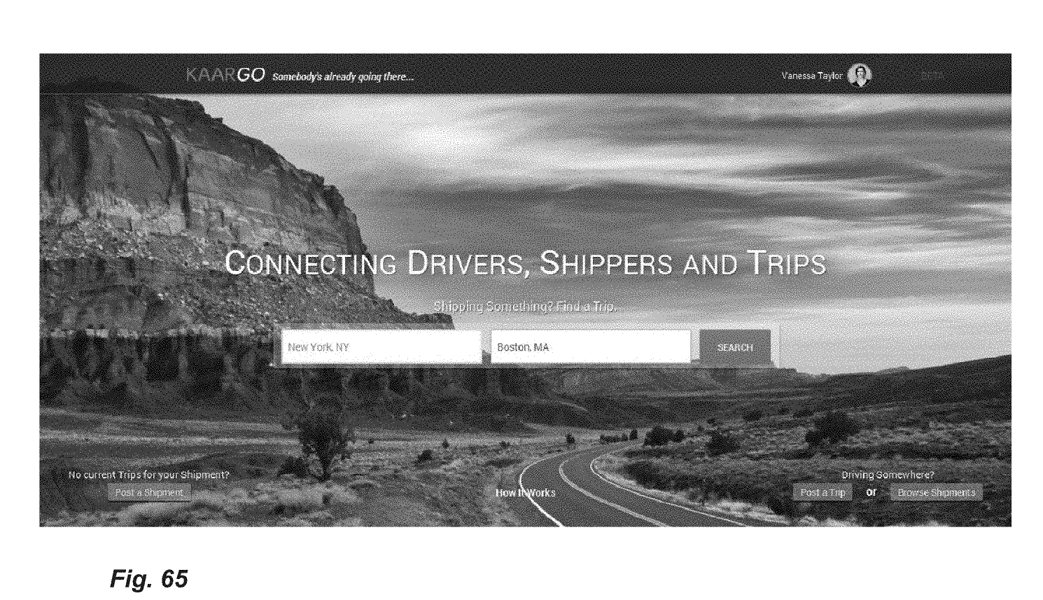

FIG. 65 is a representation of a web page display wherein a shipper can search for available trips based on an origin and a destination city.

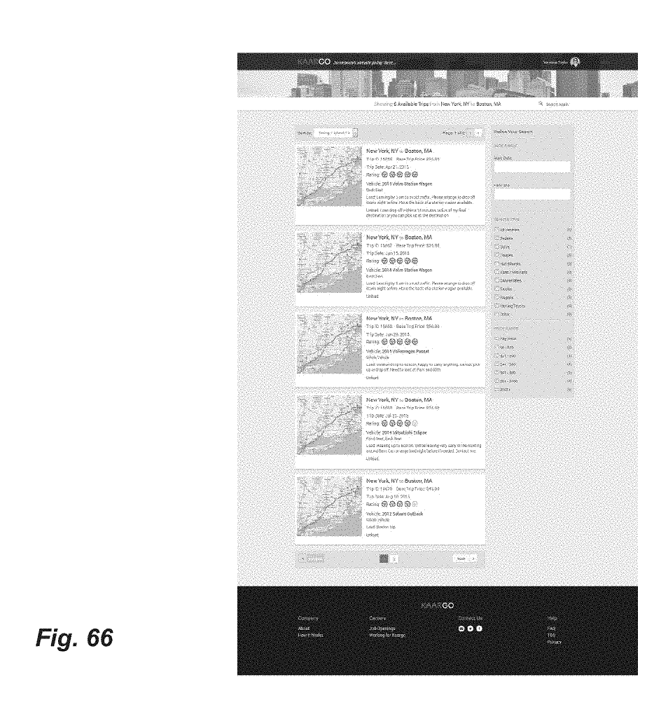

FIG. 66 is a representation of a web page display of all available trips in the system for a given origin and a destination city route, and also includes refinement of the search criteria.

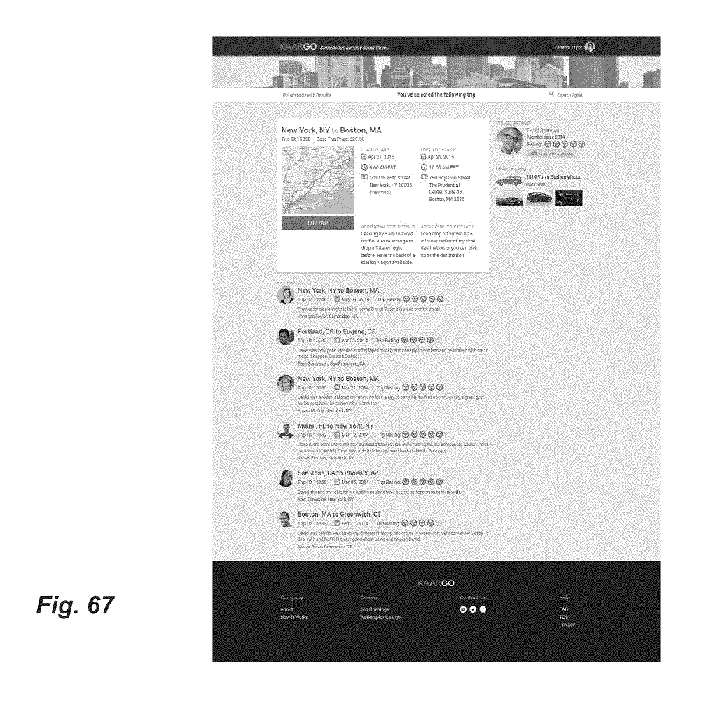

FIG. 67 is a representation of a web page display by which may be invoked a purchase a trip process that shows a trip's load/unload details, vehicle used for the trip, driver details, ratings and reviews for the driver.

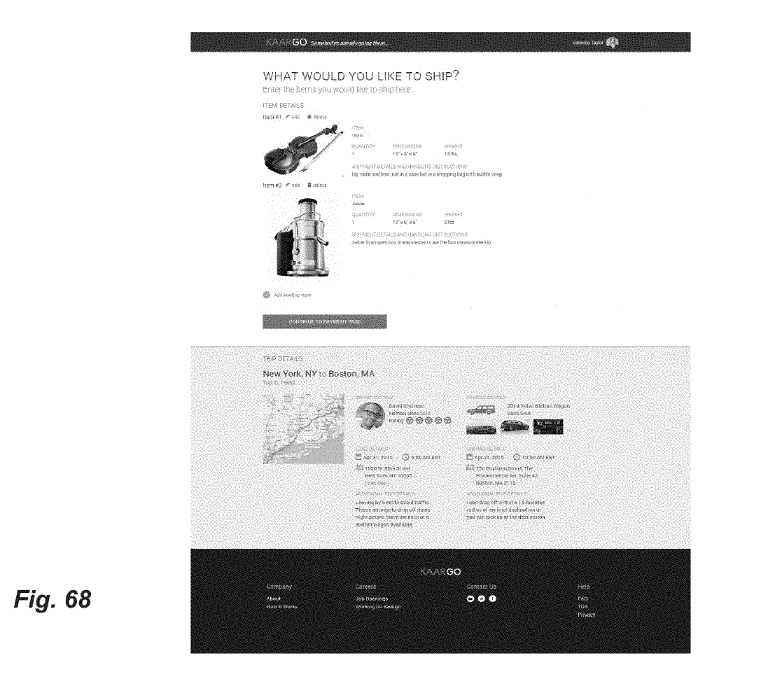

FIG. 68 is a representation of a web page display of a purchase a trip process, showing the items entered for that trip.

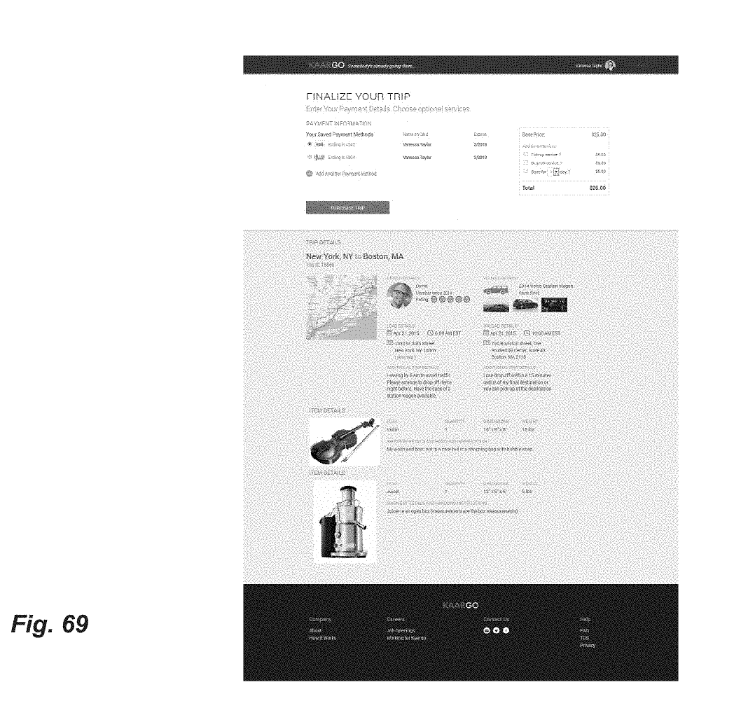

FIG. 69 is a representation of a web page display of the Purchase a Trip process, showing payment methods and the total amount to be paid for that trip.

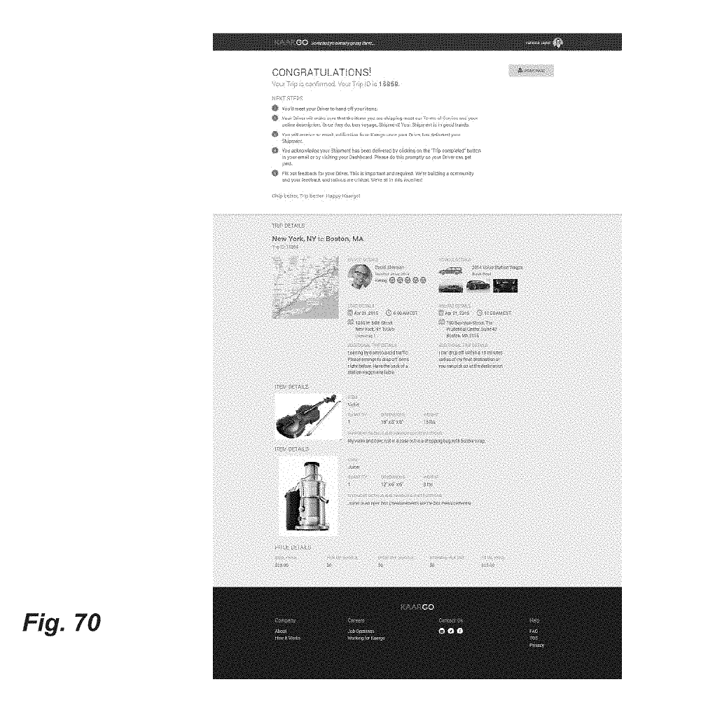

FIG. 70 is a representation of a web page display of a purchase a trip process, showing successful completion of purchasing a trip, along with trip-related details.

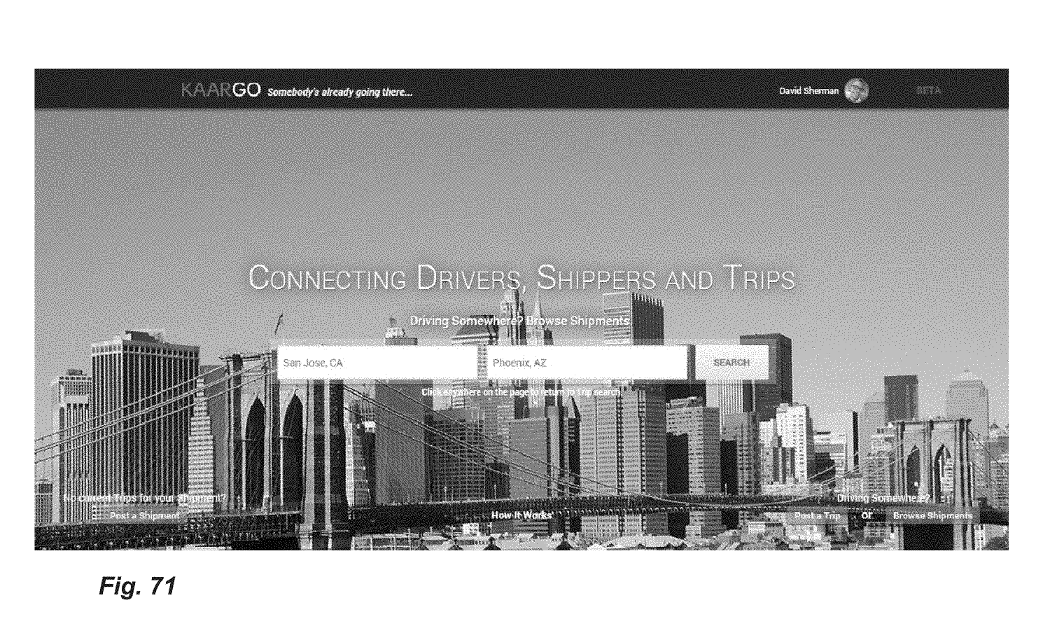

FIG. 71 is a representation of a web page display wherein a driver can search for available shipments based on an origin and a destination city.

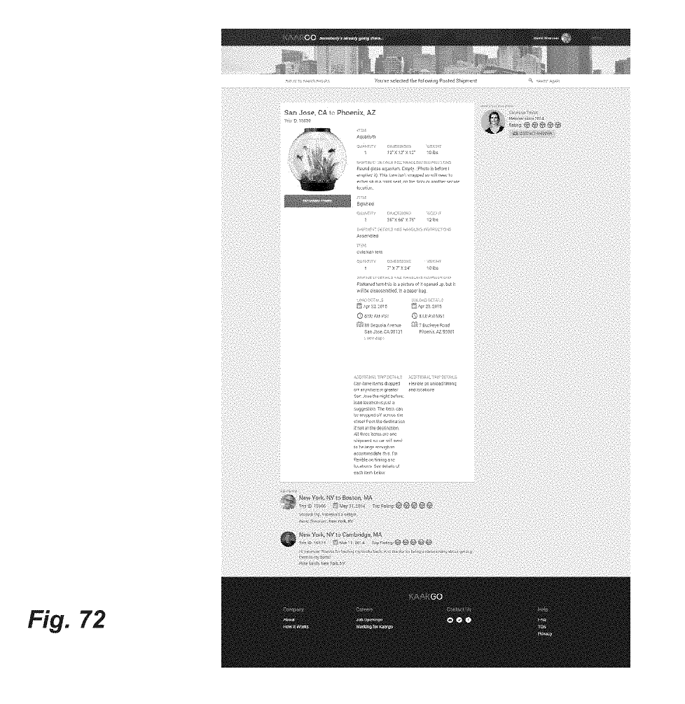

FIG. 72 is a representation of a web page display, in the purchase a trip flow, showing offers by drivers to make a trip for a shipment posted by a shipper for a given origin and a destination city route.

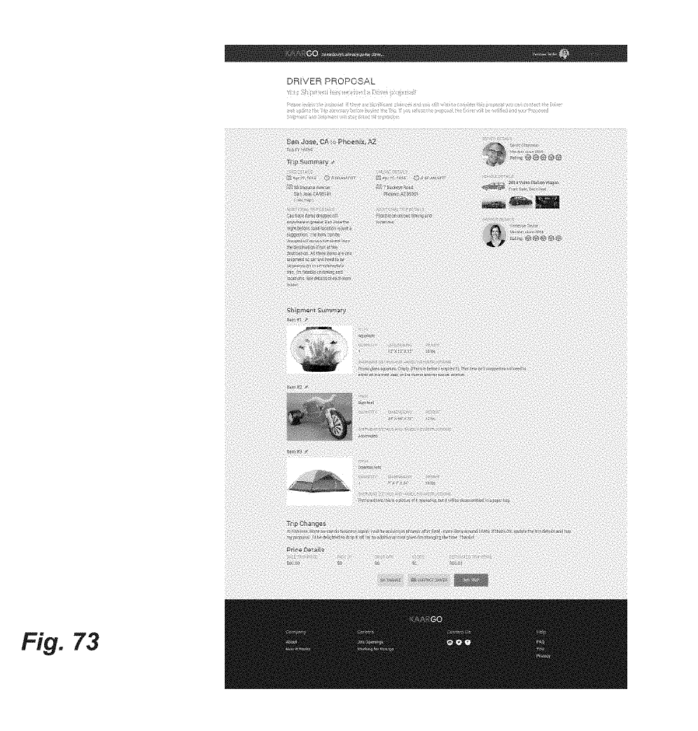

FIG. 73 is a representation of a web page display, in the driver proposal module flow, wherein a shipper is purchasing a trip based on a proposal received from a driver offering to undertake the trip.

FIG. 74 is a representation of a web page display, associated with a member personal profile.

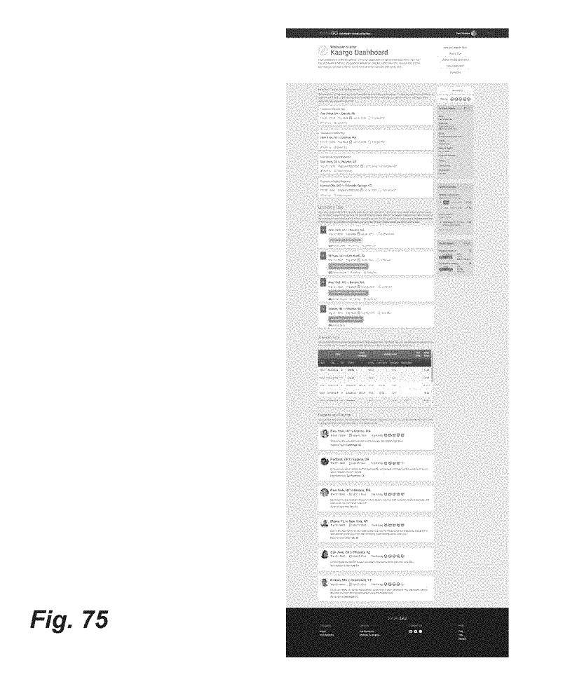

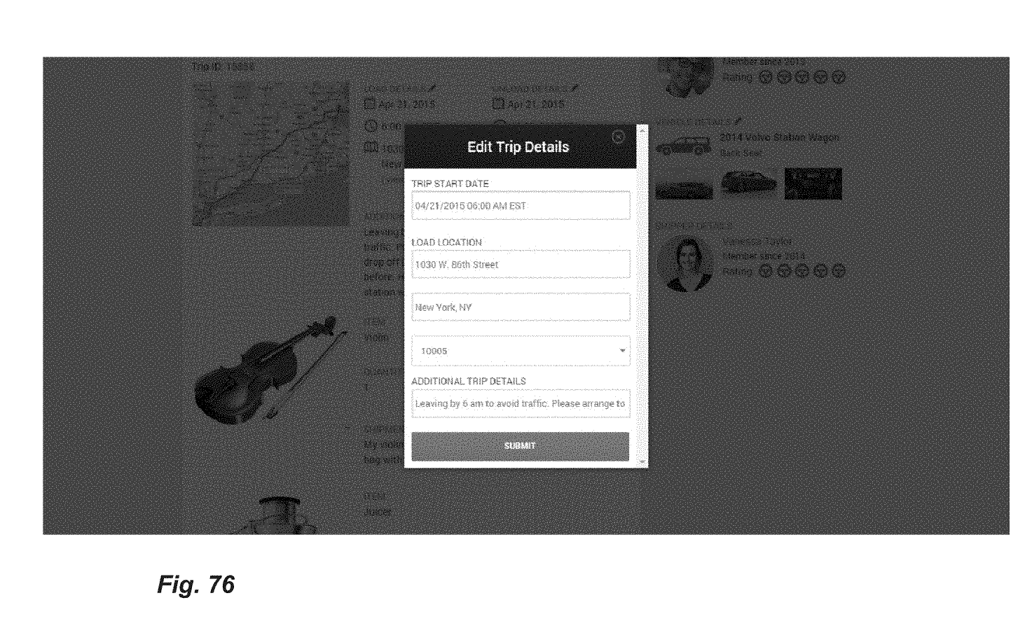

FIG. 75 is a representation of a web page display of the dashboard.

FIG. 76 is a representation of a web page display of the edit trip details from the dashboard.

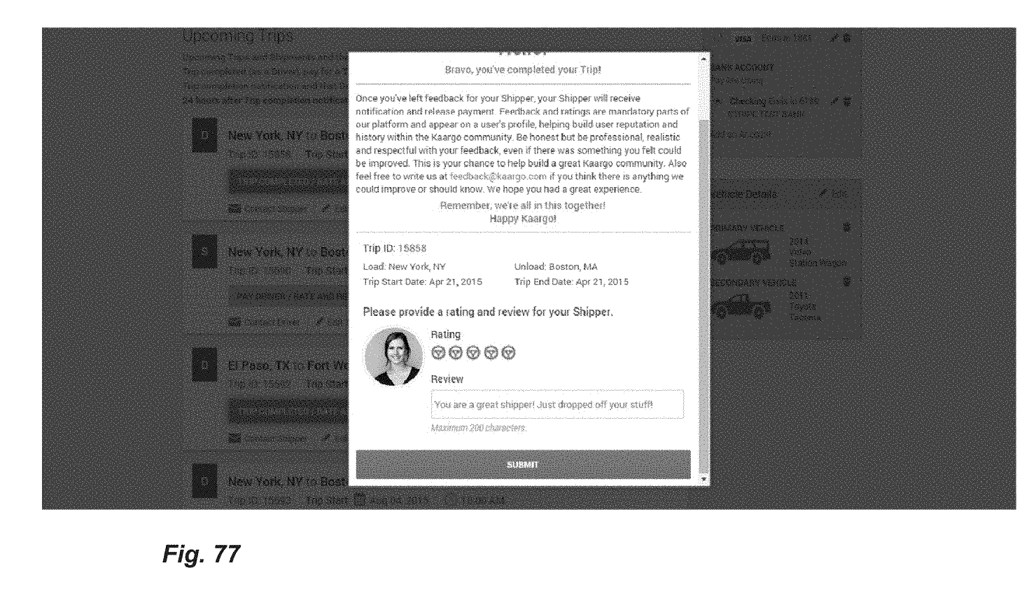

FIG. 77 is a representation of a web page display on a client computer of a driver, providing rating and review for the shipper from the dashboard.

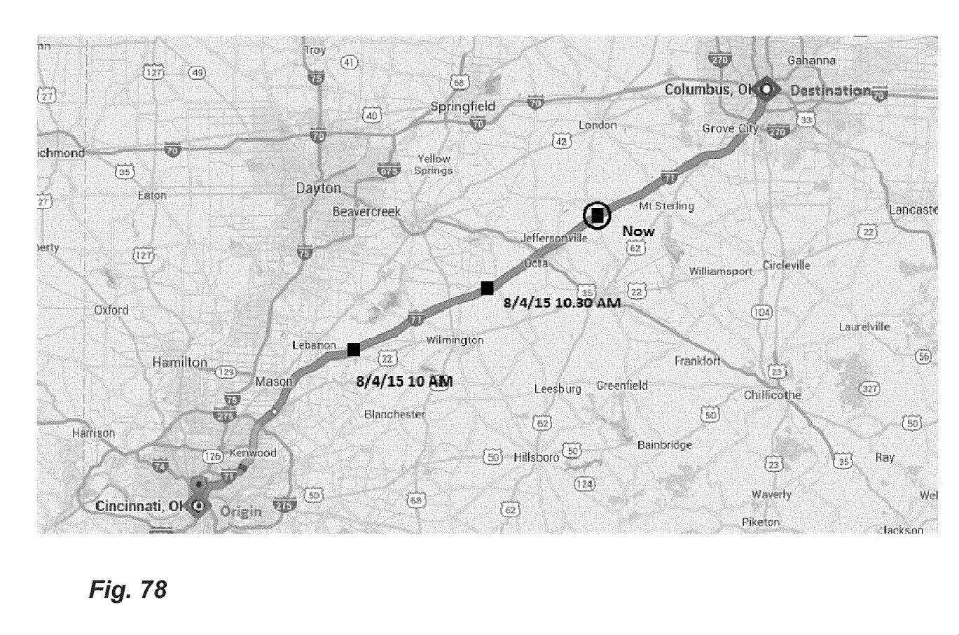

FIG. 78 is a representation of a web page display on a client computer of a shipper, providing a map with shipment tracking data in the form of contemporaneous geolocations that show the current location of the shipment highlighted and a tracking history for that trip.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A computer-implemented method of providing a marketplace platform that enables one of a first set of first consumers, each first consumer planning a trip in a motor vehicle driven by such first consumer, the trip having an origin and a destination over a specific time period, and willing to carry a set of items from a pickup location within a first specified distance of the origin to a delivery location within a second specified distance of the destination, to connect and interact with one of a second set of second consumers, each second consumer desiring to ship a shipment from a starting location to an end location over a specific time interval, wherein, the one of the first consumers and the one of the second consumers may choose to connect with each other on the basis of perceived matches (i) between the origin and the starting location, (ii) between the destination and the ending location, and (iii) between the specific time period and the specific time interval, the method comprising:
receiving at a server system, over a wide area network, from a computer client of each of the first and second consumers, data by which each such consumer is registered, such data including contact information and a credit facility identifier;
also receiving at the server system, over the wide area network, from a computer client of each consumer desiring to be a first consumer, driver's license identification data;
receiving at the server system, over the wide area network, from a computer client of each first consumer desiring to post a trip, trip data characterizing the trip to be posted, such data including for such trip: the origin, the destination, and the specific time interval;
storing by the server system the received trip data in a database;
receiving at the server system, over the wide area network, from a computer client of each second consumer desiring to post a shipment, shipment data characterizing the shipment to be posted, such data including for such shipment: the starting location, the end location, the specific time period, and an uploaded photograph of such shipment, and wherein provision of such shipment data from such second consumer is a condition to use of the platform by such second consumer;
storing by the server system the received shipment data in the database;
causing at least some of the stored trip data and at least some of the stored shipment data to be searchable over the wide area network via a client computer of any of the consumers;
responsive to a purchase-a-trip message from a client computer of a purchasing one of the second consumers, receiving at the server system, over the wide area network from a client computer of the purchasing one of the second consumers, purchase data characterizing a trip purchase, such data identifying a corresponding posted trip;
updating by the server system the database to reflect the trip purchase; transmitting, by the server system, purchase completion messages, to the client computer of the purchasing one of the second consumers, such second consumer hereinafter called “the shipper” and to the client computer of the corresponding one of the first consumers whose trip was purchased, such first consumer hereinafter called “the driver”, confirming the trip purchase for a corresponding shipment; and
serving by the server system to the computer client of the driver a copy of the uploaded photograph of the shipper's shipment and also an instruction to the driver to refuse to carry any item tendered to the driver by the shipper if the item does not match an item in the uploaded photograph of the shipper's shipment;
with respect to a purchased trip that has been commenced:
receiving at the server system, contemporaneous geolocation data from a mobile computer, of the driver, that is in communication with the server and running an application causing such data to be transmitted to the server; and
transmitting, by the server system, to the computer client of the shipper, location data showing the contemporaneous location of the driver and the corresponding shipment and the corresponding shipment, such location data including a map that shows the current location of the corresponding shipment highlighted and a tracking history for such purchased trip that has been commenced.

2. A computer-implemented method of providing a marketplace platform that enables one of a first set of first consumers, each first consumer planning a trip in a motor vehicle driven by such first consumer, the trip having an origin and a destination over a specific time period, and willing to carry a set of items from a pickup location within a first specified distance of the origin to a delivery location within a second specified distance of the destination, to connect and interact with one of a second set of second consumers, each second consumer desiring to ship a shipment from a starting location to an end location over a specific time interval, wherein, the one of the first consumers and the one of the second consumers may choose to connect with each other on the basis of perceived matches (i) between the origin and the starting location, (ii) between the destination and the ending location, and (iii) between the specific time period and the specific time interval, the method comprising:
receiving at a server system, over a wide area network, from a computer client of each of the first and second consumers, data by which each such consumer is registered, such data including constact information and a credit facility identifier;
also receiving at the server system, over the wide area network, from a computer client of each consumer desiring to be a first consumer, driver's license identification data;
receiving at the server system, over the wide area network, from a computer client of each first consumer desiring to post a trip, trip data characterizing the trip to be posted, such data including for such trip: the origin, the destination, and the specific time interval;
storing by the server system the received trip data in a database;
receiving at the server system, over the wide area network, from a computer client of each second consumer desiring to post a shipment, shipment data characterizing the shipment to be posted, such data including for such shipment: the starting location, the end location, and the specific time period;
storing by the server system the received shipment data in the database;
causing at least some of the stored trip data and at least some of the stored shipment data to be searchable over the wide area network via a client computer of any of the consumers;
responsive to a purchase-a-trip message from a client computer of a purchasing one of the second consumers, receiving at the server system, over the wide area network from a client computer of the purchasing one of the second consumers, purchase data characterizing a trip purchase, such data identifying a corresponding posted trip;
updating by the server system the database to reflect the trip purchase; and
transmitting, by the server system, purchase completion messages, to the client computer of the purchasing one of the second consumers, such second consumer hereinafter called “the shipper” and to the client computer of the corresponding one of the first consumers whose trip was purchased, such first consumer hereinafter called “the driver”, confirming the trip purchase for a corresponding shipment.

3. A method according to claim 2, further comprising, with respect to a purchased trip that has been commenced:
receiving at the server system, contemporaneous geolocation data from a mobile computer, of the driver, that is in communication with the server and running an application causing such data to be transmitted to the server; and
transmitting, by the server system, to the computer client of the shipper, location data showing the contemporaneous location of the driver and the corresponding shipment.

4. A method according to claim 3, wherein transmitting, to the computer client of the shipper, location data showing the contemporaneous location of the driver and the corresponding shipment, includes transmitting a map that shows the current location of the corresponding shipment highlighted and a tracking history for such purchased trip that has been commenced.

5. A method according to claim 2, wherein receiving at the server system the shipment data includes receiving an uploaded photograph of such shipment, and wherein provision of such shipment data from such second consumer is a condition to use of the platform by such second consumer and the method further comprises serving by the server system to the computer client of the driver a copy of the uploaded photograph of the shipper's shipment and also an instruction to the driver to refuse to carry any item tendered to the driver by the shipper if the item does not match an item in the uploaded photograph of the shipper's shipment.

6. A method according to claim 2,
wherein receiving at the server system the trip data includes receiving an uploaded photograph of the vehicle and causing at least some of the stored trip data to be searchable over the wide area network extends to the uploaded photographs of the vehicle so that each potential shipper can assess suitability, of space and dimensions, of a vehicle of a potential driver, for transporting the shipper's shipment.

7. A method according to claim 3,
wherein receiving at the server system the trip data includes receiving an uploaded photograph of the vehicle and causing at least some of the stored trip data to searchable over the wide area network extends to the uploaded photographs of the vehicles so that each potential shipper can assess suitability, of space and dimensions, of a vehicle of a potential driver for transporting the shipper's shipment.
